(19) United States
(12) Patent Application Publication
(10) Pub. No.: US 2024/0040654 A1
(43) Pub. Date: Feb. 1, 2024

(54) METHOD AND DEVICE USED IN COMMUNICATION NODE FOR WIRELESS COMMUNICATION

(71) Applicants: Qiaoling YU, Shanghai (CN); Xiaobo ZHANG, Shanghai (CN)

(72) Inventors: Qiaoling YU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/377,799

(22) Filed: Oct. 8, 2023

Related U.S. Application Data
(63) Continuation of application No. PCT/CN2022/085243, filed on Apr. 6, 2022.

(30) Foreign Application Priority Data
Apr. 9, 2021 (CN) 202110381076.3
Apr. 14, 2021 (CN) 202110400101.8

(51) Int. Cl. H04W 76/20; H04W 28/02

(52) U.S. Cl. CPC H04W 76/20; H04W 28/0278

(57) ABSTRACT

Present application provides a method and a device in a communication node for wireless communications. A communication node, accompanying a first message, starts a first timer; transmits the first message, the first message comprises an RRC signaling; transmits a first field; monitors a second message, the second message comprises an RRC signaling, the second message is used to respond to the first message; as a response to any condition in a first condition set being satisfied, updates from RRC_INACTIVE state to a first RRC state; if the second message is received, stops the first timer; the first field is used to assist in determining a transmission of the second message; two conditions in the first condition set are respectively the first timer being expired and the second message being received; the present application increases the success probability of SDT transmission and reduces the power consumption of the first node.

### CROSS REFERENCE TO RELATED APPLICATIONS

This application is the continuation of the international patent application No. PCT/CN2022/085243, filed on Apr. 6, 2022, and claims the priority benefit of Chinese Patent Application No. 202110381076.3, filed on Apr. 9, 2021, and claims the priority benefit of Chinese Patent Application No 202110400101.8, filed on Apr. 14, 2021, the full disclosure of which is incorporated herein by reference.

### BACKGROUND

### Technical Field

The present application relates to transmission methods and devices in wireless communication systems, and in particular to a transmission method and device related to small packet services.

### Related Art

New Radio (NR) supports Radio Resource Control (RRC)_INACTIVE State, and until 3GPP Rel-16 version, RRC_INACTIVE State does not support transmitting data. When a User Equipment (UE) has periodic or aperiodic infrequent small packets needed to be transmitted in RRC_INACTIVE state, it needs to resume the connection first, that is, switches to RRC_CONNECTED state, and then switches to RRC_INACTIVE state after data is transmitted. 3GPP RAN #86 plenary decided to carry out a Work Item (WI) of “Small Data Transmission (SDT) in NR INACTIVE state” to study SDT technology in RRC_INACTIVE state, comprising transmitting uplink data on preconfigured Physical Uplink Shared Channel (PUSCH) resources, or carrying data with Message 3 (Msg3) or MSGB in Random Access (RA) procedure.

### SUMMARY

A timer is defined for the SDT procedure. When the timer expires, it is determined that the SDT procedure fails. Therefore, when and how the base station determines whether to terminate the SDT procedure can have an impact on the current SDT packet, and it is necessary to enhance the signaling interaction between the UE and the base station.

Due to the inability to transmit packets endlessly in RRC_INACTIVE state, a newly defined timer was proposed in 3GPP discussion to effectively control a transmission of data packets in RRC_INACTIVE state. If the newly defined timer expires, it is considered that the SDT transmission is failed. According to the existing BSR triggering mechanism, it is possible that new data arrives and the volume of data may not be reported in a timely manner, so it needs to enhance the buffer reporting mechanism and the newly defined timer.

To address the above problem, the present application provides a solution. It should be noted that though the present application only took the NR scenario for example in the statement above, the present application is also applicable to scenarios such as Long Term Evolution (LTE), NarrowBand Internet of Things (NB IoT), or Vehicle to Everything (V2X), where similar technical effects can be achieved. Additionally, the adoption of a unified solution for various scenarios contributes to the reduction of hardware complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict.

The present application provides a method in a first node for wireless communications, comprising:
accompanying a first message, starting a first timer; transmitting the first message, the first message comprising an RRC signaling; transmitting a first field; and
monitoring a second message, the second message comprising an RRC signaling, the second message being used to respond to the first message; as a response to any condition in a first condition set being satisfied, updating from RRC_INACTIVE state to a first RRC state;
herein, if the second message is received, and as a response to the second message being received, stop the first timer; the first field is used to assist in determining a transmission of the second message; two conditions in the first condition set are respectively the first timer being expired and the second message being received; the first RRC state is a candidate state in a first candidate state set, and the first candidate state set comprises RRC_IDLE state.

In one embodiment, a problem to be solved in the present application comprises: how to ensure the best effort transmission of SDT.

In one embodiment, a problem to be solved in the present application comprises: how to avoid SDT transmission failure.

In one embodiment, characteristics of the above method comprise: assisting the base station in transmitting a second message through the first field.

In one embodiment, characteristics of the above method comprise: assisting in determining a type of a second message through the first field.

In one embodiment, advantages of the above method comprise: the base station determines a type of the second message based on information reporting of the UE.

In one embodiment, advantages of the above method comprise: the base station determines a status update of the first node based on information reporting of the UE.

In one embodiment, advantages of the above method comprise: improving the success probability of SDT transmission.

In one embodiment, advantages of the above method comprise: reducing power consumption of the UE.

According to one aspect of the present application, it is characterized in that the phrase that the first field is used to assist in determining a transmission of the second message comprises: the first field is used to assist in determining a time for transmitting the second message.

In one embodiment, essence of the above method comprises: the first field is used to delay a time for transmitting the second message.

In one embodiment, essence of the above method comprises: the first field is used to indicate transmitting the second message as soon as possible.

According to one aspect of the present application, comprising:
as a response to the behavior of transmitting a first field, an expiration value of the first timer being increased by a first offset;
herein, the first offset comprises at least one slot.

In one embodiment, essence of the above method comprises: the first field is used to extend an SDT transmission time.

According to one aspect of the present application, it is characterized in that the first field indicates whether a size of a target data block reaches a first size threshold; the target data block comprises at least one of data pending to be transmitted on uplink, or a MAC MSGB or a MAC CE.

In one embodiment, essence of the above method comprises: when a size of a target data block reaches a first size threshold, transmitting a first field.

In one embodiment, essence of the above method comprises: when a size of a target data block does not reach a first size threshold, a first field is set to a first value; when a size of a target data block reaches a first size threshold, a first field is set to a second value.

According to one aspect of the present application, comprising:
receiving a first signaling, the first signaling indicating a first resource block;
herein, the first message comprises the first field, and the first field is a first BSR; the first resource block cannot accommodate the first BSR and the first data block at the same time; the first data block comprises an SDU;
the first resource block is used to carry the first message.

In one embodiment, essence of the above method comprises: when the first resource block cannot accommodate both the first BSR and a first data block, the first message comprises a first BSR.

In one embodiment, essence of the above method comprises: when the first resource block cannot accommodate both the first BSR and a first data block at the same time, the first message comprises a first BSR, and the first message does not comprise at least one bit in the first data block.

According to one aspect of the present application, comprising:
determining that a fourth message is not correctly received, the fourth message being triggered by the first message; receiving a second signaling, the second signaling indicating a second resource block; and
when a second condition set is satisfied, updating the first field; the behavior of updating the first field being used to determine a third message, transmitting the third message on the second resource block;
herein, the behavior of determining that the fourth message is not correctly received triggers the second signaling; the second condition set comprises that there exists a second data block, and the second data block arrives after the first message is assembled.

In one embodiment, essence of the above method comprises: when Msg3 is re-transmitted, and if uplink data pending to be transmitted changes, updating the first field.

In one embodiment, essence of the above method comprises: the first field is a BSR MAC CE.

In one embodiment, essence of the above method comprises: the first field is a Buffer Size field.

According to one aspect of the present application, comprising:
as a response to the behavior of updating the first field, canceling a second BSR;
herein, the second BSR is triggered between the first message and the third message.

In one embodiment, essence of the above method comprises: if the first field is updated, canceling the second BSR.

The present application provides a method in a second node for wireless communications, comprising:
receiving a first message, the first message comprising an RRC signaling. receiving a first field; and
transmitting a second message, the second message comprising an RRC signaling, the second message being used to respond to the first message;
herein, accompanying the first message, a first timer is started; as a response to any condition in a first condition set being satisfied, a transmitter of the first message updates from RRC_INACTIVE state to a first RRC state; if the second message is received, as a response to the second message being received, the first timer is stopped; the first field is used to assist in determining a transmission of the second message; two conditions in the first condition set are respectively the first timer being expired and the second message being received; the first RRC state is a candidate state in a first candidate state set, and the first candidate state set comprises RRC_IDLE state.

According to one aspect of the present application, the phrase that the first field is used to assist in determining a transmission of the second message comprises: the first field is used to assist in determining a time for transmitting the second message.

According to one aspect of the present application, it is characteristic in that as a response to the first field being transmitted, an expiration value of the first timer is increased by a first offset; herein, the first offset comprises at least one slot.

According to one aspect of the present application, it is characterized in that the first field indicates whether a size of a target data block reaches a first size threshold; the target data block comprises at least one of data pending to be transmitted on uplink, or a MAC MSGB or a MAC CE.

According to one aspect of the present application, comprising:
transmitting a first signaling, the first signaling indicating a first resource block;
herein, the first message comprises the first field, and the first field is a first BSR; the first resource block cannot accommodate the first BSR and the first data block at the same time; the first data block comprises an SDU;
the first resource block is used to carry the first message.

According to one aspect of the present application, comprising:
a fourth message being determined not correctly received, the fourth message being triggered by the first message; transmitting a second signaling, the second signaling indicating a second resource block; and
receiving a third message on the second resource block;
herein, when a second condition set is satisfied, the first field is updated; the behavior of the first field being updated is used to determine the third message; the behavior of determining that the fourth message is not correctly received triggers the second signaling; the second condition set comprises that there exists a second data block, and the second data block arrives after the first message is assembled.

According to one aspect of the present application, it is characterized in that as a response to the behavior of the first field being updated, a second BSR is canceled; herein, the second BSR is triggered between the first message and the third message.

The present application provides a first node for wireless communications, comprising:
a first transmitter, accompanying a first message, starting a first timer; transmitting the first message, the first message comprising an RRC signaling; transmitting a first field; and
a first receiver, monitoring a second message, the second message comprising an RRC signaling, the second message being used to respond to the first message; as a response to any condition in a first condition set being satisfied, updating from RRC_INACTIVE state to a first RRC state;
herein, if the second message is received, and as a response to the second message being received, stop the first timer; the first field is used to assist in determining a transmission of the second message; two conditions in the first condition set are respectively the first timer being expired and the second message being received; the first RRC state is a candidate state in a first candidate state set, and the first candidate state set comprises RRC_IDLE state.

The present application provides a second node for wireless communications, comprising:
a second receiver, receiving a first message, the first message comprising an RRC signaling; receiving a first field; and
a second transmitter, transmitting a second message, the second message comprising an RRC signaling, the second message being used to respond to the first message;
herein, accompanying the first message, a first timer is started; as a response to any condition in a first condition set being satisfied, a transmitter of the first message updates from RRC_INACTIVE state to a first RRC state; if the second message is received, as a response to the second message being received, the first timer is stopped; the first field is used to assist in determining a transmission of the second message; two conditions in the first condition set are respectively the first timer being expired and the second message being received; the first RRC state is a candidate state in a first candidate state set, and the first candidate state set comprises RRC_IDLE state.

In one embodiment, the present application has the following advantages over conventional schemes:
the base station determines a type of the second message based on information reporting of the UE;
the base station determines a status update of the first node based on information reporting of the UE;
improving the success probability of SDT transmission;
reducing power consumption of the UE.

The present application provides a method in a first node for wireless communications, comprising:
transmitting a first message, the first message comprising an RRC message; accompanying the first message, starting a first timer; and
monitoring a second message when the first timer is in a running state; receiving a first signaling when the first timer is in a running state, as a response to the behavior of receiving the first signaling, restarting the first timer or triggering a first buffer status report;
herein, if the second message is received, and as a response to the second message being received, stop the first timer; the second message comprises an RRC message, and the second message is used to respond to the first message.

In one embodiment, as a response to the behavior of receiving a first signaling, the first receiver restarts the first timer.

In one embodiment, as a response to the behavior of receiving a first signaling, the first receiver triggers a first buffer status report.

In one embodiment, as a response to the behavior of receiving a first signaling, the first receiver restarts the first timer and triggers a first buffer status report.

In one embodiment, a problem to be solved in the present application comprises: how to avoid SDT failure incurred due to an expiration of a first timer.

In one embodiment, a problem to be solved in the present application comprises: how to complete an SDT transmission as soon as possible.

In one embodiment, a problem to be solved in the present application comprises: how to reduce the UE power consumption.

In one embodiment, essence of the above method comprises: restarting the first timer based on an indication from the base station.

In one embodiment, essence of the above method comprises: triggering a first buffer status report based on an indication of the base station.

In one embodiment, advantages of the above method comprise: increasing the triggering probability of BSR.

In one embodiment, advantages of the above method comprise: completing the SDT transmission as soon as possible.

In one embodiment, advantages of the above method comprise: improving the success probability of SDT.

In one embodiment, advantages of the above method comprise: avoiding SDT failure incurred due to an expiration of a first timer.

According to one aspect of the present application, comprising:
before the first message being transmitted, resuming a first-type DRB;
herein, when the first-type DRB is resumed, the first node is in RRC_INACTIVE state.

According to one aspect of the present application, comprising:
as a response to an expiration of the first timer, updating from RRC_INACTIVE state to a first RRC state;
herein, the first RRC state is a candidate state in a first candidate state set, and the first candidate state set comprises RRC_IDLE state.

According to one aspect of the present application, comprising:
after the behavior of triggering a first buffer status report, generating a first MAC CE;
herein, the first MAC CE indicates a buffer status; a priority of the first MAC CE is not lower than a priority of a second MAC CE, the second MAC CE is a MAC CE in a first candidate MAC CE set, and the first candidate MAC CE set comprises a BSR MAC CE.

According to one aspect of the present application, it is characterized in that the first signaling indicates a first expiration value of the first timer.

According to one aspect of the present application, comprising:
receiving a second signaling;
herein, the second signaling indicates a second expiration value of the first timer; the second signaling comprises an RRC message.

The present application provides a method in a second node for wireless communications, comprising:
receiving a first message, the first message comprising an RRC message; and
transmitting a second message; and transmitting a first signaling;
herein, accompanying the first message, a first timer is started; when the second message is received, the first timer is in a running state; when the first message is received, the first timer is in a running state; as a response to the first signaling being received, the first timer is restarted or a first buffer status report is triggered; if the second message is received, and as a response to the second message being received, stop the first timer; the second message comprises an RRC message, and the second message is used to respond to the first message.

According to one aspect of the present application, it is characterized in that before the first message is transmitted, a first-type DRB is resumed; herein, when the first-type DRB is resumed, a transmitter of the first message is in RRC_INACTIVE state.

According to one aspect of the present application, it is characteristic in that as a response to an expiration of the first timer, RRC_INACTIVE state is updated as a first RRC state; herein, the first RRC state is a candidate state in a first candidate state set, and the first candidate state set comprises RRC_IDLE state.

According to one aspect of the present application, it is characterized in that after the behavior of triggering a first buffer status report, a first MAC CE is generated; herein, the first MAC CE indicates a buffer status; a priority of the first MAC CE is not lower than a priority of a second MAC CE, the second MAC CE is a MAC CE in a first candidate MAC CE set, and the first candidate MAC CE set comprises a BSR MAC CE.

According to one aspect of the present application, it is characterized in that the first signaling indicates a first expiration value of the first timer.

According to one aspect of the present application, comprising:
transmitting a second signaling;
herein, the second signaling indicates a second expiration value of the first timer; the second signaling comprises an RRC message.

The present application provides a first node for wireless communications, comprising:
a first transmitter, transmitting a first message, the first message comprising an RRC message;
accompanying the first message, starting a first timer; and
a first receiver, monitoring a second message when the first timer is in a running state; receiving a first signaling when the first timer is in a running state, as a response to the behavior of receiving the first signaling, restarting the first timer or triggering a first buffer status report;
herein, if the second message is received, and as a response to the second message being received, stop the first timer; the second message comprises an RRC message, and the second message is used to respond to the first message.

The present application provides a second node for wireless communications, comprising:
a second receiver, receiving a first message, the first message comprising an RRC message; and
a second transmitter, transmitting a second message; transmitting a first signaling;
herein, accompanying the first message, a first timer is started; when the second message is received, the first timer is in a running state; when the first message is received, the first timer is in a running state; as a response to the first signaling being received, the first timer is restarted or a first buffer status report is triggered; if the second message is received, and as a response to the second message being received, stop the first timer; the second message comprises an RRC message, and the second message is used to respond to the first message.

In one embodiment, the present application has the following advantages over conventional schemes:
increasing the triggering probability of BSR;
completing an SDT transmission as soon as possible;
improving the success probability of SDT;
avoiding SDT failure due to an expiration of a first timer.

### BRIEF DESCRIPTION OF THE DRAWINGS

Other features, objects and advantages of the present application will become more apparent from the detailed description of non-restrictive embodiments taken in conjunction with the following drawings:

FIG. 1A illustrates a flowchart of transmissions of a first signal, a second signal and a third signal according to one embodiment of the present application;

FIG. 1B illustrates a flowchart of transmission of a first message, a second message and a first signaling according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5A illustrates a flowchart of radio signal transmission according to one embodiment of the present application;

FIG. 5B illustrates a flowchart of radio signal transmission according to one embodiment of the present application;

FIG. 6A illustrates a flowchart of radio signal transmission according to another embodiment of the present application;

FIG. 6B illustrates a flowchart of radio signal transmission according to another embodiment of the present application;

FIG. 7A illustrates a schematic diagram of updating a first field according to one embodiment of the present application;

FIG. 7B illustrates a schematic diagram of a first timer according to one embodiment of the present application;

FIG. 8A illustrates a schematic diagram of a first field being used to assist in determining a time for transmitting a second message according to one embodiment of the present application;

FIG. 8B illustrates a schematic diagram of K1 bits being used to indicate 2^{K1} states according to one embodiment of the present application;

FIG. 9A illustrates a schematic diagram of the first field indicating whether a size of the target data block reaches a first size threshold according to one embodiment of the present application;

FIG. 9B illustrates a schematic diagram of a first MAC CE comprising a first MAC field according to one embodiment of the present application;

FIG. 10A illustrates a schematic diagram of a first condition set being satisfied being used to determine a behavior of a first node according to one embodiment of the present application;

FIG. 10B illustrates a schematic diagram of a first signaling indicating a first expiration value of a first timer according to one embodiment of the present application;

FIG. 11A illustrates a schematic diagram of a field in a MAC MSGB being used to a first field according to one embodiment of the present application;

FIG. 11B illustrates a structure block diagram of a processor in first node according to one embodiment of the present application;

FIG. 12A illustrates a schematic diagram of a field in a MAC CE being used to determine a first field according to one embodiment of the present application;

FIG. 12B illustrates a structure block diagram of a processor in a second node according to one embodiment of the present application;

FIG. 13 illustrates a schematic diagram of a field in a MAC CE being used to determine a first field according to another embodiment of the present application;

FIG. 14 illustrates a schematic diagram of multiple fields in multiple MAC MSGBs in a MAC PDU being used to determine a first field according to one embodiment of the present application;

FIG. 15 illustrates a structure block diagram of a processor in a first node according to one embodiment of the present application;

FIG. 16 illustrates a structure block diagram of a processor in a second node according to one embodiment of the present application;

FIG. 17 illustrates a schematic diagram of updating a first field being used to determine canceling a second BSR according to one embodiment of the present application;

FIG. 18 illustrates a schematic diagram of a second condition being satisfied being used to determine updating a first field according to one embodiment of the present application;

FIG. 19 illustrates a schematic diagram of when a first resource block cannot accommodate both a first BSR and a first data block at the same time, the first message comprising a first BSR according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1A

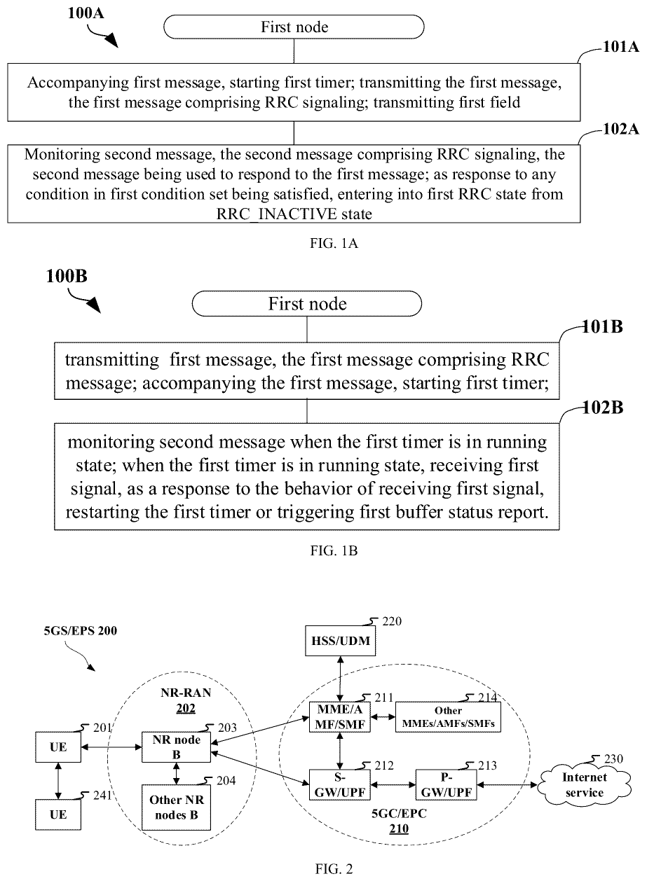

Embodiment 1A illustrates a flowchart of transmission of a first message, a second message and a first field according to one embodiment of the present application, as shown in FIG. 1A. In FIG. 1A, each box represents a step. It should be noted particularly that the order in which the boxes are arranged does not imply a chronological sequence of each step respectively marked.

In embodiment 1A, a first node in the present application in step 101A, accompanying a first message, starts a first timer; transmits the first message, the first message comprises an RRC signaling; transmits a first field; in step 102A, monitors a second message, the second message comprises an RRC signaling, the second message is used to respond to the first message; as a response to any condition in a first condition set being satisfied, updates from RRC_INACTIVE state to a first RRC state; herein, if the second message is received, and as a response to the second message being received, stop the first timer; the first field is used to assist in determining a transmission of the second message; two conditions in the first condition set are respectively the first timer being expired and the second message being received; the first RRC state is a candidate state in a first candidate state set, and the first candidate state set comprises RRC_IDLE state.

In one embodiment, the behavior of “accompanying a first message, starting a first timer” comprises: the behavior of starting a first timer is related to the first message.

In one embodiment, the behavior of “accompanying a first message, starting a first timer” comprises: when the first node receives an indication from a lower layer of the first node, starting the first timer, and the indication being triggered by the first message.

In one embodiment, the behavior of “accompanying a first message, starting a first timer” comprises: when the first node transmits an indication to a lower layer of the first node, starting the first timer, and the indication being triggered by the first message.

In one embodiment, the behavior of “accompanying a first message, starting a first timer” comprises: when the first node receives an indication from a higher layer of the first node, starting the first timer, and the indication being triggered by the first message.

In one embodiment, the behavior of “accompanying a first message, starting a first timer” comprises: when the first node transmits an indication to a higher layer of the first node, starting the first timer, and the indication being triggered by the first message.

In one embodiment, the behavior of “accompanying a first message, starting a first timer” comprises: the behavior of starting a first timer is related to transmitting the first message.

In one embodiment, the behavior of “accompanying a first message, starting a first timer” comprises: the behavior of starting a first timer is related to receiving a response to the first message.

In one embodiment, the behavior of “accompanying a first message, starting a first timer” comprises: the first message being transmitted is a necessary condition for the behavior of starting a first timer.

In one embodiment, the behavior of “accompanying a first message, starting a first timer” comprises: once the first message is transmitted, starting the first timer.

In one embodiment, the behavior of “accompanying a first message, starting a first timer” comprises: once the first message is transmitted, the first timer is activated at a first symbol after the first message is transmitted or retransmitted, and the first timer comprises an ra-ContentionResolutionTimer.

In one embodiment, the behavior of “accompanying a first message, starting a first timer” comprises: once the first message is transmitted, the first timer is activated at a given PDCCH occasion, and the first timer comprises msgB-ResponseWindow.

In one embodiment, the behavior of “accompanying a first message, starting a first timer” comprises: when the first message is triggered, activating the first timer.

In one embodiment, the behavior of “accompanying a first message, starting a first timer” comprises: upon preparing to transmit the first message, starting the first timer.

In one embodiment, the behavior of “accompanying a first message, starting a first timer” comprises: upon a transmission of the first message, starting the first timer.

In one embodiment, the behavior of “accompanying a first message, starting a first timer” comprises: following the transmission of the first message, starting the first timer.

In one embodiment, the behavior of “accompanying a first message, starting a first timer” comprises: upon the first message being setup, starting the first timer.

In one embodiment, the behavior of “accompanying a first message, starting a first timer” comprises: upon an initialization of an SDT procedure to which the first message belongs, starting the first timer.

In one embodiment, the behavior of “accompanying a first message, starting a first timer” comprises: upon an initiation of the SDT procedure to which the first message belongs, starting the first timer.

In one embodiment, the behavior of “accompanying a first message, starting a first timer” comprises: upon a reception of a response to the first message, activating the first timer.

In one embodiment, the behavior of “accompanying a first message, starting a first timer” comprises: upon a start of the first timer, the first message being transmitted.

In one embodiment, the behavior of “accompanying a first message, starting a first timer” comprises: when data of a first one of logical channels associated with a first-type DRB is transmitted after the first message is transmitted, the first timer is activated.

In one embodiment, the behavior of “accompanying a first message, starting a first timer” comprises: when data of a first one of logical channels associated with a first-type DRB is received after the first message is transmitted, the first timer is activated.

In one embodiment, the behavior of “accompanying a first message, starting a first timer” comprises: just-before the transmission of the first message.

In one embodiment, transmit a first message, receive a first feedback, transmit first DRB data and start a first timer.

In one subembodiment of the embodiment, the first DRB data is data of first one of logical channels associated with a first-type DRB transmitted in an SDT procedure.

In one subembodiment of the embodiment, the first message comprises an RRCResumeRequest message and the first message does not comprise data of a logical channel associated with a first-type DRB.

In one embodiment, transmit a first message, receive second DRB data and start a first timer.

In one subembodiment of the embodiment, the second DRB data is first one of data of a logical channel associated with a first-type DRB received in an SDT procedure.

In one subembodiment of the embodiment, the first message comprises an RRCResumeRequest message, and the first message does not comprise data of a logical channel associated with a first-type DRB.

In one embodiment, the phrase of accompanying the first message, starting the first timer comprises: transmitting the first message is not used to start T319 timer.

In one embodiment, a transmission of the first-type data unit is not used to start or restart the T319.

In one embodiment, accompanying the first message, start the first timer, the first message comprises at least partial bits of at least the first-type data unit; accompanying a fourth message, start the T319 timer, and the fourth message does not comprise the first-type data unit.

In one embodiment, the first message is transmitted via an air interface.

In one embodiment, the first message is transmitted via an antenna port.

In one embodiment, the first message is transmitted through an upper-layer signaling.

In one embodiment, the first message is transmitted through a higher-layer signaling.

In one embodiment, the first message comprises an uplink signal.

In one embodiment, the first message comprises a sidelink signal.

In one embodiment, the first message comprises a Radio Resource Control (RRC) signaling.

In one embodiment, the RRC signaling comprises an RRC message.

In one embodiment, the RRC signaling comprises at least one Information Element (IE) in an RRC message.

In one embodiment, the RRC signaling comprises at least one field in an RRC message.

In one embodiment, the first message comprises an RRCResumeRequest message.

In one embodiment, the first message comprises an RRC message whose name is RRCConnectionResumeRequest.

In one embodiment, the first message comprises an RRCEarlyDataRequest message.

In one embodiment, the first message comprises an RRC message whose name comprises at least one of RRC, Connection, Resume, sdt, idt, Inactive, Small, Data, Transmission, or Request.

In one embodiment, the first message comprises ShortI-RNTI-Value or I-RNTI-Value.

In one embodiment, the first message comprises resumeMAC-I.

In one embodiment, the first message comprises resumeMAC-I, and the resumeMAC-I is a bit string with a length equal to 16.

In one embodiment, the first message comprises resumeCause.

In one embodiment, the first message comprises resumeCause, and the resumeCause indicates one of emergency or highPriorityAccess or mt-Access or mo-Signalling or mo-Data or mo-VoiceCall or mo-VideoCall or mo-SMS or rna-Update or ps-PriorityAccess or mcs-PriorityAccess or sdt or idt or edt or smalldatatransmission or inactivedatatransmission or pur.

In one embodiment, the first message comprises spare, and the spare is a bit string with a length equal to 1.

In one embodiment, the first message is all or part of Message 3 (Msg3).

In one embodiment, the first message is all or part of Message A (MSGA).

In one embodiment, the phrase that the first message comprises an RRC signaling comprises: the first message is an RRC signaling.

In one embodiment, the phrase that the first message comprises an RRC signaling comprises: the first message is a Medium Access Control (MAC) Protocol Data Unit (PDU), the MAC PDU comprises a MAC Service Data Unit (SDU), and the MAC SDU carries the RRC signaling.

In one subembodiment of the above embodiment, the MAC SDU comprises a Common Control Channel (CCCH) SDU.

In one subembodiment of the above embodiment, the MAC SDU comprises a Dedicated Control Channel (DCCH) SDU.

In one subembodiment of the above embodiment, the MAC SDU comprises a Dedicated Traffic Channel (DTCH) SDU.

In one embodiment, the first message comprises an RRC signaling and the first message comprises data of a logical channel associated with a first-type DRB.

In one subembodiment of the above embodiment, the first message comprises an RRC signaling and the first message comprises a BSR.

In one subembodiment of the above embodiment, the first message comprises an RRC signaling and the first message does not comprise a BSR.

In one embodiment, the first message comprises an RRC signaling and the first message does not comprise data of a logical channel associated with a first-type DRB.

In one subembodiment of the above embodiment, the first message comprises an RRC signaling and the first message comprises a BSR.

In one subembodiment of the above embodiment, the first message comprises an RRC signaling and the first message does not comprise a BSR.

In one embodiment, the first timer is not T319.

In one embodiment, the first timer comprises a ra-ContentionResolutionTimer.

In one embodiment, the first timer comprises a msgB-ResponseWindow.

In one embodiment, accompanying a first message, start a first timer and do not start the T319.

In one embodiment, for the definition of T319, refer to chapter 7.1.1 of 3GPP TS 38.331.

In one embodiment, the behavior of starting a first timer comprises: enabling the first timer starting timing.

In one embodiment, the behavior of starting a first timer comprises: enabling the first timer starting running.

In one embodiment, the meaning of the starting comprises start.

In one embodiment, the meaning of the starting comprises begin.

In one embodiment, the first field is transmitted via an air interface.

In one embodiment, the first field is transmitted via an antenna port.

In one embodiment, the first field is transmitted through a higher-layer signaling.

In one embodiment, the first field is transmitted through an upper-layer signaling.

In one embodiment, the first field is transmitted through a MAC-layer signaling.

In one embodiment, the first field is transmitted by a physical signaling.

In one embodiment, the first field comprises an uplink signal.

In one embodiment, the first field comprises a sidelink signal.

In one embodiment, the first field indicates whether there exists data pending to be transmitted.

In one embodiment, the first field indicates an arrival of data other than the first-type DRB.

In one embodiment, the first field indicates that the first node requests to enter into RRC_CONNECTED state.

In one embodiment, the first field indicates that the first node requests resuming a suspended RRC connection.

In one embodiment, the first field indicates that the first node requests suspending an RRC connection.

In one embodiment, the first field indicates that the first node requests suspending the first-type DRB.

In one embodiment, the first field indicates that the first node requests suspending a resumed Radio Bearer (RB).

In one embodiment, the first field indicates that the first node requests terminating an SDT procedure.

In one embodiment, the first field indicates that the first node requests prolonging an SDT procedure.

In one embodiment, the first field indicates that the first node requests configuring a first configuration set.

In one embodiment, the first field indicates that the first node requests time alignment amount.

In one embodiment, the first field indicates that the first node requests uplink resources.

In one embodiment, the first field indicates that the first node requests Beam Failure Recovery (BFR).

In one embodiment, the first field is a physical signal.

In one embodiment, the first field is transmitted a physical uplink control channel (PUCCH).

In one embodiment, a physical layer channel bearing the first field comprises a PUCCH.

In one subembodiment of the embodiment, the PUCCH comprises a PUCCH Format0.

In one subembodiment of the embodiment, the PUCCH comprises a PUCCH Format1.

In one subembodiment of the embodiment, the PUCCH comprises a PUCCH Format2.

In one subembodiment of the embodiment, the PUCCH comprises a PUCCH Format3.

In one subembodiment of the embodiment, the PUCCH comprises a PUCCH Format4.

In one subembodiment of the embodiment, the PUCCH comprises a PUCCH Format5.

In one embodiment, the first field comprises a Scheduling Request (SR) signal.

In one subembodiment of the above embodiment, the SR signal is triggered by data of the first-type DRB.

In one subembodiment of the above embodiment, the SR signal is triggered by the second data block.

In first subsidiary embodiment of the subembodiment, the meaning of the phrase that the SR signal is triggered by the second data block comprises: when the second data block is valid for a MAC entity, triggering the SR signal.

In one subembodiment of the above embodiment, when data of the first-type DRB arrives and there is no sufficient uplink resource used for transmitting data of the first-type DRB, the first field is transmitted.

In one subembodiment of the above embodiment, when data other than the first-type DRB arrives and there is no sufficient uplink resource used for transmitting data of the first-type DRB, the first field is not transmitted.

In one embodiment, the first field comprises a Positive SR.

In one embodiment, the first field comprises a Negative SR.

In one embodiment, the first field is transmitted simultaneously with Hybrid Automatic Repeat reQuest (HARQ) Acknowledge (ACK)/Non-Acknowledge (NACK) information.

In one embodiment, the first field is not transmitted simultaneously with HARQ ACK/NACK information.

In one embodiment, the first field is at least one field in a MAC PDU.

In one embodiment, the first field is at least one field in a MAC sub-PDU.

In one embodiment, the first field is a MAC MSGB.

In one embodiment, the first field is at least one field in a MAC MSGB.

In one embodiment, the first field is at least one field in a MAC Control Element (CE).

In one embodiment, the first field is at least one field in a MAC SDU.

In one embodiment, the first field is a DCCH SDU.

In one embodiment, the first field is a field in a DCCH SDU.

In one embodiment, the first field is a Buffer Status Report (BSR).

In one embodiment, the first field is a field in a BSR.

In one embodiment, the first field is a bit in a BSR.

In one embodiment, the first field is a field in an RRC message.

In one embodiment, the first field is a field in the first message.

In one embodiment, the first field is not a field in the first message.

In one embodiment, the first field is a field in a MAC CE.

In one subembodiment of the embodiment, the MAC CE is a BSR MAC CE.

In one subembodiment of the embodiment, the MAC CE is not a BSR MAC CE.

In one subembodiment of the embodiment, the MAC CE comprises a Buffer Size field.

In one subembodiment of the embodiment, the MAC CE comprises a Buffer Size field and a Logical Channel Group (LCG) ID field.

In one subembodiment of the embodiment, the MAC CE comprises a Buffer Size field, and does not comprise a LCG ID field.

In one subembodiment of the embodiment, the MAC CE comprises a Buffer Size field, and does not comprise an LCG ID field.

In one subembodiment of the embodiment, the MAC CE comprises a Power Headroom Report (PHR) field.

In one embodiment, the first field comprises a MAC CE, the MAC CE comprises a Buffer Size field, the Buffer Size field comprises 8 bits, and the Buffer Size indicates a size of a target data block.

In one subembodiment of the embodiment, the target data block comprises data associated with all first-type DRBs and protocol headers of each protocol layer.

In one subembodiment of the embodiment, the target data block comprises at least one of data pending to be transmitted on uplink, or a MAC MSGB or a MAC CE.

In one embodiment, the first field comprises a field.

In one embodiment, during a running period of the first timer, the first field is transmitted.

In one embodiment, the first message comprises the first field.

In one embodiment, the first message does not comprise the first field.

In one embodiment, before the first timer starts running, the first field is transmitted.

In one embodiment, accompanying a first message, start a first timer, and the first message comprises the first field.

In one embodiment, the first field occupies Q2 bit(s), a value of the first field is set as one of Q1 first-type candidate value(s), Q1 and Q2 being positive integers, Q2 being not greater than 8, Q1 being not greater than Q2 power of 2 (2^{Q2}), and the Q1 first-type candidate value(s) is (are respectively) used to indicate Q1 first-type state(s).

In one subembodiment of the above embodiment, Q2 is equal to 32.

In one subsidiary embodiment of the above subembodiment, the one bit is set to 0 to indicate a first-type state, and the one bit is set to 1 to indicate another first-type state.

In one subsidiary embodiment of the subembodiment, the one bit and other signals occupy a field together.

In one subsidiary embodiment of the subembodiment, the one bit independently occupies a field.

In one subembodiment of the above embodiment, Q2 is equal to 2.

In one subembodiment of the above embodiment, Q2 is equal to 3.

In one subembodiment of the above embodiment, Q2 is equal to one of 4, 5, 6, 7 and 8.

In one subembodiment of the above embodiment, the Q2 is equal to one of 4, 5, 6, . . . , 31 and 32.

In one embodiment, the first field indicates two first-type states, the first field being set indicates a first-type state, and the first field not being set indicates another first-type state.

In one embodiment, the first field is a BOOLEAN value, the first field being set as a true value indicates a first-type state, and the first field being set as a false value indicates another first-type state.

In one embodiment, the first field indicates two first-type states, the first field being set indicates another first-type state, and the first field not being set indicates a first-type state.

In one embodiment, the first field is a BOOLEAN value, the first field being set as a true value indicates another first-type state, and the first field being set as a false value indicates a first-type state.

In one embodiment, the first-type state comprises: there exists data pending to be transmitted, and the another first-type state comprises: there exists no data pending to be transmitted.

In one embodiment, the first-type state comprises: a size of a target data block reaches a first size threshold; the another first-type state comprises: a size of a target data block does not reach a first size threshold.

In one embodiment, the first-type state comprises: data other than the first-type DRB arrives; the another first-type state comprises: no data other than the first-type DRB arrives.

In one embodiment, the first-type state comprises: requesting time alignment amount; the another first-type state comprises: not requesting time alignment amount.

In one embodiment, the first-type state comprises: requesting uplink resources; the another first-type state comprises: not requesting uplink resources.

In one embodiment, the first-type state comprises: requesting a Beam Failure Recovery (BFR); the another first-type state comprises: not requesting a BFR.

In one embodiment, the first-type state comprises: requesting configuring a first configuration set; the another first-type state comprises: not requesting configuring a first configuration set.

In one embodiment, the first-type state comprises: requesting terminating an SDT procedure; the another first-type state comprises: not requesting terminating an SDT procedure.

In one embodiment, the first-type state comprises: requesting prolonging an SDT procedure; the another first-type state comprises: not requesting prolonging an SDT procedure.

In one embodiment, the first-type state comprises: requesting prolonging an SDT procedure; the another first-type state comprises: requesting terminating an SDT procedure.

In one embodiment, the first-type state comprises: one of requesting to enter into RRC_CONNECTED state, or requesting to resuming a suspended RRC connection, or requesting to suspend an RRC connection, or requesting to suspend the first-type DRB, or requesting to suspend a resumed RB; the another first-type state comprises: one of requesting to enter into RRC_CONNECTED state, or requesting to resume a suspended RRC connection, or requesting to suspend an RRC connection, or requesting to suspend the first-type DRB, or requesting to suspend a resumed RB; the first-type state and the another first-type state are different, and the first-type state and the another first-type state are respectively one of the Q1 first-type state(s).

In one embodiment, the second message is transmitted via an air interface.

In one embodiment, the second message is transmitted via an antenna port.

In one embodiment, the second message is transmitted via an upper-layer signaling.

In one embodiment, the second message is transmitted via a higher-layer signaling.

In one embodiment, the second message comprises a Downlink signal.

In one embodiment, the second message comprises a sidelink signal.

In one embodiment, the second message comprises a Msg4.

In one embodiment, the second message comprises a Msg B.

In one embodiment, the phrase that the second message comprises an RRC signaling comprises: the second message comprises at least one RRC message.

In one embodiment, the phrase that the second message comprises an RRC signaling comprises: the second message comprises a MAC SDU whose RRC message is submitted to the MAC layer.

In one embodiment, the second message comprises an RRC message.

In one subembodiment of the embodiment, the RRC message comprises an RRCRelease message.

In one subembodiment of the embodiment, the RRC message comprises an RRCResume message.

In one subembodiment of the embodiment, the RRC message comprises an RRCSetup message.

In one subembodiment of the embodiment, the RRC message comprises an RRCReject message.

In one subembodiment of the embodiment, the RRC message comprises an RRCConnectionRelease message.

In one subembodiment of the embodiment, the RRC message comprises an RRCConnectionResume message.

In one subembodiment of the embodiment, the RRC message comprises an RRCConnectionSetup message.

In one subembodiment of the embodiment, the RRC message comprises an RRCConnectionReject message.

In one subembodiment of the embodiment, the RRC message comprises an RRCEarlyDataComplete message.

In one subembodiment of the embodiment, a name of the RRC message comprises at least one of RRC, Connection, Resume, Release, Resume, RRCReject, Setup, Reconfiguration, Complete, sdt, idt, Inactive, Small, Data, or Transmission.

In one embodiment, the meaning of the monitoring comprises searching.

In one embodiment, the meaning of monitoring comprises monitoring.

In one embodiment, the meaning of the monitoring comprises passing Cyclic Redundancy Check (CRC) check.

In one embodiment, the behavior of monitoring a second message comprises: monitoring a first-type DCI in a first time-frequency resource pool; the first-type DCI comprises scheduling information of a first-type channel, and the second message occupies at least one the first-type channel.

In one subembodiment of the embodiment, the monitoring a first-type DCI comprises performing a blind detection on the first-type DCI.

In one subembodiment of the embodiment, the monitoring a first-type DCI comprises respectively performing channel decoding among multiple PDCCH candidates.

In one subembodiment of the embodiment, the monitoring a first-type DCI comprises judging whether the first-type DCI is detected based on the CRC.

In one subembodiment of the embodiment, the first time-frequency resource pool only occurs in partial time-domain resources in a search space.

In one subembodiment of the embodiment, the first time-frequency resource pool comprises a segment of continuous time-domain resources.

In one subembodiment of the embodiment, the first time-frequency resource pool comprises a segment of discontinuous time-domain resources.

In one subembodiment of the embodiment, the first time-frequency resource pool is periodic.

In one subembodiment of the embodiment, the first time-frequency resource pool is aperiodic.

In one subembodiment of the embodiment, the first time-frequency resource pool comprises multiple Resource Elements (REs).

In one subembodiment of the embodiment, the first time-frequency resource pool comprises multiple Control Channel Elements (CCEs).

In one subembodiment of the embodiment, the first time-frequency resource pool comprises a segment of continuous frequency-domain resources.

In one subembodiment of the embodiment, the first time-frequency resource pool comprises a segment of discontinuous frequency-domain resources.

In one subembodiment of the embodiment, the first time-frequency resource pool comprises one or multiple Resource Elements (REs).

In one subembodiment of the embodiment, the first time-frequency resource pool belongs to a first search space.

In one subsidiary embodiment of the above embodiment, the first search space is associated with the first time-frequency resource pool.

In one subsidiary embodiment of the above embodiment, the first search space corresponds to the first time-frequency resource pool.

In one subsidiary embodiment of the above embodiment, the first time-frequency resource pool is a part of time-frequency resources allocated to a first search space.

In one subembodiment of the embodiment, the first time-frequency resource pool is associated with TEMPORARY Cell Radio Network Temporary Identifier (C-RNTI).

In one subembodiment of the embodiment, the first time-frequency resource pool is associated with an MSGB-RNTI.

In one subembodiment of the embodiment, the first time-frequency resource pool is associated with a C-RNTI.

In one subembodiment of the embodiment, the first time-frequency resource pool comprises multiple REs.

In one subembodiment of the embodiment, the first time-frequency resource pool comprises multiple CCEs.

In one subembodiment of the embodiment, the first time-frequency resource pool comprises at least one PDCCH candidate.

In one subembodiment of the embodiment, the first time-frequency resource pool belongs to a same search space.

In one subembodiment of the embodiment, the first-type DCI is scrambled by an MSGB-RNTI.

In one subembodiment of the embodiment, the first-type DCI is scrambled by a TEMPORARY_C-RNTI.

In one subembodiment of the embodiment, the first-type DCI is scrambled by a C-RNTI.

In one subembodiment of the embodiment, the first-type DCI is used for DownLink Grant.

In one subembodiment of the embodiment, the first-type DCI comprises DCI format 1_0.

In one subembodiment of the embodiment, the first-type DCI comprises DCI format 1_1.

In one subembodiment of the above embodiment, the phrase that the first-type DCI comprises scheduling information of a first-type channel comprises: the first-type DCI comprises at least one of time-domain position, frequency-domain position, Modulation and Coding Scheme (MCS), Redundancy Version (RV), New Data Indicator (NDI), or Hybrid Automatic Repeat reQuest (HARQ) process number of the first-type channel.

In one subsidiary embodiment of the subembodiment, the time-domain position comprises resource allocation in time domain.

In one subsidiary embodiment of the subembodiment, the time-domain position is calculated according to chapter 5.1.2.1 of TS 38.214.

In one subsidiary embodiment of the subembodiment, the frequency-domain position comprises resource allocation in frequency domain.

In one subsidiary embodiment of the subembodiment, the frequency-domain position is calculated according to chapter 5.1.2.2.2 of TS 38.214.

In one subsidiary embodiment of the subembodiment, the MCS comprises at least one of modulation order (Qm) or target code rate (R).

In one subsidiary embodiment of the subembodiment, the RV is determined based on a field in the first-type DCI, and the field comprises a redundant version field (rv).

In one subsidiary embodiment of the subembodiment, the NDI is determined based on a field in the first-type DCI, and the field comprises an NDI field.

In one subsidiary embodiment of the subembodiment, the HARQ process number is determined based on a field in the first-type DCI, and the field comprises a HARQ process number field.

In one subembodiment of the embodiment, the phrase that the second message occupies at least one the first-type channel comprises: the first-type channel is a physical-layer channel used for transmitting the second message.

In one subembodiment of the embodiment, the phrase that the second message occupies at least one the first-type channel comprises: the second message is transmitted through the first-type channel.

In one subembodiment of the embodiment, the first-type channel comprises a Physical Downlink Shared Channel (PDSCH).

In one subembodiment of the embodiment, the first-type channel comprises a Downlink Shared Channel (DL-SCH).

In one subembodiment of the embodiment, the at least one first-type channel occupied by the second message also comprises other bit blocks.

In one subsidiary embodiment of the subembodiment, the other bit blocks comprise a MAC CE.

In one subsidiary embodiment of the subembodiment, the other bit blocks comprise a PDCP PDU from a DRB.

In one subsidiary embodiment of the subembodiment, the other bit blocks comprise an RRC signaling other than the second message.

In one embodiment, the behavior of monitoring a second message comprises: transferring data received at the lower layer to the higher layer, and determine whether the data received at the lower layer is the second message at the higher layer.

In one embodiment, the behavior of monitoring a second message is only executed during a running period of the first timer.

In one embodiment, the behavior of monitoring a second message comprises: monitoring a first-type DCI in at least one search space until the second message is detected or the first timer is expired, and a scheduling signaling of the second message comprises at least one first-type DCI.

In one embodiment, the lower layer comprises a physical layer.

In one embodiment, the lower layer comprises a MAC layer.

In one embodiment, the higher layer comprises a Radio Link Control Protocol (RLC) layer.

In one embodiment, the higher layer comprises an RRC layer.

In one embodiment, the behavior of monitoring a signal comprises: determining whether there exists the signal through at least one of energy monitoring, coherent detection, broadband detection, correlation detection, synchronous detection, waveform detection, or maximum likelihood detection.

In one subembodiment of the above embodiment, the signal is the second message.

In one subembodiment of the above embodiment, the signal is the first-type DCI.

In one embodiment, the phrase that the second message is used to respond to the first message comprises: the second message is a response to the first message.

In one embodiment, the phrase that the second message is used to respond to the first message comprises: the first message triggers the second message.

In one embodiment, the first message comprises an RRCResumeRequest, and the second message comprising one of an RRCRelease message, an RRCResume message, an RRCSetup message, or an RRCReject message is used to determine that the second message is used in response to the first message.

In one embodiment, the first message comprises RRCConnectionResumeRequest, and the second message comprising one of an RRCConnectionRelease message, an RRCConnectionResume message, an RRCConnectionSetup message, or an RRCConnectionReject message is used to determine that the second message is used to respond to the first message.

In one embodiment, the phrase of “as a response to any condition in a first condition set being satisfied, updating from RRC_INACTIVE state to first RRC state” comprises: as a response to an expiration of the first timer, updating from RRC_INACTIVE state to a first RRC state.

In one embodiment, the phrase of “as a response to any condition in a first condition set being satisfied, updating from RRC_INACTIVE state to first RRC state” comprises: as a response to the second message being received, updating from RRC_INACTIVE state to a first RRC state.

In one embodiment, the phrase of as a response to any condition in a first condition being satisfied comprises: when one condition in the first condition set is satisfied.

In one subembodiment of the embodiment, there at least exists one condition in the first condition not being satisfied.

In one subembodiment of the embodiment, other conditions in the first condition set are satisfied.

In one embodiment, the phrase of as a response to any condition in a first condition being satisfied comprises: if any condition in the first condition set is satisfied.

In one embodiment, the behavior of updating from RRC_INACTIVE state to first RRC state comprises: the first node transits from RRC_INACTIVE state to first RRC state.

In one embodiment, the behavior of updating from RRC_INACTIVE state to first RRC state comprises: the first node enters into the first RRC state from RRC_INACTIVE state.

In one embodiment, the behavior of updating from RRC_INACTIVE state to first RRC state comprises: the first node remains in the first RRC state from RRC_INACTIVE state, and the first RRC state is RRC_INACTIVE state.

In one embodiment, the phrase that if the second message is received comprises: if the second message is received and the second message is a response to the first message.

In one embodiment, the phrase that if the second message is received comprises: if the second message is successfully received.

In one embodiment, the phrase that if the second message is received comprises: when the second message is received.

In one embodiment, the phrase that as a response to receiving the second message comprises: when the second message is received.

In one embodiment, the phrase that as a response to receiving the second message comprises: when the second message is received.

In one embodiment, the behavior of stopping the first timer comprises: the first timer stops timing.

In one embodiment, the behavior of stopping the first timer comprises: timing of the first timer remains unchanged.

In one embodiment, the behavior of stopping the first timer comprises: suspending the first timer.

In one embodiment, the behavior of stopping the first timer comprises: the first timer is reset to zero and is not restarted.

In one embodiment, the meaning of the stopping comprises stop.

In one embodiment, the meaning of the stopping comprises end.

In one embodiment, the meaning of the phrase of “if the second message is received, as a response to the second message being received, stopping the first timer” comprises: when the second message is received, stopping the first timer.

In one embodiment, the meaning of the phrase of “if the second message is received, as a response to the second message being received, stopping the first timer” comprises: when the second message is received, if the second message is a response to the first message, stopping the first timer.

In one embodiment, if the second message is received and the second message is used to respond to the first message, as a response to the second message being received, stop the first timer.

In one embodiment, the meaning of the phrase that the first field is used to assist in determining a transmission of the second message comprises: the first field is used to request the second message.

In one embodiment, the phrase that the first field is used to assist in determining a transmission of the second message comprises: the second message is related to the first field.

In one embodiment, the phrase that the first field is used to assist in determining a transmission of the second message comprises: the first field is used to assist in determining whether the second message is transmitted.

In one embodiment, the phrase that the first field is used to assist in determining a transmission of the second message comprises: how the second node in the application sets the second message is related to the first field.

In one embodiment, the phrase that the first field is used to assist in determining a transmission of the second message comprises: the first field is used to determine whether a next downlink message is the second message.

In one embodiment, the phrase that the first field is used to assist in determining a transmission of the second message comprises: the first field is used to determine whether a first one of downlink messages after the first message is transmitted is the second message; herein, the first message comprises the first field.

In one embodiment, the phrase that the first field is used to assist in determining a transmission of the second message comprises: the first field is used to determine whether a first one of downlink messages after the first field is transmitted is the second message; herein, the first message does not comprise the first field.

In one embodiment, the phrase that the first field is used to assist in determining a transmission of the second message comprises: the first field is used to directly determine how the second node sets at least one of a type of the second message, content of the second message, or a transmission time of the second message.

In one embodiment, the phrase that the first field is used to assist in determining a transmission of the second message comprises: the first field is used to indirectly determine how the second node sets at least one of a type of the second message, content of the second message, or a transmission time of the second message.

In one embodiment, the phrase that the first field is used to assist in determining a transmission of the second message comprises: the first field is used to assist in determining a time for transmitting the second message.

In one embodiment, the phrase that the first field is used to assist in determining a transmission of the second message comprises: the first field is used to assist in determining content in the second message.

In one embodiment, the Q1 first-type state(s) is(are) used to assist in determining content of the second message.

In one embodiment, the Q1 first-type state(s) is(are) used to assist in determining a time for transmitting the second message.

In one embodiment, the Q1 first-type state(s) is(are) used to assist in determining a type of the second message, and the type of the second message is one type in the first candidate type set.

In one embodiment, one of the Q1 first-type state(s) is used to determine a next downlink message.

In one embodiment, one of the Q1 first-type state(s) is used to determine a first one of downlink messages after the first message is transmitted; herein, the first message comprises the first field.

In one embodiment, one of the Q1 first-type state(s) is used to determine a first one of downlink messages after the first field is transmitted; herein, the first message does not comprise the first field.

In one embodiment, the phrase that the first field is used to assist in determining a transmission of the second message comprises: the first field is used to assist in determining a type of the second message, and the type of the second message is one type in the first candidate type set.

In one subembodiment of the embodiment, the first candidate type set comprises a first candidate type and a second candidate type, the first candidate type is used to resume an RRC connection, and the second candidate type is used to release an RRC connection.

In one subsidiary embodiment of the subembodiment, when the first field is set to a value, it indicates the first candidate type, and when the first field is set to another value, it indicates the second candidate type.

In one subsidiary embodiment of the subembodiment, when the first field is set, it indicates the first candidate type, and when the first field is not set, it indicates the second candidate type.

In one subsidiary embodiment of the subembodiment, the first candidate type comprises an RRCResume message or an RRCConnectionResume message.

In one subsidiary embodiment of the subembodiment, the first candidate type comprises an RRCSetup message or an RRCConnectionSetup message.

In one subsidiary embodiment of the subembodiment, the second candidate type comprises an RRCRelease message or an RRCConnectionRelease message.

In one subsidiary embodiment of the subembodiment, the second candidate type comprises an RRCReject message or an RRCConnectionReject message.

In one subsidiary embodiment of the subembodiment, the second candidate type comprises an RRCRRCEarlyDataComplete message.

In one subsidiary embodiment of the subembodiment, the second candidate type comprises an RRC message, and a name of the RRC message is at least one of RRC or Connection or Resume or Release or Resume or RRCReject or Setup or Reconfiguration or Complete or sdt or idt or Inactive or Small or Data or Transmission, and the first RRC state comprises RRC_INACTIVE state.

In one embodiment, the phrase that the first field is used to assist in determining a transmission of the second message comprises: the first field is used to assist in determining a first content in the second message, the first content is used to indicate a first configuration set, and the first configuration set comprises a first configuration authorization resource.

In one subembodiment of the above embodiment, the phrase that the first field is used to assist in determining a first content in the second message comprises: the first field is used to request a first content in the second message.

In one subembodiment of the above embodiment, the phrase that the first field is used to assist in determining a first content in the second message comprises: the first field is used to explicitly request a first content in the second message.

In one subsidiary embodiment of the subembodiment, the first field being set to one of 1 or true or setup is used to determine requesting a first content in the second message; the first field being set to one of 1 or false or Release is not used to request a first content in the second message.

In one subsidiary embodiment of the subembodiment, a presence of the first field is used to determine requesting a first content in the second message; an absence of the first field is not used to request a first content in the second message.

In one subembodiment of the above embodiment, the phrase that the first field is used to assist in determining a first content in the second message comprises: the first field is used to implicitly request a first content in the second message.

In one subsidiary embodiment of the subembodiment, a first content in the second message is determined by parameters obtained according to the first field.

In one subsidiary embodiment of the subembodiment, the first field is used to determine a parameter, and a first content in the second message is determined based on the parameter.

In one subembodiment of the above embodiment, the first configuration set comprises a user ID, and the user ID is associated with a first configuration authorization resource in RRC_INACTIVE state.

In one subsidiary embodiment of the subembodiment, the user ID comprises an RNTI.

In one subsidiary embodiment of the subembodiment, a name of the user ID comprises at least one of RNTI or CG or CS or INACTIVE or Small or SDT or IDT or I- or S- or PUR or Data or Transmission.

In one subsidiary embodiment of the subembodiment, the user ID comprises 16 bits.

In one subsidiary embodiment of the subembodiment, the user ID comprises 32 bits.

In one subembodiment of the embodiment, the first configuration set comprises a period of the first configuration authorization resource.

In one subembodiment of the embodiment, the first configuration set comprises at least one of time-domain resources, frequency-domain resources, spatial-domain resources, or code-domain resources occupied by the first configuration authorization resource.

In one subembodiment of the embodiment, the first configuration set comprises an identifier, and the identifier is indexed to the first configuration authorization resource.

In one embodiment, the phrase that the first field is used to assist in determining a transmission of the second message comprises: the first field is used to assist in determining a second content in the second message, and the second content is used to determine amount of the time alignment.

In one subembodiment of the above embodiment, the phrase that the first field is used to assist in determining a second content in the second message comprises: the first field is used to request a second content in the second message.

In one subsidiary embodiment of the subembodiment, the first field being set to one of 1 or true or setup is used to determine requesting a second content in the second message; the first field being set to one of 1 or false or Release is not used to request a second content in the second message.

In one subsidiary embodiment of the subembodiment, a presence of the first field is used to determine requesting a second content in the second message; an absence of the first field is not used to request a second content in the second message.

In one subembodiment of the above embodiment, the phrase that the first field is used to assist in determining a second content in the second message comprises: the first field is used to explicitly request a second content in the second message.

In one subsidiary embodiment of the subembodiment, a first content in the second message is determined by parameters obtained according to the first field.

In one subsidiary embodiment of the subembodiment, the first field is used to determine a parameter, and a first content in the second message is determined based on the parameter.

In one subsidiary embodiment of the subembodiment, the first field indicates that an increase value in RSRP of a current serving cell compared to a previous RSRP reaches a first difference value, and the first difference value is configured through a field in an RRC message.

In one subsidiary embodiment of the subembodiment, the first field indicates that a decrease value in RSRP of a current serving cell compared to a previous RSRP reaches a second difference value, and the second difference value is configured through a field in an RRC message.

In one subembodiment of the above embodiment, the phrase that the first field is used to assist in determining a second content in the second message comprises: the first field is used to implicitly request a second content in the second message.

In one subembodiment of the embodiment, the second content comprises a Timing Advance Command.

In one subembodiment of the embodiment, the second content comprises a Timing Advance Command field.

In one subembodiment of the embodiment, the second content comprises a Timing Advance Command MAC CE or an Absolute Timing Advance Command MAC CE.

In one subembodiment of the embodiment, the second content comprises an index value T_{A}, the index value T_{A} is used to control a timing adjustment amount applied by a MAC entity, where for the definition of the T_{A}, refer to 3GPP TS 38.321.

In one subsidiary embodiment of the above subembodiment, the T_{A} comprises 6 bits, and a value range of the T_{A} comprises 0, 1, 2 . . . 63.

In one subsidiary embodiment of the above subembodiment, the T_{A} comprises 12 bits, and a value range of the T_{A} comprises 0, 1, 2 . . . 3846.

In one subsidiary embodiment of the above subembodiment, the T_{A} comprises one of 3 bits, or 4 bits, or 5 bits, or 7 bits, or 8 bits.

In one subembodiment of the embodiment, the second content is used to determine N_{TA}, where for the definition of the N_{TA}, refer to 3GPP TS 38.213.

In one subembodiment of the embodiment, the second content is used to determine N_{TA}T_{C}, where for the definition of the T_{c}, refer to 3GPP TS 38.213.

In one subembodiment of the embodiment, the second content is used to determine T_{A}·16·64/2^{μ}.

In one subembodiment of the embodiment, the second content is used to determine N_{TA_old}+(T_{A}−31)·16·64/2^{μ}, and the N_{TA_old} represents a time alignment amount of a last timing alignment.

In one subembodiment of the above embodiment, the time alignment amount is equal to a product of T_{A}16·64/2^{μ} and T_{c}.

In one subembodiment of the above embodiment, the time alignment amount is equal to a product of N_{TA_old}+(T_{A}−31)·16·64/2^{μ} and T_{c}.

In one subembodiment of the embodiment, the p is a non-negative integer, and the p is not greater than 256.

In one subembodiment of the embodiment, the p is one of 0, or 1, or 2, or 3, or 4.

In one subembodiment of the embodiment, the p is related to a subcarrier spacing (SCS) Δf, and the subcarrier spacing Δf is 2^{μ}·15 kHz.

In one embodiment, the phrase that the first field is used to assist in determining a transmission of the second message comprises: the first field is used to assist in determining a second content in the second message, and the second content is used to request uplink resources.

In one subembodiment of the above embodiment, the phrase that the first field is used to assist in determining a second content in the second message comprises: the first field is used to request a second content in the second message.

In one subembodiment of the above embodiment, the phrase that the first field is used to assist in determining a second content in the second message comprises: the first field is used to explicitly request a second content in the second message.

In one subembodiment of the above embodiment, the phrase that the first field is used to assist in determining a second content in the second message comprises: the first field is used to implicitly request a second content in the second message.

In one embodiment, the phrase that two conditions in the first condition set are respectively the first timer being expired and the second message being received comprises: one condition in the first condition set is that the first timer is expired.

In one embodiment, the phrase that two conditions in the first condition set are respectively the first timer being expired and the second message being received comprises: one condition in the first condition set is that the second message is received.

In one embodiment, the phrase that two conditions in the first condition set are respectively the first timer being expired and the second message being received comprises: the phrase of any condition in a first condition set being satisfied comprises: the first timer being expired.

In one embodiment, the phrase that two conditions in the first condition set are respectively the first timer being expired and the second message being received comprises: the phrase of any condition in a first condition set being satisfied comprises: the second message is received.

In one embodiment, the phrase that the first timer is expired comprises: a running time of the first timer reaches an expiration value of the first timer.

In one subembodiment of the above embodiment, the expiration value of the first timer is configurable.

In one subembodiment of the above embodiment, the expiration value of the first timer is configured through an RRC message.

In one subembodiment of the above embodiment, the expiration value of the first timer is configured through an RRCRelease message.

In one subembodiment of the above embodiment, the expiration value of the first timer is configured through a field in an RRCRelease message.

In one subembodiment of the above embodiment, the expiration value of the first timer is configured through an RRCReconfiguration message.

In one subembodiment of the above embodiment, the expiration value of the first timer is configured through an SIB1 message.

In one subembodiment of the above embodiment, the expiration value of the first timer comprises at least one slot.

In one embodiment, the phrase that the second message is received comprises: correctly decoding the second message, and the second message comprises a response for the first message.

In one embodiment, the phrase that the second message is received comprises: the second message is correctly received.

In one embodiment, the phrase that the second message is received comprises: the second message is received during a running period of the first timer.

In one embodiment, the first candidate state set comprises RRC_IDLE state and RRC_CONNECTED state.

In one embodiment, the first candidate state set comprises RRC_IDLE state and RRC_INACTIVE state.

In one embodiment, the first candidate state set comprises RRC_INACTIVE state and RRC_CONNECTED state.

In one embodiment, the first candidate state set comprises RRC_IDLE state, RRC_INACTIVE state and RRC_CONNECTED state.

In one embodiment, the phrase that the first RRC state is a candidate state in a first candidate state set comprises: the first RRC state belongs to the first candidate state set.

In one embodiment, the phrase that the first RRC state is a candidate state in a first candidate state set comprises: the first RRC state is one of RRC_IDLE or RRC_INACTIVE state or RRC_CONNECTED state.

In one embodiment, the behavior of “as a response to any condition in a first condition set being satisfied, updating from RRC_INACTIVE state to first RRC state” comprises: as a response to an expiration of the first timer, updating from RRC_INACTIVE state to a first RRC state;

In one subembodiment of the above embodiment, accompanying a first message, start a first timer; transmit the first message, the first message comprises an RRC signaling; transmit a first field; monitor a second message, the second message comprises an RRC signaling, the second message is used to respond to the first message; as a response to an expiration of the first timer, update from RRC_INACTIVE state to a first RRC state; herein, the second message is not received; the first field is used to assist in determining a transmission of the second message; the first RRC state is a candidate state in a first candidate state set, and the first candidate state set comprises RRC_IDLE state.

In one subembodiment of the embodiment, the first RRC state is RRC_INACTIVE state.

In one subembodiment of the embodiment, the first RRC state is RRC_IDLE state.

In one embodiment, the behavior of “as a response to any condition in a first condition set being satisfied, updating from RRC_INACTIVE state to first RRC state” comprises: as a response to the second message being received, updating from RRC_INACTIVE state to a first RRC state.

In one subembodiment of the above embodiment, accompanying a first message, start a first timer; transmit the first message, the first message comprises an RRC signaling; transmit a first field; monitor a second message, the second message comprises an RRC signaling, the second message is used to respond to the first message; the second message is received, as a response to the second message being received, stop the first timer; as a response to the second message being received, update from RRC_INACTIVE state to a first RRC state; herein, the first field is used to assist in determining a transmission of the second message; the first RRC state is a candidate state in a first candidate state set, and the first candidate state set comprises RRC_IDLE state.

In one subembodiment of the above embodiment, the second message comprises an RRCResume message or an RRCConnectionResume message, and the first RRC state comprises RRC_CONNECTED state.

In one subembodiment of the above embodiment, the second message comprises an RRCRelease message or an RRCConnectionRelease message, and the first RRC state comprises RRC_INACTIVE state.

In one subembodiment of the above embodiment, the second message comprises an RRCRelease message or an RRCConnectionRelease message, and the first RRC state comprises RRC_IDLE state.

In one subembodiment of the above embodiment, the second message comprises an RRCSetup message or an RRCConnectionSetup message, and the first RRC state comprises RRC_CONNECTED state.

In one subembodiment of the above embodiment, the second message comprises an RRCReject message or an RRCConnectionReject message, and the first RRC state comprises RRC_IDLE state.

In one subembodiment of the above embodiment, the second message comprises an RRCEarlyDataComplete message, and the first RRC state comprises RRC_INACTIVE state.

In one subembodiment of the embodiment, a name of the second message comprises at least one of RRC, Connection, Resume, Release, Resume, RRCReject, Setup, Reconfiguration, Complete, sdt, idt, Inactive, Small, Data, or Transmission, and the first RRC state comprises RRC_INACTIVE state.

In one embodiment, the SDT procedure comprises transmitting small packets in RRC_INACTIVE state.

In one embodiment, the SDT comprises RRC_INACTIVE Data Transmission (IDT).

In one embodiment, the SDT procedure comprises transmitting packets through Data Radio Bearer (DRB) in RRC_INACTIVE state.

In one embodiment, the SDT procedure comprises transmitting packets through one or multiple first-type DRBs in RRC_INACTIVE state.

In one embodiment, the SDT procedure comprises resuming one or multiple first-type DRBs in RRC_INACTIVE state, and transmitting packets through the one or multiple first-type DRBs.

In one embodiment, the SDT procedure comprises transmitting packets through Msg3 or MSGB in RRC_INACTIVE state.

In one embodiment, the SDT procedure comprises transmitting data of a first-type DRB on configured resources in RRC_INACTIVE state.

In one embodiment, the SDT procedure comprises transmitting a packet on a resource block configured in an RRCRelease message or RRCConnectionRelease in RRC_INACTIVE state.

In one embodiment, the SDT procedure comprises resuming a first-type DRB.

In one embodiment, the SDT procedure comprises reconstructing a Packet Data Convergence Protocol (PDCP) entity of the first-type DRB.

In one embodiment, the first timer being running is used to determine that the SDT procedure is being executed.

In one embodiment, the first-type DRB is resumed upon initiating an SDT procedure.

In one embodiment, the first-type DRB is resumed in RRC_INACTIVE state.

In one embodiment, the first-type DRB is used to transmit SDT data.

In one embodiment, the first-type DRB comprises at least one DRB.

In one embodiment, when the first message is transmitted, the first node is in RRC_INACTIVE state.

In one embodiment, when the first message is transmitted, the first node is in RRC_IDLE state.

In one embodiment, when the first message is transmitted, the first node is not in RRC_CONNECTED state.

In one embodiment, the first timer is maintained in RRC_INACTIVE state.

In one embodiment, the first timer is maintained in RRC_IDLE state.

In one embodiment, when the first timer is running, the first node is not in RRC_CONNECTED state.

### Embodiment 1B

Embodiment 1B illustrates a flowchart of transmission of a first message, a second message and a first signaling according to one embodiment of the present application, as shown in FIG. 1B. In FIG. 1B, each box represents a step. It should be noted particularly that the order in which the boxes are arranged does not imply a chronological sequence of each step respectively marked.

In embodiment 1B, a first node in the present application transmits a first message in step 101B, and the first message comprises an RRC message; accompanying the first message, starts a first timer; in step 102B, monitors a second message when the first timer is in a running state; receives a first signaling when the first timer is in a running state, as a response to the behavior of receiving the first signaling, restarts the first timer or triggering a first buffer status report; herein, if the second message is received, and as a response to the second message being received, stops the first timer; the second message comprises an RRC message, and the second message is used to respond to the first message.

In one embodiment, the first message is transmitted in RRC_INACTIVE state.

In one embodiment, the first message is transmitted in RRC_IDLE state.

In one embodiment, the first message is transmitted via an air interface.

In one embodiment, the first message is transmitted via an antenna port.

In one embodiment, the first message is transmitted through an upper-layer signaling.

In one embodiment, the first message is transmitted through a higher-layer signaling.

In one embodiment, the first message comprises an uplink signal.

In one embodiment, the first message comprises a sidelink signal.

In one embodiment, the first message is transmitted through Signaling Radio Bearer 0 (SRB0).

In one embodiment, the first message is transmitted through Signaling Radio Bearer 1 (SRB1).

In one embodiment, the first message is transmitted through Signaling Radio Bearer 2 (SRB2).

In one embodiment, the first message is transmitted through Signaling Radio Bearer 3 (SRB3).

In one embodiment, the first message is transmitted through a Common Control Channel (CCCH).

In one embodiment, the first message is transmitted through a Dedicated Control Channel (DCCH).

In one embodiment, the first message comprises a Radio Resource Control (RRC) signaling.

In one embodiment, the phrase that the first message comprises an RRC message comprises: the first message is an RRC message.

In one embodiment, the phrase that the first message comprises an RRC message comprises: the RRC message comprises at least one Information Element (IE) in an RRC message.

In one embodiment, the phrase that the first message comprises an RRC message comprises: the RRC message comprises at least one field in an RRC message.

In one embodiment, the phrase that the first message comprises an RRC message comprises: the first message is a Medium Access Control (MAC) Protocol Data Unit (PDU), the MAC PDU comprises a MAC Service Data Unit (SDU), and the MAC SDU carries the RRC message.

In one embodiment, the first message comprises an RRCResumeRequest message.

In one embodiment, the first message comprises an RRCResumeRequest1 message.

In one embodiment, the first message comprises an RRCConnectionResumeRequest message.

In one embodiment, the first message comprises an RRCEarlyDataRequest message.

In one embodiment, the first message comprises an RRC message whose name comprises at least one of RRC, Connection, Resume, sdt, idt, Inactive, Small, Data, Transmission, or Request.

In one embodiment, the first message comprises an RRCReconfigurationSidelink message.

In one embodiment, the first message comprises an MCGFailureInformation message.

In one embodiment, the first message comprises an RRCReestabilshmentRequest message.

In one embodiment, the first message comprises an RRCSetupRequest message.

In one embodiment, the first message comprises ShortI-RNTI-Value or I-RNTI-Value.

In one embodiment, the first message comprises resumeMAC-I.

In one embodiment, the first message comprises resumeMAC-I, and the resumeMAC-I is a bit string with a length equal to 16.

In one embodiment, the first message comprises resumeCause.

In one embodiment, the first message comprises resumeCause, and the resumeCause indicates one of emergency or highPriorityAccess or mt-Access or mo-Signalling or mo-Data or mo-VoiceCall or mo-VideoCall or mo-SMS or rna-Update or ps-PriorityAccess or mcs-PriorityAccess or sdt or idt or edt or smalldatatransmission or inactivedatatransmission or pur.

In one embodiment, the first message comprises spare, and the spare is a bit string with a length equal to 1.

In one embodiment, the first message is all or part of Message 3 (Msg3).

In one embodiment, the first message is all or part of Message A (MSGA).

In one subembodiment of the embodiment, the MAC SDU comprises a CCCH SDU.

In one subembodiment of the embodiment, the MAC SDU comprises a DCCH SDU.

In one subembodiment of the above embodiment, the MAC SDU comprises a Dedicated Traffic Channel (DTCH) SDU.

In one embodiment, the behavior of “accompanying the first message, starting a first timer” comprises: the behavior of starting a first timer is related to the first message.

In one embodiment, the behavior of “accompanying the first message, starting a first timer” comprises: when the first node receives an indication from a lower layer of the first node, starting the first timer, and the indication being triggered by the first message.

In one embodiment, the behavior of “accompanying the first message, starting a first timer” comprises: when the first node transmits an indication to a lower layer of the first node, starting the first timer, and the indication being triggered by the first message.

In one embodiment, the behavior of “accompanying the first message, starting a first timer” comprises: when the first node receives an indication from a higher layer of the first node, starting the first timer, and the indication being triggered by the first message.

In one embodiment, the behavior of “accompanying the first message, starting a first timer” comprises: when the first node transmits an indication to a higher layer of the first node, starting the first timer, and the indication being triggered by the first message.

In one embodiment, the behavior of “accompanying the first message, starting a first timer” comprises: the behavior of starting a first timer is related to transmitting the first message.

In one embodiment, the behavior of “accompanying the first message, starting a first timer” comprises: the behavior of starting a first timer is related to receiving a response to the first message.

In one embodiment, the behavior of “accompanying the first message, starting a first timer” comprises: the first message being transmitted is a necessary condition for the behavior of starting a first timer.

In one embodiment, the behavior of “accompanying the first message, starting a first timer” comprises: once the first message is transmitted, starting the first timer.

In one embodiment, the behavior of “accompanying the first message, starting a first timer” comprises: upon a transmission of the first message, the first timer is activated by a first symbol after the first message is transmitted or retransmitted.

In one embodiment, the behavior of “accompanying the first message, starting a first timer” comprises: upon a transmission of the first message, the first timer is initiated at a given Physical Downlink Control Channel (PDCCH) occasion.

In one embodiment, the behavior of “accompanying the first message, starting a first timer” comprises: when the first message is triggered, activating the first timer.

In one embodiment, the behavior of “accompanying the first message, starting a first timer” comprises: when preparing to transmit the first message, starting the first timer.

In one embodiment, the behavior of “accompanying the first message, starting a first timer” comprises: upon a transmission of the first message, starting the first timer.

In one embodiment, the behavior of “accompanying the first message, starting a first timer” comprises: following the transmission of the first message, starting the first timer.

In one embodiment, the behavior of “accompanying the first message, starting a first timer” comprises: upon setting of the first message, starting the first timer.

In one embodiment, the behavior of “accompanying the first message, starting a first timer” comprises: upon initialization of an SDT procedure to which the first message belongs, starting the first timer.

In one embodiment, the behavior of “accompanying the first message, starting a first timer” comprises: upon initiation of the SDT procedure which the first message belongs, starting the first timer.

In one embodiment, the behavior of “accompanying the first message, starting a first timer” comprises: upon reception of response to the first message, activating the first timer.

In one embodiment, the behavior of “accompanying the first message, starting a first timer” comprises: upon start of the first timer, the first message is transmitted.

In one embodiment, the behavior of “accompanying the first message, starting a first timer” comprises: after the first message is transmitted, and data of a first one of logical channels associated with a first-type DRB is prepared to be transmitted or under a transmission or after being transmitted, the first timer is activated.

In one embodiment, the behavior of “accompanying the first message, starting a first timer” comprises: after the first message is transmitted and data of a first one of logical channels associated with a first-type Data Radio Bearer (DRB) is received, the first timer is activated.

In one embodiment, the behavior of “accompanying the first message, starting a first timer” comprises: just-before the transmission of the first message.

In one embodiment, transmit the first message, receive a first feedback, transmit first DRB data and start a first timer.

In one subembodiment of the embodiment, the first DRB data is data of a first one of logical channels associated with a first-type DRB transmitted in an SDT procedure.

In one subembodiment of the embodiment, the first message comprises a CCCH SDU and the first message does not comprise data of a logical channel associated with a first-type DRB.

In one embodiment, transmit the first message, receive a second feedback and start a first timer.

In one subembodiment of the embodiment, the second DRB data is data of a first one of logical channels associated with a first-type DRB received in an SDT procedure.

In one subembodiment of the embodiment, the first message comprises a CCCH SDU and the first message does not comprise data of a logical channel associated with a first-type DRB.

In one embodiment, the first timer is a timer of RRC layer.

In one embodiment, the first timer is a timer of PDCP layer.

In one embodiment, the first timer is a timer of RLC layer.

In one embodiment, the first timer is a timer of MAC layer.

In one embodiment, the first timer is T319.

In one embodiment, the first timer is not T319.

In one embodiment, the first timer is related to SDT procedure.

In one embodiment, when the first timer is started, timer T319 is not started.

In one embodiment, the first timer and timer T319 are not started at the same time.

In one embodiment, a name of the first timer comprises T3xy, the xy is a positive integer not greater than 99, and the xy is not equal to any value of 01, or 02, or 04, or 10, or 11, or 12, or 16, or 19, or 20, or 21, or 22, or 25, or 30, or 31, or 42, or 45, or 46, or 50, or 80, or 90.

In one embodiment, a name of the first timer comprises T319a.

In one embodiment, a name of the first timer comprises T319b.

In one embodiment, a name of the first timer comprises at least one of sdt or idt or inactive or small or data or transmission or timer.

In one embodiment, the first timer comprises ra-ContentionResolutionTimer.

In one embodiment, the first timer comprises msgB-ResponseWindow.

In one embodiment, the phrase that the first timer is in a running state comprises: the first timer is running.

In one embodiment, the phrase that the first timer is in a running state comprises: the first timer is started, and the first timer is stopped or expired.

In one embodiment, the phrase that the first timer is in a running state comprises: the first timer is started, and a timing of the first timer does not reach a current expiration value of the first timer.

In one embodiment, the phrase that the first timer is in a running state comprises: when the first timer is running.

In one embodiment, the first timer is restarted after being started.

In one embodiment, the first timer is not restarted after being started.

In one embodiment, during a time interval between the first timer being started and the second message being received, the first timer continues timing.

In one embodiment, during a time interval between the first timer being started and the first signaling being received, the first timer continues timing.

In one embodiment, during a time interval between the first timer being started and the first timer being expired, the first timer continues timing.

In one embodiment, the meaning of the continuing timing refers to that timing of the first timer is not interrupted.

In one embodiment, the meaning of the continuing timing refers to that timing of the first timer is reset to zero and continues timing.

In one embodiment, the meaning of the continuing timing refers to that timing of the first timer is not stopped exceeding a certain time interval.

In one embodiment, the meaning of the continuing timing refers to that timing of the first timer is stopped exceeding 1 ms.

In one embodiment, the second message is transmitted via an air interface.

In one embodiment, the second message is transmitted via an antenna port.

In one embodiment, the second message is transmitted through an upper-layer signaling.

In one embodiment, the second message is transmitted through a higher-layer signaling.

In one embodiment, the second message comprises a Downlink signal.

In one embodiment, the second message comprises a sidelink signal.

In one embodiment, the first message is transmitted through an SRB.

In one embodiment, the first message is transmitted through an SRB1.

In one embodiment, the first message is transmitted through an SRB2.

In one embodiment, the first message is transmitted through an SRB3.

In one embodiment, the first message is transmitted through a CCCH.

In one embodiment, the first message is transmitted through a DCCH.

In one embodiment, the second message comprises a Msg4.

In one embodiment, the second message comprises a Msg B.

In one embodiment, the phrase that the second message comprises an RRC message comprises: the second message is an RRC message.

In one embodiment, the phrase that the second message comprises an RRC message comprises: the RRC message comprises at least one IE in an RRC message.

In one embodiment, the phrase that the second message comprises an RRC message comprises: the RRC message comprises at least one field in an RRC message.

In one embodiment, the phrase that the second message comprises an RRC message comprises: the second message comprises a MAC PDU, the MAC PDU comprises a MAC SDU and the MAC SDU carries the RRC message.

In one embodiment, the second message is monitored through a TEMPORARY C-RNTI.

In one embodiment, the second message is monitored through an MSGB-RNTI.

In one embodiment, the second message is monitored through a C-RNTI.

In one embodiment, the second message comprises an RRC message.

In one subembodiment of the embodiment, the RRC message comprises an RRCRelease message.

In one subembodiment of the embodiment, the RRC message comprises an RRCResume message.

In one subembodiment of the embodiment, the RRC message comprises an RRCSetup message.

In one subembodiment of the embodiment, the RRC message comprises an RRCReject message.

In one subembodiment of the embodiment, the RRC message comprises an RRCConnectionRelease message.

In one subembodiment of the embodiment, the RRC message comprises an RRCConnectionResume message.

In one subembodiment of the embodiment, the RRC message comprises an RRCConnectionSetup message.

In one subembodiment of the embodiment, the RRC message comprises an RRCConnectionReject message.

In one subembodiment of the embodiment, the RRC message comprises an RRCEarlyDataComplete message.

In one subembodiment of the embodiment, the RRC message comprises an RRCRelease message, or an RRCResume message, or an RRCSetup message, or an RRCReject message, or an RRCConnectionRelease message, or an RRCConnectionResume message, or an RRCConnectionSetup message, or an RRCConnectionReject message, or an RRCEarlyDataComplete message.

In one subembodiment of the embodiment, a name of the RRC message comprises at least one of RRC, Connection, Resume, Release, Resume, RRCReject, Setup, Reconfiguration, Complete, sdt, idt, Inactive, Small, Data, or Transmission.

In one embodiment, the meaning of the monitoring comprises searching.

In one embodiment, the meaning of monitoring comprises monitoring.

In one embodiment, the meaning of the monitoring comprises passing Cyclic Redundancy Check (CRC) check.

In one embodiment, the behavior of monitoring a second message comprises: monitoring a first-type DCI in a first time-frequency resource pool; the first-type DCI comprises scheduling information of a first-type channel, and the second message occupies at least one the first-type channel.

In one subembodiment of the embodiment, the monitoring a first-type DCI comprises performing a blind detection on the first-type DCI.

In one subembodiment of the embodiment, the monitoring a first-type DCI comprises performing channel decoding respectively among multiple PDCCH candidates.

In one subembodiment of the embodiment, the monitoring a first-type DCI comprises judging whether the first-type DCI is detected based on the CRC.

In one subembodiment of the embodiment, the first time-frequency resource pool only occurs in partial time-domain resources in a search space.

In one subembodiment of the embodiment, the first time-frequency resource pool comprises a segment of continuous time-domain resources.

In one subembodiment of the embodiment, the first time-frequency resource pool comprises a segment of discontinuous time-domain resources.

In one subembodiment of the embodiment, the first time-frequency resource pool is periodic.

In one subembodiment of the embodiment, the first time-frequency resource pool is aperiodic.

In one subembodiment of the embodiment, the first time-frequency resource pool comprises multiple Resource Elements (REs).

In one subembodiment of the embodiment, the first time-frequency resource pool comprises multiple Control Channel Elements (CCEs).

In one subembodiment of the embodiment, the first time-frequency resource pool comprises a segment of continuous frequency-domain resources.

In one subembodiment of the embodiment, the first time-frequency resource pool comprises a segment of discontinuous frequency-domain resources.

In one subembodiment of the embodiment, the first time-frequency resource pool comprises one or multiple Resource Elements (REs).

In one subembodiment of the embodiment, the first time-frequency resource pool belongs to a first search space.

In one subsidiary embodiment of the above embodiment, the first search space is associated with the first time-frequency resource pool.

In one subsidiary embodiment of the above embodiment, the first search space corresponds to the first time-frequency resource pool.

In one subsidiary embodiment of the above embodiment, the first time-frequency resource pool is a part of time-frequency resources allocated to a first search space.

In one subembodiment of the embodiment, the first time-frequency resource pool is associated with TEMPORARY C-RNTI.

In one subembodiment of the embodiment, the first time-frequency resource pool is associated with an MSGB-RNTI.

In one subembodiment of the embodiment, the first time-frequency resource pool is associated with a C-RNTI.

In one subembodiment of the embodiment, the first time-frequency resource pool comprises multiple REs.

In one subembodiment of the embodiment, the first time-frequency resource pool comprises multiple CCEs.

In one subembodiment of the embodiment, the first time-frequency resource pool comprises at least one PDCCH candidate.

In one subembodiment of the embodiment, the first time-frequency resource pool belongs to a same search space.

In one subembodiment of the embodiment, the first-type DCI is scrambled by an MSGB-RNTI.

In one subembodiment of the embodiment, the first-type DCI is scrambled by a TEMPORARY_C-RNTI.

In one subembodiment of the embodiment, the first-type DCI is scrambled by a C-RNTI.

In one subembodiment of the embodiment, the first-type DCI is used for DownLink Grant.

In one subembodiment of the embodiment, the first-type DCI comprises DCI format 1_0.

In one subembodiment of the embodiment, the first-type DCI comprises DCI format 1_1.

In one subembodiment of the above embodiment, the phrase that the first-type DCI comprises scheduling information of a first-type channel comprises: the first-type DCI comprises at least one of time-domain position, frequency-domain position, Modulation and Coding Scheme (MCS), Redundancy Version (RV), New Data Indicator (NDI), or Hybrid Automatic Repeat reQuest (HARQ) process number of the first-type channel.

In one subsidiary embodiment of the subembodiment, the time-domain position comprises resource allocation in time domain.

In one subsidiary embodiment of the subembodiment, the time-domain position is calculated according to chapter 5.1.2.1 in TS 38.214.

In one subsidiary embodiment of the subembodiment, the frequency-domain position comprises resource allocation in frequency domain.

In one subsidiary embodiment of the subembodiment, the frequency-domain position is calculated according to chapter 5.1.2.2.2 in TS 38.214.

In one subsidiary embodiment of the subembodiment, the MCS comprises at least one of modulation order (Qm) or target code rate (R).

In one subsidiary embodiment of the subembodiment, the RV is determined based on a field in the first-type DCI, and the field comprises a redundant version field (rv).

In one subsidiary embodiment of the subembodiment, the NDI is determined based on a field in the first-type DCI, and the field comprises an NDI field.

In one subsidiary embodiment of the subembodiment, the HARQ process number is determined based on a field in the first-type DCI, and the field comprises a HARQ process number field.

In one subembodiment of the embodiment, the phrase that the second message occupies at least one the first-type channel comprises: the first-type channel is a physical-layer channel used for transmitting the second message.

In one subembodiment of the embodiment, the phrase that the second message occupies at least one the first-type channel comprises: the second message is transmitted through the first-type channel.

In one subembodiment of the embodiment, the first-type channel comprises a Physical Downlink Shared Channel (PDSCH).

In one subembodiment of the embodiment, the first-type channel comprises a Downlink Shared Channel (DL-SCH).

In one subembodiment of the embodiment, other bit blocks can also be comprised on the at least one the first-type channel occupied by the second message.

In one subsidiary embodiment of the subembodiment, the other bit blocks comprise a MAC Control Element (CE).

In one subsidiary embodiment of the subembodiment, the other bit blocks comprise a PDCP PDU from a DRB.

In one subsidiary embodiment of the subembodiment, the other bit blocks comprise an RRC message other than the second message.

In one embodiment, the behavior of monitoring a second message comprises: transferring data received by the lower layer to the higher layer, and determining whether the data received by the lower layer is the second message at the higher layer.

In one embodiment, the behavior of monitoring a second message is only executed during a running period of the first timer.

In one embodiment, the behavior of monitoring a second message comprises: monitoring a first-type DCI in at least one search space until the second message is detected or the first timer is expired, and a scheduling signaling of the second message comprising at least one first-type DCI.

In one embodiment, the lower layer comprises a physical layer.

In one embodiment, the lower layer comprises a MAC layer.

In one embodiment, the higher layer comprises a Radio Link Control Protocol (RLC) layer.

In one embodiment, the higher layer comprises an RRC layer.

In one embodiment, the behavior of monitoring a signal comprises: determining whether there exists the signal through at least one of energy monitoring, coherent detection, broadband detection, correlation detection, synchronous detection, waveform detection, or maximum likelihood detection.

In one subembodiment of the above embodiment, the signal is the second message.

In one subembodiment of the above embodiment, the signal is the first-type DCI.

In one embodiment, the behavior of receiving a first signaling via an air interface when the first timer is running comprises: when the first timer is in a running state, receiving a first signaling.

In one embodiment, the behavior of receiving a first signaling via an air interface when the first timer is running comprises: when the first signaling is received via the air interface, the first timer is in a running state.

In one embodiment, the behavior of receiving a first signaling via an air interface when the first timer is running comprises: monitoring a PDCCH while the first timer is running, and receiving a first signaling via an air interface based on the PDCCH.

In one embodiment, the phrase of as a response to the behavior of receiving a first signaling comprises: when the first signaling is received.

In one embodiment, the phrase of as a response to the behavior of receiving a first signaling comprises: if the first signaling is received.

In one embodiment, a first signaling is received via an air interface when the first timer is running.

In one subembodiment of the embodiment, the air interface comprises an interface between two UEs.

In one subembodiment of the embodiment, the air interface comprises an interface between two gNBs/eNGs.

In one subembodiment of the embodiment, the air interface comprises an interface between a UE and a gNB/eNB.

In one subembodiment of the embodiment, the air interface comprises an interface between the first node and the second node.

In one subembodiment of the embodiment, the air interface comprises an Xn interface.

In one subembodiment of the embodiment, the air interface comprises an X2 interface.

In one subembodiment of the embodiment, the air interface comprises an NG interface.

In one subembodiment of the embodiment, the air interface comprises an X2-C interface.

In one subembodiment of the embodiment, the air interface comprises an F1 interface.

In one subembodiment of the embodiment, the air interface comprises a Uu interface.

In one subembodiment of the embodiment, the air interface comprises an LTE Uu interface.

In one subembodiment of the embodiment, the air interface comprises an NR Uu interface.

In one subembodiment of the embodiment, the air interface comprises a PC5 interface.

In one subembodiment of the embodiment, the air interface is a radio interface.

In one subembodiment of the embodiment, the air interface is a wired interface.

In one embodiment, a first signaling is received through an interlayer interface when the first timer is running.

In one subembodiment of the embodiment, the interlayer interface refers to an interface between a MAC layer of the first node and a higher layer of the first node.

In one subsidiary embodiment of the above subembodiment, the higher layer of the first node transmits the first signaling to the MAC layer of the first node.

In one subsidiary embodiment of the above subembodiment, the MAC layer of the first node receives the first signaling from the higher layer of the first node.

In one subsidiary embodiment of the above subembodiment, the higher layer comprises a non-Access Stratum (NAS) layer.

In one subsidiary embodiment of the above subembodiment, the higher layer comprises an Access Stratum (AS) layer.

In one subsidiary embodiment of the above subembodiment, the higher layer comprises an RRC layer.

In one subsidiary embodiment of the above subembodiment, the higher layer comprises a PDCP layer.

In one subsidiary embodiment of the above subembodiment, the higher layer comprises an RLC layer.

In one subembodiment of the embodiment, the first signaling is an indication.

In one subembodiment of the embodiment, the first signaling is a notification.

In one subembodiment of the embodiment, the first signaling is a cross-layer indication.

In one embodiment, the first signaling is transmitted via an air interface.

In one embodiment, the first signaling is transmitted via an antenna port.

In one embodiment, the first signaling is transmitted through an upper-layer signaling.

In one embodiment, the first signaling is transmitted through a higher-layer signaling.

In one embodiment, the first signaling comprises a Downlink (DL) signal.

In one embodiment, the first signaling comprises a sidelink signal.

In one embodiment, the first signaling comprises a higher-layer message.

In one embodiment, the first signaling comprises an RRC-layer message.

In one embodiment, the first signaling comprises a PDCP-layer message.

In one embodiment, the first signaling comprises an RLC-layer message.

In one embodiment, the first signaling comprises a MAC-layer message.

In one embodiment, the first signaling comprises a physical signal.

In one embodiment, the first signaling comprises at least one field in a DCI.

In one embodiment, the first signaling comprises at least one field in a UCI.

In one embodiment, the first signaling comprises a MAC PDU.

In one embodiment, the first signaling comprises at least one field in a MAC PDU.

In one embodiment, the first signaling comprises a MAC sub-PDU.

In one embodiment, the first signaling comprises at least one field in a MAC sub-PDU.

In one embodiment, the first signaling comprises a MAC CE.

In one embodiment, the first signaling comprises at least one field in a MAC CE.

In one embodiment, the first signaling comprises a MAC MSGB.

In one embodiment, the first signaling comprises a Logical Channel ID (LCID) field in a MAC MSGB.

In one embodiment, the first signaling comprises an extended Logical Channel ID (eLCID) field in a MAC MSGB.

In one embodiment, the first signaling comprises a Reserved (R) field in a MAC MSGB.

In one embodiment, the first signaling comprises a Format (F) field in a MAC MSGB.

In one embodiment, the first signaling comprises a Length (L) field in a MAC MSGB.

In one embodiment, the first signaling comprises a MAC CE, the MAC CE comprises 0 bit, and the MAC CE is set as a MAC MSGB identifier with a given value by an LCID field.

In one subembodiment of the above embodiment, the LCID field is set as the given value to indicate restarting the first timer or triggering a first buffer status report.

In one subembodiment of the above embodiment, the given value is a code-point or index, the given value is a positive integer, and the given value indicates a value of an LCID.

In one subembodiment of the above embodiment, the given value is equal to one of 35, 36, . . . , 45 and 46.

In one subembodiment of the above embodiment, the given value is not equal to 0, or 33, or 34, or any integer that is not less than 47 and not greater than 63.

In one subembodiment of the above embodiment, the first signaling being set as a given value is used to indicate restarting the first timer; the first signaling being set as another given value is used to indicate triggering a first buffer status report; the given value is different from the another given value.

In one embodiment, the first signaling explicitly indicates restarting the first timer or triggering the first buffer status report.

In one subembodiment of the embodiment, the first signaling explicitly indicates restarting the first timer.

In one subembodiment of the embodiment, the first signaling explicitly indicates triggering the first buffer status report.

In one subembodiment of the embodiment, a bit in the first signaling indicates whether to restart the first timer.

In one subsidiary embodiment of the subembodiment, the bit being set to 1 is used to indicate restarting the first timer.

In one subsidiary embodiment of the subembodiment, the bit being set to 0 is not used to indicate restarting the first timer.

In one subembodiment of the embodiment, whether the signaling is set is used to indicate whether to restart the first timer.

In one subsidiary embodiment of the subembodiment, the signaling being setup is used to indicate restarting the first timer.

In one subsidiary embodiment of the subembodiment, the signaling not being setup is not used to indicate restarting the first timer.

In one subembodiment of the embodiment, whether a received message comprises the first signaling is setup to indicate whether to restart the first timer.

In one subsidiary embodiment of the subembodiment, a received message comprising the first signaling is used to indicate restarting the first timer.

In one subsidiary embodiment of the subembodiment, a received message not comprising the first signaling is not used to indicate restarting the first timer.

In one embodiment, the first signaling implicitly indicates restarting the first timer or triggering the first buffer status report.

In one subembodiment of the embodiment, the first signaling implicitly indicates restarting the first timer.

In one subembodiment of the embodiment, whether the first signaling comprises the first timer is used to indicate whether to restart the first timer.

In one subsidiary embodiment of the subembodiment, the first signaling comprising the first timer is used to indicate restarting the first timer.

In one subsidiary embodiment of the subordinate subembodiment, the first signaling is used to reconfigure the first timer.

In one subsidiary embodiment of the subordinate subembodiment, the first signaling comprises a name of the first timer.

In one subsidiary embodiment of the subordinate subembodiment, the first signaling comprises an expiration value of the first timer.

In one subsidiary embodiment of the subordinate subembodiment, the first signaling comprises an offset for the first timer.

In one subsidiary embodiment of the subembodiment, the first signaling not comprising the first timer is not used to indicate restarting the first timer.

In one subembodiment of the embodiment, whether the first signaling comprises uplink resources is used to indicate whether to reconfigure the first timer.

In one subsidiary embodiment of the subembodiment, the first signaling comprising uplink resources is used to indicate reconfiguring the first timer.

In one subsidiary embodiment of the subembodiment, the first signaling not comprising uplink resources is not used to indicate reconfiguring the first timer.

In one subembodiment of the embodiment, the first signaling implicitly indicates triggering the first buffer status report.

In one subembodiment of the embodiment, whether the first signaling comprises uplink resources is used to indicate whether to trigger the first buffer status report.

In one subsidiary embodiment of the subembodiment, the first signaling comprising uplink resources is used to indicate triggering the first buffer status report.

In one subsidiary embodiment of the subembodiment, the first signaling not comprising uplink resources is not used to indicate triggering the first buffer status report.

In one embodiment, the first signaling comprising a UL grant is used to determine that the first signaling comprises uplink resources.

In one embodiment, the UL grant is dynamically received through a PDCCH.

In one embodiment, the UL grant is dynamically received through an RAR.

In one embodiment, the UL grant is configured semi-persistently by an RRC message.

In one embodiment, the UL grant is determined through PUSCH resources associated with MSGA.

In one embodiment, the UL grant is a configured uplink grant.

In one embodiment, the phrase of “as a response to the behavior of receiving a first signaling, restarting the first timer or triggering a first buffer status report” comprises: as a response to the behavior of receiving a first signaling, restarting the first timer.

In one subembodiment of the embodiment, the meaning of the phrase of “as a response to the behavior of receiving a first signaling, restarting the first timer” comprises: the behavior of receiving a first signaling is used to restart the first timer.

In one subembodiment of the embodiment, the meaning of the phrase of “as a response to the behavior of receiving a first signaling, restarting the first timer” comprises: the first signaling indicates restarting the first timer.

In one subembodiment of the embodiment, the meaning of the phrase of “as a response to the behavior of receiving a first signaling, restarting the first timer” comprises: when the first signaling is received, restarting the first timer.

In one embodiment, the phrase of “as a response to the behavior of receiving a first signaling, restarting the first timer or triggering a first buffer status report” comprises: as a response to the behavior of receiving a first signaling, triggering a first buffer status report.

In one subembodiment of the embodiment, the meaning of the phrase of “as a response to the behavior of receiving a first signaling, triggering a first buffer status report” comprises: the behavior of receiving a first signaling is used to determine triggering the first buffer status report.

In one subembodiment of the embodiment, the meaning of the phrase of “as a response to the behavior of receiving a first signaling, triggering a first buffer status report” comprises: the behavior of receiving the first signaling is a triggering condition for the first buffer status report.

In one embodiment, the phrase of “as a response to the behavior of receiving a first signaling, restarting the first timer or triggering a first buffer status report” comprises: as a response to the behavior of receiving a first signaling, restarting the first timer and triggering a first buffer status report.

In one subembodiment of the embodiment, the meaning of the phrase of “as a response to the behavior of receiving a first signaling, restarting the first timer and triggering a first buffer status report” comprises: the behavior of receiving a first signaling is used to determine restarting the first timer and triggering a first buffer status report.

In one subembodiment of the embodiment, the meaning of the phrase of “as a response to the behavior of receiving a first signaling, restarting the first timer and triggering a first buffer status report” comprises: the behavior of receiving a first signaling is restarting the first timer and a triggering condition for triggering a first buffer status report.

In one embodiment, the behavior of restarting the first timer comprises: stopping the first timer and immediately starting the first timer.

In one embodiment, the behavior of restarting the first timer comprises: resetting timing of the first timer to zero and restarting timing from 0.

In one embodiment, the behavior of restarting the first timer comprises: restarting the first timer.

In one embodiment, the behavior of restarting the first timer comprises: the first timer is reset to zero and continues running.

In one embodiment, the behavior of triggering a first buffer status report comprises: triggering a first buffer status report.

In one embodiment, after the behavior of triggering a first buffer status report, a first MAC CE is generated.

In one embodiment, after the behavior of triggering a first buffer status report, the first MAC CE is not generated.

In one embodiment, the first buffer status report comprises a Buffer Status Report (BSR).

In one embodiment, the first buffer status report comprises a Data Volume Report (DVR).

In one embodiment, the first buffer status report is used to provide a UL data volume of a MAC entity.

In one subembodiment of the embodiment, the uplink data belongs to a first logical channel group (LCG), and the LCG comprises at least one logical channel.

In one subsidiary embodiment of the above subembodiment, the first logical channel group is any logical channel group among Q1 logical channel group(s), Q1 being a positive integer.

In one subordinate embodiment of the subsidiary embodiment, for the SDT procedure, Q1 is equal to 1.

In one subordinate embodiment of the subsidiary embodiment, for the SDT procedure, Q1 is equal to 2.

In one subordinate embodiment of the subsidiary embodiment, Q1 is equal to 8.

In one subordinate embodiment of the subsidiary embodiment, Q1 is not greater than 8.

In one subembodiment of the embodiment, the uplink data volume is a sum of valid data on all logical channels in a logical channel group after a MAC PDU is established.

In one subembodiment of the embodiment, the uplink data volume does not calculate a size of an RLC header and a MAC MSGB.

In one subembodiment of the embodiment, the uplink data volume calculates a size of an RLC header and a MAC MSGB.

In one embodiment, if the second message is not received and the first timer is running, continue monitoring the second message.

In one embodiment, if the second message is not received and the first timer is expired, it is considered that an SDT transmission fails.

In one embodiment, if the second message is not received and the first timer is expired, update from RRC_INACTIVE state to a first RRC state.

In one embodiment, the phrase of as a response to the second message being received comprises: upon a reception of the second message.

In one embodiment, the phrase of as a response to the second message being received comprises: when the second message is received.

In one embodiment, the behavior of stopping the first timer comprises: the first timer stops running.

In one embodiment, the behavior of stopping the first timer comprises: the first timer stops timing.

In one embodiment, the behavior of stopping the first timer comprises: the first timer does not continue timing.

In one embodiment, the behavior of stopping the first timer comprises: timing of the first timer remains unchanged.

In one embodiment, the behavior of stopping the first timer comprises: suspending the first timer.

In one embodiment, the behavior of stopping the first timer comprises: the first timer is not reset to zero and maintains current timing.

In one embodiment, the behavior of stopping the first timer comprises: the first timer is reset to zero and keeps a timing value equal to zero.

In one embodiment, the behavior of stopping the first timer comprises: the first timer is reset to zero and is not restarted.

In one embodiment, the meaning of the stopping comprises stopping.

In one embodiment, the meaning of the stopping comprises suspending.

In one embodiment, the meaning of the stopping comprises ending.

In one embodiment, the phrase that the second message is used to respond to the first message comprises: the second message is a response for the first message.

In one embodiment, the phrase that the second message is used to respond to the first message comprises: the first message triggers the second message.

In one embodiment, the first message comprises an RRCResumeRequest message or an RRCResumeRequest1 message, and the second message comprises one of an RRCRelease message, an RRCResume message, an RRCSetup message, or an RRCReject message is used to determine that the second message is used to respond to the first message.

In one embodiment, the first message comprises RRCConnectionResumeRequest, and the second message comprises one of an RRCConnectionRelease message, an RRCConnectionResume message, an RRCConnectionSetup message, or an RRCConnectionReject message is used to determine that the second message is used to respond to the first message.

### Embodiment 2

Embodiment 2 illustrates a schematic diagram of a network architecture according to one embodiment of the present application, as shown in FIG. 2. FIG. 2 is a diagram illustrating a network architecture 200 of 5G NR, Long-Term Evolution (LTE) and Long-Term Evolution Advanced (LTE-A) systems. The 5G NR or LTE network architecture 200 may be called a 5G System (5GS)/Evolved Packet System (EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 is a UE.

In one embodiment, the gNB 203 corresponds to the second node in the present application.

In one embodiment, the gNB 203 is a BaseStation (BS).

In one embodiment, the gNB 203 is a UE.

In one embodiment, the gNB 203 is a relay.

In one embodiment, the gNB 203 is a gateway.

In one embodiment, the UE supports Terrestrial Network (NTN) transmission.

In one embodiment, the UE supports Non-Terrestrial Network (NTN) transmission.

In one embodiment, the UE supports communications within networks with large delay differences.

In one embodiment, the UE supports Dual Connection (DC) transmission.

In one embodiment, the UE comprises an aircraft.

In one embodiment, the UE comprises a vehicle terminal.

In one embodiment, the UE comprises a vessel.

In one embodiment, the UE comprises an Internet of Things (IoT) terminal.

In one embodiment, the UE comprises an industrial Internet of Things (IoT) terminal.

In one embodiment, the UE comprises a device supporting transmission with low-delay and high-reliability.

In one embodiment, the UE comprises test equipment.

In one embodiment, the UE comprises a signaling tester.

In one embodiment, the base station supports transmission over a non-terrestrial network.

In one embodiment, the base station supports communications within networks with large delay differences.

In one embodiment, the base station supports Terrestrial Network (NTN) transmission.

In one embodiment, the base station comprises a Marco Cellular base station.

In one embodiment, the base station comprises a Micro Cell base station.

In one embodiment, the base station comprises a Pico Cell base station.

In one embodiment, the base station comprises a Femtocell.

In one embodiment, the base station comprises a base station supporting large delay differences.

In one embodiment, the base station comprises flight platform equipment.

In one embodiment, the base station comprises satellite equipment.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises test equipment.

In one embodiment, the base station comprises a signaling tester.

In one embodiment, the base station comprises an Integrated Access and Backhaul (IAB)-node.

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises a relay.

In one embodiment, the relay comprises an L3 relay.

In one embodiment, the relay comprises an L2 relay.

In one embodiment, the relay comprises a router.

In one embodiment, the relay comprises a switcher.

In one embodiment, the relay comprises a UE.

In one embodiment, the relay comprises a base station.

### Embodiment 3

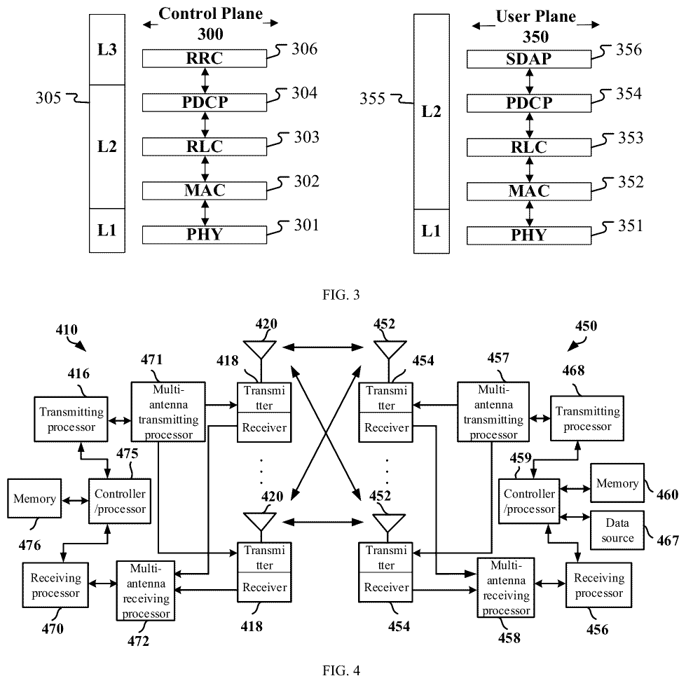

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for the control plane 300 is represented by three layers, which are a layer 1, a layer 2 and a layer 3, respectively. The layer 1 (L1) is the lowest layer and performs signal processing functions of various PHY layers. The L1 is called PHY 301 in the present application. L2 305, above the PHY 301, comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a data packet and provides support for handover. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating various radio resources (i.e., resources block) in a cell. The MAC sublayer 302 is also in charge of HARQ operation. The RRC sublayer 306 in L3 layer of the control plane 300 is responsible for acquiring radio resources (i.e., radio bearer) and configuring the lower layer with an RRC signaling. The radio protocol architecture of the user plane 350 comprises layer 1 (L1) and layer 2 (L2). In the user plane 350, the radio protocol architecture is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic.

In one embodiment, the radio protocol architecture in FIG. 3 is applicable to the first node in the present application.

In one embodiment, the radio protocol architecture in FIG. 3 is applicable to the second node in the present application.

In one embodiment, the first message in the present application is generated by the RRC 306.

In one embodiment, the first message in the present application is generated by the MAC 302 or the MAC 352.

In one embodiment, the first message in the present application is generated by the PHY 301 or the PHY 351.

In one embodiment, the first field in the present application is generated by the RRC 306.

In one embodiment, the first field in the present application is generated by the MAC 302 or the MAC 352.

In one embodiment, the first field in the present application is generated by the PHY 301 or the PHY 351.

In one embodiment, the second message in the present application is generated by the RRC 306.

In one embodiment, the second message in the present application is generated by the MAC 302 or the MAC 352.

In one embodiment, the second message in the present application is generated by the PHY 301 or the PHY 351.

In one embodiment, the first signaling in the present application is generated by the RRC 306.

In one embodiment, the first signaling in the present application is generated by the MAC 302 or the MAC 352.

In one embodiment, the first signaling in the present application is generated by the PHY 301 or the PHY 351.

In one embodiment, the second signaling in the present application is generated by the RRC 306.

In one embodiment, the second signaling in the present application is generated by the MAC 302 or the MAC 352.

In one embodiment, the second signaling in the present application is generated by the PHY 301 or the PHY 351.

In one embodiment, the third message in the present application is generated by the RRC 306.

In one embodiment, the third message in the present application is generated by the MAC 302 or the MAC 352.

In one embodiment, the third message in the present application is generated by the PHY 301 or the PHY 351.

In one embodiment, the first MAC CE in the present application is generated by the MAC 302 or the MAC 352.

### Embodiment 4

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises at least one processor and at least one memory. at least one processor and at least one memory. The at least one memory comprises computer program codes; the at least one memory and the computer program codes are configured to be used in collaboration with the at least one processor, the first communication device 450 at least: accompanying a first message, starts a first timer; transmits the first message, the first message comprises an RRC signaling; transmits a first field; monitors a second message, the second message comprises an RRC signaling, the second message is used to respond to the first message; as a response to any condition in a first condition set being satisfied, updates from RRC_INACTIVE state to a first RRC state; herein, if the second message is received, and as a response to the second message being received, stop the first timer; the first field is used to assist in determining a transmission of the second message; two conditions in the first condition set are respectively the first timer being expired and the second message being received; the first RRC state is a candidate state in a first candidate state set, and the first candidate state set comprises RRC_IDLE state.

In one embodiment, the first communication device 450 comprises at least one processor and at least one memory. a memory that stores a computer readable instruction program. The computer readable instruction program generates an action when executed by at least one processor. The action includes: accompanying a first message, starting a first timer; transmitting the first message, the first message comprising an RRC signaling; transmitting a first field; monitoring a second message, the second message comprising an RRC signaling, the second message being used to respond to the first message; as a response to any condition in a first condition set being satisfied, updating from RRC_INACTIVE state to a first RRC state; herein, if the second message is received, and as a response to the second message being received, stop the first timer; the first field is used to assist in determining a transmission of the second message; two conditions in the first condition set are respectively the first timer being expired and the second message being received; the first RRC state is a candidate state in a first candidate state set, and the first candidate state set comprises RRC_IDLE state.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: receives a first message, the first message comprises an RRC signaling; receives a first field; transmits a second message, the second message comprises an RRC signaling, the second message is used to respond to the first message; herein, accompanying the first message, a first timer is started; as a response to any condition in a first condition set being satisfied, a transmitter of the first message updates from RRC_INACTIVE state to a first RRC state; if the second message is received, as a response to the second message being received, the first timer is stopped; the first field is used to assist in determining a transmission of the second message; two conditions in the first condition set are respectively the first timer being expired and the second message being received; the first RRC state is a candidate state in a first candidate state set, and the first candidate state set comprises RRC_IDLE state.

In one embodiment, the second communication device 410 comprises a memory that stores a computer readable instruction program. The computer readable instruction program generates an action when executed by at least one processor. The action includes: receiving a first message, the first message comprising an RRC signaling. receiving a first field; transmitting a second message, the second message comprising an RRC signaling, the second message being used to respond to the first message; herein, accompanying the first message, a first timer is started; as a response to any condition in a first condition set being satisfied, a transmitter of the first message updates from RRC_INACTIVE state to a first RRC state; if the second message is received, as a response to the second message being received, the first timer is stopped; the first field is used to assist in determining a transmission of the second message; two conditions in the first condition set are respectively the first timer being expired and the second message being received; the first RRC state is a candidate state in a first candidate state set, and the first candidate state set comprises RRC_IDLE state.

In one embodiment, the antenna 452, the receiver 454, the receiving processor 456, and the controller/processor 459 are used to monitor or receive a second message; at least one of the antenna 420, the transmitter 418, the transmitting processor 416, or the controller/processor 475 is used to transmit the second message.

In one embodiment, the antenna 452, the transmitter 454, the transmitting processor 468, and the controller/processor 459 are used to transmit a first message; at least one of the antenna 420, the receiver 418, the receiving processor 470, or the controller/processor 475 is used to receive a first message.

In one embodiment, the antenna 452, the transmitter 454, the transmitting processor 468, and the controller/processor 459 are used to transmit a third message; at least one of the antenna 420, the receiver 418, the receiving processor 470, or the controller/processor 475 is used to receive a third message.

In one embodiment, the antenna 452, the transmitter 454, the transmitting processor 468, and the controller/processor 459 are used to transmit a first field; at least one of the antenna 420, the receiver 418, the receiving processor 470, or the controller/processor 475 is used to receive a first field.

In one embodiment, the antenna 452, the receiver 454, the receiving processor 456, and the controller/processor 459 are used to monitor or receive a first signaling; at least one of the antenna 420, the transmitter 418, the transmitting processor 416, or the controller/processor 475 is used to transmit the first signaling.

In one embodiment, the antenna 452, the receiver 454, the receiving processor 456, and the controller/processor 459 are used to monitor or receive a second signaling; at least one of the antenna 420, the transmitter 418, the transmitting processor 416, or the controller/processor 475 is used to transmit a second signaling.

In one embodiment, the first communication device 450 comprises at least one processor and at least one memory. at least one processor and at least one memory. The at least one memory comprises computer program codes; the at least one memory and the computer program codes are configured to be used in collaboration with the at least one processor, the first communication device 450 at least: transmits a first message, the first message comprises an RRC message; accompanying the first message, starts a first timer; monitors a second message when the first timer is in a running state; receives a first signaling when the first timer is in a running state, as a response to the behavior of receiving the first signaling, restarts the first timer or triggers a first buffer status report; herein, if the second message is received, and as a response to the second message being received, stop the first timer; the second message comprises an RRC message, and the second message is used to respond to the first message.

In one embodiment, the first communication device 450 comprises at least one processor and at least one memory. a memory that stores a computer readable instruction program. The computer readable instruction program generates an action when executed by at least one processor. The action includes: transmitting a first message, the first message comprising an RRC message; accompanying the first message, starting a first timer; monitoring a second message when the first timer is in a running state; receiving a first signaling when the first timer is in a running state, as a response to the behavior of receiving the first signaling, restarting the first timer or triggering a first buffer status report; herein, if the second message is received, and as a response to the second message being received, stop the first timer; the second message comprises an RRC message, and the second message is used to respond to the first message.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: receives a first message, the first message comprises an RRC message; transmits a second message; and transmits a first signaling; herein, accompanying the first message, a first timer is started; when the second message is received, the first timer is in a running state; when the first message is received, the first timer is in a running state; as a response to the first signaling being received, the first timer is restarted or a first buffer status report is triggered; if the second message is received, and as a response to the second message being received, stop the first timer; the second message comprises an RRC message, and the second message is used to respond to the first message.

In one embodiment, the second communication device 410 comprises a memory that stores a computer readable instruction program. The computer readable instruction program generates an action when executed by at least one processor. The action includes: receiving a first message, the first message comprising an RRC message; transmitting a second message; and transmitting a first signaling; herein, accompanying the first message, a first timer is started; when the second message is received, the first timer is in a running state; when the first message is received, the first timer is in a running state; as a response to the first signaling being received, the first timer is restarted or a first buffer status report is triggered; if the second message is received, and as a response to the second message being received, stop the first timer; the second message comprises an RRC message, and the second message is used to respond to the first message.

In one embodiment, the antenna 452, the receiver 454, the receiving processor 456, and the controller/processor 459 are used to monitor or receive a second message; at least one of the antenna 420, the transmitter 418, the transmitting processor 416, or the controller/processor 475 is used to transmit the second message.

In one embodiment, the antenna 452, the receiver 454, the receiving processor 456, the controller/processor 459 are used to receive a first signaling; at least one of the antenna 420, the transmitter 418, the transmitting processor 416, or the controller/processor 475 is used to transmit the first signaling.

In one embodiment, the antenna 452, the receiver 454, the receiving processor 456, and the controller/processor 459 are used to receive a second signaling; at least one of the antenna 420, the transmitter 418, the transmitting processor 416, or the controller/processor 475 is used to transmit the second signaling.

In one embodiment, the antenna 452, the transmitter 454, the transmitting processor 468, and the controller/processor 459 are used to transmit a first message; at least one of the antenna 420, the receiver 418, the receiving processor 470, or the controller/processor 475 is used to receive the first message.

In one embodiment, the antenna 452, the transmitter 454, the transmitting processor 468, and the controller/processor 459 are used to transmit a first MAC CE; at least one of the antenna 420, the receiver 418, the receiving processor 470, or the controller/processor 475 is used to receive the first MAC CE.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a UE that supports large delay differences.

In one embodiment, the first communication device 450 is a UE that supports NTN.

In one embodiment, the first communication device 450 is an aircraft device.

In one embodiment, the first communication device 450 has a positioning capability.

In one embodiment, the first communication device 450 does not have a positioning capability.

In one embodiment, the first communication device 450 is a UE that supports TN.

In one embodiment, the second communication device 410 is a base station (gNB/eNB/ng-eNB).

In one embodiment, the second communication device 410 is a base station that supports large delay differences.

In one embodiment, the second communication device 410 is a base station that supports NTN.

In one embodiment, the second communication device 410 is satellite equipment.

In one embodiment, the second communication device 410 is flying platform equipment.

In one embodiment, the second communication device 410 is a base station that supports TN.

### Embodiment 5A

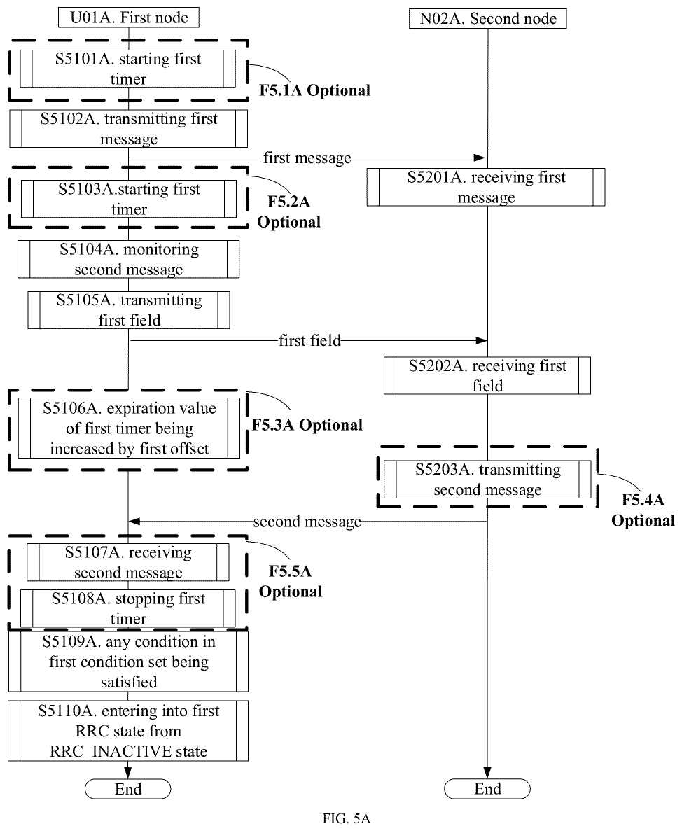

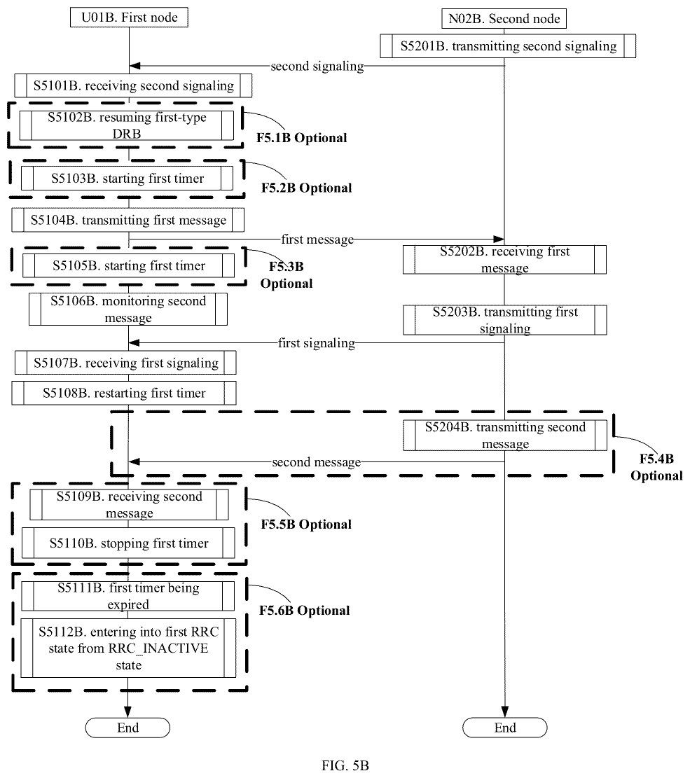

Embodiment 5A illustrates a flowchart of radio signal transmission according to one embodiment in the present application, as shown in FIG. 5. It is particularly underlined that the order illustrated in the embodiment does not put constraints over sequences of signal transmissions and implementations.

The first node U01A, in step S5101A, starts a first timer accompanying the first message; in step S5102A, transmits the first message, and the first message comprises an RRC signaling; in step S5103A, accompanying a first message, starts a first timer; in step S5104A, monitors a second message, the second message comprises an RRC signaling, the second message is used to respond to the first message; in step S5105A, transmits a first field; in step S5106A, as a response to the behavior of transmitting a first field, an expiration value of a first timer is increased by a first offset; in step S5107A, receives a second message; in step S5108A, if the second message is received, and as a response to receiving the second message, stops a first timer; in step S5109A, any condition in a first condition set is satisfied; in step S5110A, as a response to any condition in a first condition set being satisfied, updates from RRC_INACTIVE state to a first RRC state.

The second node N02A, in step S5201, receives the first message; in step S5202A, receives the first field; in step S5203A, transmits the second message.

In embodiment 5A, the first field is used to assist in determining a transmission of the second message; two conditions in the first condition set are respectively the first timer being expired and the second message being received; the first RRC state is a candidate state in a first candidate state set, and the first candidate state set comprises RRC_IDLE state; the first offset comprises at least one slot.

In one embodiment, the phrase of as a response to the behavior of transmitting a first field comprises: when the first field is transmitted.

In one embodiment, the phrase of as a response to the behavior of transmitting a first field comprises: when it is determined to transmit the first field.

In one embodiment, the phrase of as a response to the behavior of transmitting a first field comprises: when the first field is triggered.

In one embodiment, the behavior that an expiration value of the first timer is increased by a first offset comprises: prolonging an expiration time of the first timer by the first offset.

In one embodiment, the behavior that an expiration value of the first timer is increased by a first offset comprises: when the first timer runs to a first moment, the first timer continues running; herein, a time interval between the first time and a time when the first timer is started is equal to an expiration value of the first timer.

In one embodiment, the behavior that an expiration value of the first timer is increased by a first offset comprises: the first timer is expired at the second time, and a time interval between the second time and a time when the first timer is started is equal to a sum of an expiration value of the first timer and the first offset, and the first timer continues timing during a time interval between the second time and a time when the first timer is started.

In one embodiment, the slot comprises at least one of slot, or subframe, or radio frame, or frame, or multiple Orthogonal Frequency Division Multiplexing (OFDM) symbols, or multiple Single Carrier Frequency Division Multiple Access (SC-FDMA) symbols.

In one embodiment, the first offset is configured through an RRC message.

In one embodiment, the first offset is pre-configured.

In one embodiment, the first offset is determined by the first node A.

In one embodiment, the dotted box F5.1A exists.

In one embodiment, the dotted box F5.1A does not exist.

In one embodiment, the dotted box F5.2A exists.

In one embodiment, the dotted box F5.2A does not exist.

In one embodiment, the dotted box F5.3A exists.

In one embodiment, the dotted box F5.3A does not exist.

In one embodiment, the dotted box F5.4A exists.

In one embodiment, the dotted box F5.4A does not exist.

In one embodiment, the dotted box F5.5A exists.

In one embodiment, the dotted box F5.5A does not exist.

In one embodiment, one of the dotted box F5.1A and dotted box F5.2A exists.

In one embodiment, the dotted box F5.1A and dotted box F5.2A do not exist at the same time.

In one embodiment, the dotted box F5.4A exists and the dotted box F5.5A exists.

In one embodiment, the dotted box F5.4A exists and the dotted box F5.5A does not exist.

In one embodiment, the dotted box F5.4A does not exist and the dotted box F5.5A does not exist.

In one embodiment, the step S5102A and the step S5105A belong to a same step.

In one embodiment, the step S5102A is taken before the step S5105A.

### Embodiment 5B

Embodiment 5B illustrates a flowchart of radio signal transmission according to one embodiment in the present application, as shown in FIG. 5. It is particularly underlined that the order illustrated in the embodiment does not put constraints over sequences of signal transmissions and implementations.

The first node U01B receives a second signaling in step S5101B; in step S5102B, before the first message being transmitted, resumes a first-type DRB; in step S5103B, accompanying the first message, starts a first timer; in step S5104B, transmits a first message, the first message comprises an RRC message; in step S5105B, accompanying the first message, starts a first timer; in step S5106B, monitors a second message when the first timer is in a running state; in step S5107B, receives a first signaling when the first timer is in a running state; in step S5108B, as a response to the behavior of receiving a first signaling, restarts a first timer; in step S5109A, receives a second message; in step S5110B, stops a first timer; in step S5111B, the first timer is expired; in step S5112B, as a response to an expiration of the first timer, updates from RRC_INACTIVE state to a first RRC state;

The second node N02B, in step S5201B, transmits the second signaling; in step S5202B, receives the first message; in step S5203B, transmits the first signaling; in step S5204B, transmits the second message.

In embodiment 5B, if the second message is received, and as a response to the second message being received, stop the first timer; the second message comprises an RRC message, and the second message is used to respond to the first message; when the first-type DRB is resumed, the first node U01B is in RRC_INACTIVE state; the first RRC state is a candidate state in a first candidate state set, and the first candidate state set comprises RRC_IDLE state; the second signaling indicates a second expiration value of the first timer; the second signaling comprises an RRC message.

In one embodiment, the phrase that the second signaling comprises an RRC message comprises: the second signaling is an RRC message.

In one embodiment, the phrase that the second signaling comprises an RRC message comprises: the second signaling comprises at least one IE in an RRC message.

In one embodiment, the phrase that the second signaling comprises an RRC message comprises: the second signaling comprises at least one field in an RRC message.

In one embodiment, the second signaling is transmitted via an air interface.

In one embodiment, the second signaling is transmitted via an antenna port.

In one embodiment, the second signaling is transmitted through an upper-layer signaling.

In one embodiment, the second signaling is transmitted through a higher-layer signaling.

In one embodiment, the second signaling comprises a downlink signal.

In one embodiment, the second signaling comprises a sidelink signal.

In one embodiment, the second signaling comprises an RRCRelease message.

In one embodiment, the second signaling comprises a RRCConnectionRelease message.

In one embodiment, the second signaling comprises an RRCReconfiguration message.

In one embodiment, the second signaling comprises an RRCConnectionReconfiguration message.

In one embodiment, the second signaling comprises an RRCReconfigurationSidelink message.

In one embodiment, the second signaling comprises a System Information Block (SIB).

In one embodiment, the second signaling comprises a System Information Block1 (SIB1) message.

In one embodiment, the second signaling comprises an RRCResume message.

In one embodiment, the second signaling comprises an RRCConnectionResume message.

In one embodiment, the second signaling comprises a configuration of the first-type DRB.

In one embodiment, the second signaling comprises a field, and a name of the field comprises drb-ContinueROHC.

In one subembodiment of the embodiment, the drb-ContinueROHC being setup to 1 or true indicates that the first-type DRB continues using a header compression protocol context configured by the header compression protocol.

In one subembodiment of the embodiment, the drb-ContinueROHC being setup to 0 or absence indicates that the first-type DRB resets a header compression protocol context configured by the header compression protocol.

In one embodiment, the second signaling comprises a field, and a name of the field comprises nextHopChainingCount.

In one embodiment, the second signaling comprises an IE in an RRC message, and the IE comprises UE-TimersAndConstants.

In one embodiment, the second signaling comprises an IE in an RRC message, and the IE comprises CellGroupConfig.

In one embodiment, the second signaling comprises an IE in an RRC message, and the IE comprises ServingCellConfig.

In one embodiment, the second signaling comprises a field in an RRC message, and a name of the field comprises the first timer.

In one embodiment, the second signaling comprises a field in an RRC message, and a name of the field comprises SuspendConfig.

In one embodiment, the second signaling comprises a field in an RRC message, and a name of the field comprises SuspendConfig1.

In one embodiment, the second signaling comprises a field in an RRC message, and a name of the field comprises at least one of Sdt, Edt, Small, Data, Inactive, Transmission, Info, Suspend, or Config.

In one embodiment, the second signaling comprises an IE in an RRC message, and a name of the IE comprises at least one of Sdt, Edt, Small, Data, Inactive, Transmission, Info, Suspend, or Config.

In one embodiment, the phrase that the second signaling indicates a second expiration value of the first timer comprises: the second expiration value of the first timer is configured through the second signaling.

In one embodiment, the phrase that the second signaling indicates a second expiration value of the first timer comprises: the second signaling indicates that an expiration value of the first timer is configured as the second expiration value.

In one embodiment, the phrase that the second signaling indicates a second expiration value of the first timer comprises: the second expiration value of the first timer is a value of a field in the second signaling, and a name of the field comprises the first timer.

In one embodiment, a first condition set being satisfied is used to determine an initiation of the SDT procedure.

In one subembodiment of the embodiment, the first condition set comprises that a first data volume is not greater than a first threshold.

In one subsidiary embodiment of the subembodiment, the first data volume comprises a data volume on the first-type DRB.

In one subsidiary embodiment of the subembodiment, the first data volume calculates sizes of a CCCH SDU, a DTCH SDU, a BSR MAC CE, a MAC MSGB, an RLC header, and a PDCP header.

In one subsidiary embodiment of the subembodiment, the first data volume calculates sizes of a MAC subheader, an RLC header and a PDCP header.

In one subsidiary embodiment of the subembodiment, the first data volume does not comprise a data volume on other DRBs other than the first-type DRB.

In one subsidiary embodiment of the subembodiment, the first data volume does not comprise a data volume unrelated to the SDT transmission.

In one subsidiary embodiment of the above subembodiment, the first threshold is configurable.

In one subsidiary embodiment of the above subembodiment, the first threshold is pre-configured.

In one subsidiary embodiment of the above subembodiment, the first threshold comprises P1 bit(s), P1 being a positive integer.

In one subembodiment of the above embodiment, the first condition set comprising a field in RRC indicates that an execution of the SDT procedure is allowed.

In one subsidiary embodiment of the subembodiment, the field being set as setup or true is used to indicate an execution of the SDT procedure is allowed.

In one subsidiary embodiment of the subembodiment, the field being set as setup or true is used to indicate an execution of the SDT procedure is allowed.

In one embodiment, the first-type DRB is configured through an RRC message.

In one embodiment, the first-type DRB is configured through an SIB1 message.

In one embodiment, the first-type DRB is configured through an RRCRelease message.

In one embodiment, the first-type DRB is configured through an RRCConnectionRelease message.

In one embodiment, the first-type DRB comprises a DRB used for SDT transmission.

In one embodiment, the first-type DRB comprises a DRB used for IDT transmission.

In one embodiment, the first-type DRB comprises a DRB configured to be resumed in RRC_INACTIVE state.

In one embodiment, the first-type DRB comprises at least one DRB.

In one embodiment, the phrase of “before the first message being transmitted, resuming a first-type DRB” comprises: when preparing to transmit the first message, resuming the first-type DRB.

In one embodiment, the phrase of “before the first message being transmitted, resuming a first-type DRB” comprises: when initiating an SDT procedure, resuming the first-type DRB; herein, the SDT procedure comprises transmitting the first message.

In one embodiment, the phrase of “before the first message being transmitted, resuming a first-type DRB” comprises: when setting content of the first message, resuming the first-type DRB.

In one embodiment, the phrase of “before the first message being transmitted, resuming a first-type DRB” comprises: resuming the first-type DRB before submitting the first message from the RRC layer to a lower layer.

In one embodiment, the phrase of “before the first message being transmitted, resuming a first-type DRB” comprises: after content of the first message is set, and before the first message is submitted from the RRC layer to a lower layer, resuming the first-type DRB.

In one embodiment, before the first message is transmitted, reconstruct a Packet Data Convergence Protocol (PDCP) entity of the first-type DRB.

In one embodiment, before the first message is transmitted, reconstruct a Packet Data Convergence Protocol (PDCP) entity of Signaling Radio Bearer 1 (SRB1).

In one embodiment, before the first message is transmitted, reconstruct a PDCP entity of Signaling Radio Bearer 2 (SRB2).

In one embodiment, before the first message is transmitted, resume SRB1.

In one embodiment, before the first message is transmitted, resume SRB2.

In one embodiment, before the first message is transmitted, execute at least one in an action set of reconstructing a PDCP entity of the first-type DRB; reconstructing a PDCP entity of SRB1; reconstructing a PDCP entity of SRB2; resuming SRB1; resuming SRB1; or resuming a first-type DRB.

In one embodiment, the first-type DRB is used to transmit a packet in RRC_INACTIVE state.

In one embodiment, the phrase that “when the first-type DRB is resumed, the first node U01B is in RRC_INACTIVE state” comprises: when the first node U01B is in RRC_INACTIVE state, resuming the first-type DRB.

In one embodiment, the phrase that “when the first-type DRB is resumed, the first node U01B is in RRC_INACTIVE state” comprises: when the first node U01B is in RRC_INACTIVE state, resuming the first-type DRB.

In one embodiment, the phrase of “before the first message being transmitted, recovering a first-type DRB” comprises: first resuming a first-type DRB, then transmitting the first message.

In one embodiment, the phrase of “before the first message being transmitted, recovering a first-type DRB” comprises: first resuming a first-type DRB, then transmitting the first message.

In one embodiment, when an SDT procedure is initiated, before the first message being transmitted, resume a first-type DRB;

In one embodiment, the action of resuming a first-type DRB comprises: resuming the first-type DRB.

In one embodiment, the phrase that “when the first-type DRB is resumed, the first node U01B is in RRC_INACTIVE state” comprises: when the first node U01B is in RRC_INACTIVE state, resuming the first-type DRB.

In one embodiment, the phrase that “when the first-type DRB is resumed, the first node U01B is in RRC_INACTIVE state” comprises: when the first node U01B is in RRC_INACTIVE state, resuming the first-type DRB.

In one embodiment, when the first-type DRB is resumed, the second message is not received.

In one embodiment, when the first node U01B is in RRC_INACTIVE state, resume the first-type DRB, and after the first-type DRB is resumed, transmit the first message.

In one embodiment, the phrase of as a response that the first timer is expired comprises: when the first timer is expired.

In one embodiment, the phrase of as a response that the first timer is expired comprises: if the first timer is expired.

In one embodiment, the phrase of as a response that the first timer is expired comprises: after the first timer is expired.

In one embodiment, the phrase of “as a response to an expiration of the first timer, updating from RRC_INACTIVE state to a first RRC state” comprises: an expiration of the first timer triggers updating from RRC_INACTIVE state to a first RRC state.

In one embodiment, the phrase of “as a response to an expiration of the first timer, updating from RRC_INACTIVE state to a first RRC state” comprises: an expiration of the first timer is used to determine updating from RRC_INACTIVE state to a first RRC state.

In one embodiment, the phrase that the first timer is expired comprises: timing of the first timer reaches a given expiration value of the first timer.

In one subembodiment of the above embodiment, the given expiration value of the first timer is configurable.

In one subembodiment of the above embodiment, the given expiration value of the first timer is configured through an RRC message.

In one subembodiment of the above embodiment, the given expiration value of the first timer is configured through an RRCRelease message.

In one subembodiment of the above embodiment, the given expiration value of the first timer is configured through a field in an RRCRelease message.

In one subembodiment of the above embodiment, the given expiration value of the first timer is configured through an RRCReconfiguration message.

In one subembodiment of the above embodiment, the given expiration value of the first timer is configured through an SIB1 message.

In one subembodiment of the above embodiment, the given expiration value of the first timer comprises at least one slot, the slot comprises at least one of slot, or subframe, or radio frame, or frame, or multiple Orthogonal Frequency Division Multiplexing (OFDM) symbols, or multiple Single Carrier Frequency Division Multiple Access (SC-FDMA) symbols.

In one subembodiment of the above embodiment, the given expiration value comprises the first expiration value.

In one subembodiment of the above embodiment, the given expiration value comprises the second expiration value.

In one subembodiment of the above embodiment, a running time of the first timer is different from a timing of the first timer.

In one subembodiment of the above embodiment, when the first timer is not restarted, a running time of the first timer is equal to a timing of the first timer.

In one subembodiment of the above embodiment, when the first timer is restarted, a running time of the first timer is greater than a timing of the first timer.

In one embodiment, the behavior of updating from RRC_INACTIVE state to a first RRC state comprises: the first node U01B transits from RRC_INACTIVE state to the first RRC state.

In one embodiment, the behavior of updating from RRC_INACTIVE state to a first RRC state comprises: the first node U01B enters into the first RRC state from RRC_INACTIVE state.

In one embodiment, the behavior of updating from RRC_INACTIVE state to a first RRC state comprises: the first node U01B remains in the first RRC state from RRC_INACTIVE state, and the first RRC state is RRC_INACTIVE state.

In one embodiment, the first candidate state set comprises RRC_IDLE state and RRC_INACTIVE state.

In one subembodiment of the embodiment, the first RRC state is RRC_IDLE state.

In one subembodiment of the embodiment, the first RRC state is RRC_INACTIVE state.

In one embodiment, the first candidate state set does not comprise RRC_CONNECTED state.

In one embodiment, the first candidate state set comprises RRC_IDLE state, RRC_INACTIVE state and RRC_CONNECTED state.

In one subembodiment of the embodiment, the first RRC state is RRC_IDLE state.

In one subembodiment of the embodiment, the first RRC state is RRC_INACTIVE state.

In one subembodiment of the embodiment, the first RRC state is RRC_CONNECTED state.

In one embodiment, the phrase that the first RRC state is a candidate state in a first candidate state set comprises: the first RRC state belongs to the first candidate state set.

In one embodiment, the phrase that the first RRC state is a candidate state in a first candidate state set comprises: the first RRC state is one of RRC_IDLE state or RRC_INACTIVE state or RRC_CONNECTED state.

In one embodiment, as a response to an expiration of the first timer, update from RRC_INACTIVE state to RRC_IDLE state.

In one embodiment, as a response to an expiration of the first timer, update from RRC_INACTIVE state to RRC_INACTIVE state.

In one embodiment, as a response to an expiration of the first timer, update from RRC_INACTIVE state to RRC_CONNECTED state.

In one embodiment, as a response to an expiration of the first timer, suspend the first-type DRB and update it from RRC_INACTIVE state to the first RRC state; the first RRC state is the RRC_IDLE state or the RRC_CONNECTED state.

In one embodiment, the first message is used to initiate an SDT procedure.

In one subembodiment of the embodiment, the SDT procedure comprises transmitting small packets in RRC_INACTIVE state.

In one subembodiment of the embodiment, the SDT comprises RRC_INACTIVE Data Transmission (IDT).

In one subembodiment of the embodiment, the SDT procedure comprises transmitting a packet through a Data Radio Bearer (DRB) in RRC_INACTIVE state.

In one subembodiment of the embodiment, the SDT procedure comprises transmitting a packet through Msg3 or MSGB in RRC_INACTIVE state.

In one subembodiment of the embodiment, the SDT procedure comprises transmitting data of a first-type DRB on configured resources in RRC_INACTIVE state.

In one subembodiment of the embodiment, the SDT procedure comprises transmitting a packet on a resource block configured in an RRCRelease message or RRCConnectionRelease in RRC_INACTIVE state.

In one subembodiment of the embodiment, the SDT procedure comprises: before the first message is transmitted, resuming a first-type DRB.

In one embodiment, the dotted box F5.1B is optional.

In one embodiment, the dotted box F5.2B is optional.

In one embodiment, the dotted box F5.3B is optional.

In one embodiment, the dotted box F5.4B is optional.

In one embodiment, the dotted box F5.5B is optional.

In one embodiment, the dotted box F5.6B is optional.

In one embodiment, the dotted box F5.1B exists.

In one embodiment, the dotted box F5.1B does not exist.

In one embodiment, the dotted box F5.2B exists.

In one embodiment, the dotted box F5.2B does not exist.

In one embodiment, the dotted box F5.3B exists.

In one embodiment, the dotted box F5.3B does not exist.

In one embodiment, the dotted box F5.4B exists.

In one embodiment, the dotted box F5.4B does not exist.

In one embodiment, the dotted box F5.5B exists.

In one embodiment, the dotted box F5.5B does not exist.

In one embodiment, the dotted box F5.6B exists.

In one embodiment, the dotted box F5.6B does not exist.

In one embodiment, one of the dotted box F5.2B and the dotted box F5.3B exists.

In one embodiment, the dotted box F5.4B exists and the dotted box F5.5B exists.

In one embodiment, the dotted box F5.4B exists and the dotted box F5.5B does not exist.

In one embodiment, both the dotted box F5.4B and the dotted box F5.5B do not exist.

In one embodiment, the dotted box F5.4B and the dotted box F5.5B exist, and the dotted box F5.6B does not exist.

In one embodiment, at least one of the dotted box F5.4B and the dotted box F5.5B does not exist, while the dotted box F5.6B exists.

### Embodiment 6A

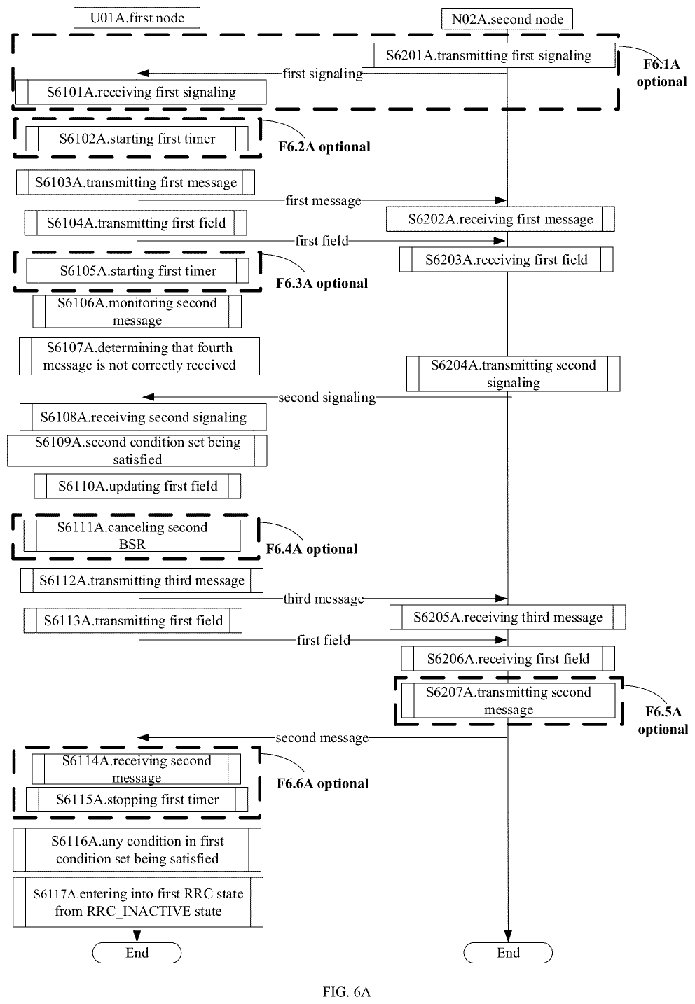

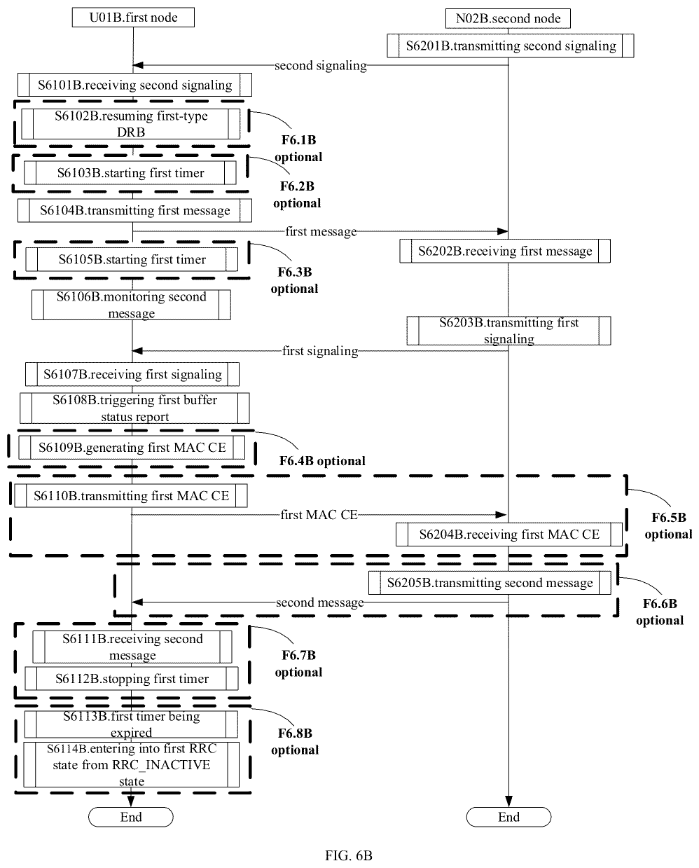

Embodiment 6A illustrates a flowchart of radio signal transmission according to another embodiment of the present application, as shown in FIG. 6A. It is particularly underlined that the order illustrated in the embodiment does not put constraints over sequences of signal transmissions and implementations.

The first node U01A, in step S6101A, receives a first signaling, and the first signaling indicates a first resource block; in step S6102A, accompanying a first message, starts a first timer; in step S6103A, transmits the first message, and the first message comprises an RRC signaling; in step S6104A, transmits a first field; in step S6105A, accompanying a first message, starts a first timer; in step S6106A, monitors a second message, the second message comprises an RRC signaling, the second message is used to respond to the first message; in step S6107A, determines that a fourth message is not correctly received, the fourth message is triggered by the first message; in step S6108A, receives a second signaling, the second signaling indicates a second resource block; in step S6109A, a second condition set is satisfied; in step S6110A, when a second condition set is satisfied, updates the first field; in step S6111A, as a response to the behavior of updating the first field, cancels a second BSR; in step S6112A, the behavior of updating the first field being used to determine a third message, transmits a third message on the second resource block; in step S6113A, transmits a first field; in step S6114A, receives a second message; in step S6115A, if the second message is received, and as a response to receiving the second message, stops a first timer; in step S6116A, any condition in a first condition set is satisfied; in step S6117A, as a response to any condition in a first condition set being satisfied, updates from RRC_INACTIVE state to a first RRC state.

The second node N02A transmits the first signaling in step S6201A; in step S6202A, receives the first message; in step S6203A, receives the first field; transmits a second signaling in step S6204A; in step S6205B, receives the third message; in step S6206A, receives the first field; in step S6207A, transmits the second message.

In embodiment 6A, the first field is used to assist in determining a transmission of the second message; two conditions in the first condition set are respectively the first timer being expired and the second message being received; the first RRC state is a candidate state in a first candidate state set, and the first candidate state set comprises RRC_IDLE state; the behavior of determining that the fourth message is not correctly received triggers the second signaling; the second condition set comprises that there exists a second data block, and the second data block arrives after the first message is assembled; the second BSR is triggered between the first message and the third message.

In one embodiment, transmit a random access preamble, and as a response to the behavior of transmitting a random access preamble, receive the first signaling.

In one subembodiment of the above embodiment, the random access (RA) preamble is used for 2-stepRA.

In one subembodiment of the above embodiment, the RA preamble is used for 4-stepRA.

In one subembodiment of the above embodiment, the RA preamble is used for SDT.

In one embodiment, the first signaling comprises a physical signal.

In one embodiment, the first signaling comprises Uplink Control Information (UCI).

In one embodiment, the first signaling comprises a MAC PDU.

In one embodiment, the first signaling comprises a MAC sub-PDU.

In one embodiment, the first signaling comprises a Random Access Response (RAR), and a field in the RAR indicates the first resource block.

In one subembodiment of the above embodiment, the RAR is a MAC RAR.

In one subembodiment of the above embodiment, the RAR is a fallback RAR.

In one subembodiment of the above embodiment, the RAR is a success RAR.

In one subembodiment of the above embodiment, the field is a UL grant field.

In one subembodiment of the above embodiment, the field comprises 27 bits.

In one embodiment, the phrase that the first signaling indicates a first resource block comprises: the first signaling is used to determine the first resource block;

In one embodiment, the phrase that the first signaling indicates a first resource block comprises: the first signaling indicates at least one of time resources or frequency resources or spatial-domain resources or code-domain resources of the first resource block.

In one embodiment, the first resource block comprises at least one of time-domain resources, frequency-domain resources, spatial-domain resources, or code-domain resources.

In one embodiment, the first resource block is a UL Grant.

In one embodiment, the first resource block is resources used for uplink.

In one embodiment, the phrase that the first message comprises the first field comprises: the first message carries the first field.

In one embodiment, the phrase that the first message comprises the first field comprises: the first field is a field in the first message.

In one embodiment, the phrase that the first message comprises the first field comprises: the first message is the first field.

In one embodiment, the phrase that the first message comprises the first field comprises: the first message comprises the first BSR.

In one embodiment, the first data block is associated with the first-type DRB.

In one embodiment, the first data block is data on a logical channel in an LCG corresponding to the first-type DRB.

In one embodiment, the first data block is data of a DTCH.

In one embodiment, the first data block is data of a DCCH.

In one embodiment, the first data block is data of a CCCH.

In one embodiment, the phrase that the first data block comprises an SDU comprises: the first data block comprises at least one SDU.

In one embodiment, the phrase that the first data block comprises an SDU comprises: the first data block comprises at least one SDU.

In one embodiment, the phrase that the first resource block cannot accommodate both the first BSR and the first data block at the same time comprises: the first resource block can accommodate the first data block, but cannot accommodate the first BSR.

In one subembodiment of the above embodiment, the first resource block comprises a UL grant.

In one subembodiment of the above embodiment, the first data block comprises all pending data available for transmission.

In one subsidiary of the embodiment, the all pending data available for transmission comprises at least one SDU.

In one subordinate embodiment of the subsidiary embodiment, the SDU comprises a CCCH SDU.

In one subordinate embodiment of the subsidiary embodiment, the SDU comprises a DCCH SDU.

In one subordinate embodiment of the subsidiary embodiment, the SDU comprises a DTCH SDU.

In one subordinate embodiment of the subsidiary embodiment, the SDU comprises a MAC SDU.

In one subordinate embodiment of the subsidiary embodiment, the SDU comprises all or part of the first message.

In one subsidiary embodiment of the subembodiment, the all pending data available for transmission comprises at least one of a CCCH SDU, a DCCH SDU, a DTCH SDU, a MAC SDU, a MAC CE, or a MAC MSGB.

In one subsidiary embodiment of the subembodiment, the all pending data available for transmission comprises at least one of a CCCH SDU, a DCCH SDU, a DTCH SDU, a MAC SDU, a MAC CE, a PDCP Data PDU, a PDCP Control PDU, a PDCP SDU, an RLC data PDU, an RLC control PDU, an RLC SDU, a PDCP header, an RLC header, or a MAC sub header.

In one subsidiary embodiment of the subembodiment, the all pending data available for transmission does not comprise a BSR MAC CE.

In one subsidiary embodiment of the subembodiment, the all pending data available for transmission comprises a BSR MAC CE.

In one subsidiary embodiment of the subembodiment, the all pending data available for transmission comprises data of the first-type DRB.

In one subsidiary embodiment of the subembodiment, the all pending data available for transmission comprises a MAC MSGB corresponding to data of the first-type DRB.

In one subembodiment of the embodiment, the first BSR comprises a BSR MAC CE and a MSGB of a BSR MAC CE.

In one embodiment, the phrase that the first resource block cannot accommodate both the first BSR and the first data block at the same time comprises: the first resource block can accommodate the first data block, but cannot accommodate a BSR MAC CE and a MAC MSGB corresponding to the first BSR.

In one embodiment, the phrase that the first resource block cannot accommodate both the first BSR and the first data block at the same time comprises: a size of the first resource block is smaller than a sum of a size of the first BSR and a size of the first data block.

In one embodiment, the phrase that the first resource is used to bear the first message comprises: the first message is transmitted on the first resource block.

In one embodiment, the phrase that the first resource is used to bear the first message comprises: the first message is transmitted through the first resource block.

In one embodiment, the phrase that the first resource is used to bear the first message comprises: the first resource block is used to transmit the first message.

In one embodiment, the behavior of determining that a fourth message is not correctly received comprises: it is considered that the fourth message is not successfully received.

In one embodiment, the behavior of determining that a fourth message is not correctly received comprises: it is considered this Contention Resolution not successful; herein, the fourth message is used for contention resolution.

In one embodiment, the behavior of determining that a fourth message is not correctly received comprises: considering random access procedure not successfully completed; herein, PREAMBLE_TRANSMISSION_COUNTER is less than a sum of preambleTransMax and 1.

In one embodiment, the behavior of determining that a fourth message is not correctly received comprises: if the first timer is expired, determining that the fourth message is not correctly received.

In one subembodiment of the embodiment, the first timer comprises a ra-ContentionResolutionTimer.

In one subembodiment of the embodiment, the first timer comprises msgB-ResponseWindow.

In one embodiment, the behavior of determining that a fourth message is not correctly received comprises: the first node U01A receives a PDCCH, and the PDCCH is addressed to a TEMPORARY_C-RNTI, and as a response to receiving the PDCCH and a MAC PDU being successfully decoded, stopping the first timer; if the MAC PDU not comprising a UE Contention Resolution Identity MAC CE or a UE Contention Resolution Identity in a UE Contention Resolution Identity MAC CE does not match a CCCH SDU in the first message, it is determined that the fourth message is not correctly received; herein, the first message comprises a first CCCH SDU, the first message is Msg3, and the behavior of determining the fourth message not correctly received refers that it is considered that contention resolution is unsuccessful.

In one embodiment, the behavior of determining that a fourth message is not correctly received comprises: the first node U01A receives a PDCCH, the PDCCH is addressed to an MSGB-RNTI, and as a response to receiving the PDCCH and a received Transmission Block (TB) being successfully decoded, stopping the first timer; if an MSGB not comprising a successRAR MAC sub-PDU or a UE Contention Resolution Identity in a successRAR MAC sub-PDU does not match a CCCH SDU in the first message, it is determined that the fourth message is not correctly received; herein, the first message comprises a first CCCH SDU, the first message is MSGA, and the behavior of determining the fourth message not correctly received refers to that a random access procedure is not successfully completed.

In one embodiment, the behavior of determining that a fourth message is not correctly received comprises: upon a reception of a NACK, it is determined that the fourth message is not correctly received; the behavior of determining the fourth message not correctly received refers to that the fourth message carries NACK.

In one embodiment, the fourth message comprises an RRC message.

In one embodiment, the fourth message does not comprise an RRC message.

In one embodiment, the fourth message comprises a PDCP layer packet.

In one embodiment, the fourth message comprises an RLC-layer data packet.

In one embodiment, the fourth message comprises a MAC PDU.

In one embodiment, the fourth message comprises a MAC SDU.

In one embodiment, the fourth message comprises a physical signal.

In one embodiment, the fourth message comprises an ACK.

In one embodiment, the fourth message is a downlink signal in an SDT procedure.

In one embodiment, the fourth message is a first one of downlink signals in the SDT procedure.

In one embodiment, the fourth message comprises the second message.

In one embodiment, the fourth message does not comprise the second message.

In one embodiment, the fourth message is Msg4 in a random access procedure.

In one embodiment, the fourth message is MSGB in a random access procedure.

In one embodiment, the fourth message comprises a UE Contention Resolution Identity MAC CE.

In one embodiment, the fourth message comprises a UE Content Resolution Identity MAC CE, and a CCCH SDU comprised in the UE Content Resolution Identity MAC CE matches a CCCH SDU in the first message.

In one embodiment, the fourth message comprises a successRAR MAC sub-PDU.

In one embodiment, the fourth message comprises a successRAR MAC sub-PDU, and a UE Content Resolution Identity in the successRAR MAC sub-PDU matches a CCCH SDU in the first message.

In one embodiment, the phrase that a fourth message is triggered by the first message comprises: when the first message is transmitted, monitoring the fourth message.

In one embodiment, the phrase that a fourth message is triggered by the first message comprises: as a response to the first message being transmitted, monitoring the fourth message.

In one embodiment, the phrase that a fourth message is triggered by the first message comprises: the fourth message is a response to the first message.

In one embodiment, the phrase that a fourth message is triggered by the first message comprises: when the base station receives the first message, transmitting the fourth message.

In one embodiment, the second signaling comprises a physical signal.

In one embodiment, the second signaling comprises Uplink Control Information (UCI).

In one embodiment, the second signaling comprises a MAC PDU.

In one embodiment, the second signaling comprises a MAC sub-PDU.

In one embodiment, the second signaling comprises an RAR, and a field in the RAR indicates the second resource block.

In one subembodiment of the above embodiment, the RAR is a MAC RAR.

In one subembodiment of the above embodiment, the RAR is a fallbackRAR.

In one subembodiment of the above embodiment, the RAR is a successRAR.

In one subembodiment of the above embodiment, the field is a UL grant field.

In one subembodiment of the above embodiment, the field comprises 27 bits.

In one embodiment, the phrase that the second signaling indicates a second resource block comprises: the second signaling is used to determine the second resource block.

In one embodiment, the phrase that the second signaling indicates a second resource block comprises: the second signaling indicates at least one of time resources or frequency resources or spatial-domain resources or code-domain resources of the second resource block.

In one embodiment, the second resource block comprises at least one of time-domain resources, frequency-domain resources, spatial-domain resources, or code-domain resources.

In one embodiment, the second resource block is a UL Grant.

In one embodiment, the second resource block is resources used for uplink.

In one embodiment, a size of the first resource block is the same as the second resource block.

In one embodiment, a size of the first resource block is different from the second resource block.

In one embodiment, the first resource block is the same as the second resource block.

In one embodiment, the first resource block is different from the second resource block.

In one embodiment, the phrase that the second condition set is satisfied comprises: any condition in the second condition set is satisfied.

In one embodiment, the phrase that the second condition set is satisfied comprises: all conditions in the second condition set are satisfied.

In one embodiment, the behavior of updating the first field comprises: modifying a value in the first field.

In one embodiment, the behavior of updating the first field comprises: updating the first field as another value.

In one embodiment, the first field comprises a field.

In one embodiment, the behavior of updating the first field comprises: setting a value in the first field to 1.

In one embodiment, the behavior of updating the first field comprises: setting a value in the first field.

In one embodiment, the behavior of updating the first field comprises: setting a value in the first field from 0 to 1.

In one embodiment, the behavior of updating the first field comprises: changing a value in the first field.

In one embodiment, the behavior of updating the first field comprises: modifying a value of the first field from a first value to a second value.

In one subembodiment of the embodiment, when the first message is transmitted, a value of the first field is equal to the first value; when the second message is transmitted, a value of the first field is equal to the second value.

In one subembodiment of the embodiment, the first value is a default value.

In one subembodiment of the embodiment, the first value is 0.

In one subembodiment of the embodiment, the first value indicates an absence of the second data block, and the second value indicates a presence of the second data block.

In one subembodiment of the above embodiment, the first value indicates that a size of the target data block does not reach the first size threshold, and the second value indicates that a size of the target data block reaches the first size threshold.

In one subembodiment of the above embodiment, the first value indicates that there is no data pending to be transmitted, and the second value indicates that there is still data pending to be transmitted.

In one subembodiment of the above embodiment, the first value indicates requesting to enter into RRC_CONNECTED state, and the second value indicates requesting to suspend an RRC connection.

In one subembodiment of the above embodiment, the first value indicates maintaining a current SDT procedure, and the second value indicates requesting terminating the SDT procedure.

In one subembodiment of the above embodiment, the first value indicates maintaining a current SDT procedure, and the second value indicates requesting prolonging the SDT procedure.

In one subembodiment of the above embodiment, the first value indicates not requesting a time alignment amount, and the second value indicates requesting a time alignment amount.

In one subembodiment of the above embodiment, the first value indicates not requesting beam failure recovery, and the second value indicates requesting beam failure recovery.

In one embodiment, the phrase that the behavior of updating the first field is used to determine a third message comprises: the third message is a message after the first field in the first message is updated.

In one embodiment, the phrase that the behavior of updating the first field is used to determine a third message comprises: the first field in the first message is updated to form the third message.

In one embodiment, values of only the first fields in the first message and the third message are different.

In one embodiment, the first message and the third message carry a same RRC message.

In one embodiment, the phrase that the behavior of updating the first field is used to determine a third message comprises: a format of a MAC PDU of the third message is the same as a format of a MAC PDU of the first message, and the first field in the first message and the first field in the third message are setup as different values.

In one embodiment, the phrase that the behavior of determining that a fourth message is not correctly received triggers the second signaling comprises: when the fourth message is not correctly received, triggering the second signaling.

In one embodiment, the phrase that the behavior of determining that a fourth message is not correctly received triggers the second signaling comprises: the behavior of determining that the fourth message is not correctly received is used to indirectly trigger the second signaling;

In one subembodiment of the embodiment, the behavior of determining that a fourth message is not correctly received triggers transmitting another random access preamble, and as a response to retransmitting a random access preamble, receive the second signaling.

In one subsidiary embodiment of the subembodiment, the another random access preamble is used for 2-step RA.

In one subsidiary embodiment of the subembodiment, the another random access preamble is used for 4-step RA.

In one subsidiary embodiment of the subembodiment, the another random access preamble is used for SDT.

In one subsidiary embodiment of the subembodiment, the another random access preamble is used for non-SDT.

In one subembodiment of the embodiment, the behavior of determining that a fourth message is not correctly received triggers retransmitting a random access preamble, and as a response to the behavior of transmitting another random access preamble, receive the second signaling.

In one embodiment, the random access preamble comprises Preamble.

In one embodiment, the random access preamble comprises a bit string.

In one embodiment, the random access preamble and the another random access preamble belong to a same random access procedure.

In one embodiment, when the another random access preamble is transmitted, PREAMBLE_TRANSMISSION_COUNTER is less than a sum of prepableTransMax and 1.

In one embodiment, the second data block comprises uplink data (UL data).

In one embodiment, the second data block comprises PDCP layer data.

In one embodiment, the second data block comprises RLC layer data.

In one embodiment, the second data block comprises MAC layer data.

In one embodiment, the second data block comprises RRC layer data.

In one embodiment, the phrase that the second condition set comprises there existing a second data block comprises: the second data block is available to a MAC entity.

In one embodiment, the phrase that the second condition set comprises there existing a second data block comprises: one condition in the second condition set is there existing a second data block.

In one embodiment, the phrase that the second condition set comprises there existing a second data block comprises: one condition in the second condition set is that a size of a target data block reaches a first size threshold.

In one subembodiment of the embodiment, the target data block comprises a first data block and a second data block.

In one subembodiment of the embodiment, the target data block is all data currently pending to be transmitted by the first node U01A.

In one subembodiment of the embodiment, the target data block is data on a logical channel with an LCID equal to a given value.

In one embodiment, the phrase that the second condition set comprises there existing a second data block comprises: one condition in the second condition set is that a size of a target data block reaches a first size threshold.

In one embodiment, the second data block is associated with the first-type DRB.

In one embodiment, the second data block comprises data on a logical channel in an LCG corresponding to the first-type DRB.

In one embodiment, the second data block comprises data of a DTCH.

In one embodiment, the second data block comprises data of a DCCH.

In one embodiment, the phrase that the second data block arrives after the first message is assembled comprises: the second data block arrives after the first message is transmitted and before the third message is transmitted.

In one embodiment, the phrase that the second data block arrives after the first message is assembled comprises: the second data block arrives after the first message is assembled and before the third message is assembled.

In one embodiment, the first data block and the second data block belong to a same LCG.

In one embodiment, the first data block and the second data block belong to a logical channel.

In one embodiment, the first data block and the second data block belong to different LCGs.

In one embodiment, the first data block and the second data block belong to different logical channels.

In one embodiment, the phrase of as a response to the behavior of updating a first field comprises: after the first field is updated.

In one embodiment, the phrase of as a response to the behavior of updating a first field comprises: upon an updated of the first field.

In one embodiment, the phrase of as a response to the behavior of updating a first field comprises: upon the behavior of updating the first field is triggered.

In one embodiment, the behavior of canceling a second BFR comprises: revoking the second BSR.

In one embodiment, the behavior of canceling a second BFR comprises: not transmitting the second BSR.

In one embodiment, the meaning of the canceling comprises cancel.

In one embodiment, the meaning of the canceling comprises delete.

In one embodiment, the second BSR is a BSR.

In one embodiment, the second BSR is a Regular BSR.

In one embodiment, the second BSR is a Periodic BSR.

In one embodiment, the second BSR is a Padding BSR.

In one embodiment, when retxBSR-Timer is expired, the second BSR is triggered.

In one embodiment, when periodicBSR-Timer is expired and at least one logical channel in an LCG comprises uplink data, the second BSR is triggered.

In one embodiment, when uplink resources are allocated and a number of padding bit(s) is equal to or greater than MSGBs of a BSR MAC CE and a BSR MAC CE, the second BSR is triggered.

In one embodiment, the phrase that the second BSR is triggered between the first message and the third message comprises: the second BSR is triggered after the first message is transmitted and before the third message is transmitted.

In one embodiment, the phrase that the second BSR is triggered between the first message and the third message comprises: the second BSR is triggered after the first message is transmitted and before the third message is assembled.

In one embodiment, the phrase that the second BSR is triggered between the first message and the third message comprises: the second BSR is triggered after the first message is assembled and before the third message is assembled.

In one embodiment, the phrase that the second BSR is triggered between the first message and the third message comprises: the second BSR is triggered after the first message is assembled and before the third message is transmitted.

In one embodiment, a time the second BSR being triggered is later than a time the first BSR being triggered.

In one embodiment, the first message comprises the first field, and the first field is a first BSR; the first resource block cannot accommodate the first BSR and the first data block at the same time; the first data block comprises an SDU; the first resource block is used to carry the first message; herein, the first signaling is received.

In one embodiment, the dotted box F6.1A exists.

In one embodiment, the dotted box F6.1A does not exist.

In one embodiment, the dotted box F6.2A exists.

In one embodiment, the dotted box F6.2A does not exist.

In one embodiment, the dotted box F6.3A exists.

In one embodiment, the dotted box F6.3A does not exist.

In one embodiment, the dotted box F6.4A exists.

In one embodiment, the dotted box F6.4A does not exist.

In one embodiment, the dotted box F6.5A exists.

In one embodiment, the dotted box F6.5A does not exist.

In one embodiment, the dotted box F6.6A exists.

In one embodiment, the dotted box F6.6A does not exist.

In one embodiment, one of the dotted box F6.2A and the dotted box F6.3A exists.

In one embodiment, the dotted box F6.3A and the dotted box F6.3A do not exist at the same time.

In one embodiment, the dotted box F6.5A exists and the dotted box F6.6A exists.

In one embodiment, the dotted box F6.5A exists and the dotted box F6.6A does not exist.

In one embodiment, the dotted box F6.5A does not exist and the dotted box F6.6A does not exist.

In one embodiment, the step S6103A and the step S6104A belong to a same step.

In one embodiment, the step S6103A is taken before the step S6104A.

In one embodiment, the step S6112A and the step S6113A belong to a same step.

In one embodiment, the step S6112A is taken before the step S6113A.

In one embodiment, accompanying the third message, the first timer is restarted.

In one embodiment, when a second condition set is satisfied, update the first field; the behavior of updating the first field is used to determine a third message.

In one subembodiment of the above embodiment, a first message comprises the first field.

In one subembodiment of the above embodiment, a first message does not comprise the first field.

### Embodiment 6B

Embodiment 6B illustrates a flowchart of radio signal transmission according to another embodiment of the present application, as shown in FIG. 6B. It is particularly underlined that the order illustrated in the embodiment does not put constraints over sequences of signal transmissions and implementations.

The first node U01B receives a second signaling in step S6101B; in step S6102B, before the first message being transmitted, resumes a first-type DRB; in step S6103B, accompanying the first message, starts a first timer; in step S6104B, transmits a first message, the first message comprises an RRC message; in step S6105B, accompanying the first message, starts a first timer; in step S6106B, monitors a second message when the first timer is in a running state; in step S6107B, receives a first signaling when the first timer is in a running state; in step S6108B, as a response to the behavior of receiving a first signaling, triggers a first buffer status report; in step S6109B, after the behavior of triggering a first buffer status report, generates a first MAC CE; in step S6110B, transmits a first MAC CE; in step S6111B, receives a second message; in step S6112B, stops a first timer; in step S6113B, the first timer is expired; in step S6114B, as a response to an expiration of the first timer, updates from RRC_INACTIVE state to a first RRC state.

The second node N02B, in step S6201B, transmits the second signaling; in step S6202B, receives the first message; in step S6203B, transmits the first signaling; in step S6204B, receives the first MAC CE; in step S6204B, transmits the second message.

In embodiment 6B, if the second message is received, and as a response to the second message being received, stop the first timer; the second message comprises an RRC message, and the second message is used to respond to the first message; when the first-type DRB is resumed, the first node U01B is in RRC_INACTIVE state; the first RRC state is a candidate state in a first candidate state set, and the first candidate state set comprises RRC_IDLE state; the first MAC CE indicates a buffer status; a priority of the first MAC CE is not lower than a priority of a second MAC CE, the second MAC CE is a MAC CE in a first candidate MAC CE set, and the first candidate MAC CE set comprises a BSR MAC CE; the second signaling indicates a second expiration value of the first timer; the second signaling comprises an RRC message.

In one embodiment, the first MAC CE comprises one byte, and byte comprises 8 bits.

In one embodiment, the first MAC CE comprises two bytes, and byte comprises 8 bits.

In one embodiment, after the behavior of triggering a first buffer status report, report the first buffer status report and generate a first MAC CE.

In one embodiment, after the behavior of triggering a first buffer status report, report the first buffer status report, when UL-SCH resources are valid for new data and can accommodate the first MAC CE and a MSGB of the first MAC CE, generate a first MAC CE.

In one embodiment, the behavior of generating a first MAC CE comprises: instructing multi-path multiplexing and Assembly procedure to generate the first MAC CE.

In one embodiment, the meaning of generation comprises generate.

In one embodiment, the first MAC CE is transmitted.

In one embodiment, the first MAC CE is not transmitted.

In one embodiment, as a response to the behavior of generating a first MAC CE, assemble the first MAC CE into a MAC PDU.

In one embodiment, as a response to the behavior of generating a first MAC CE, when a second condition set is satisfied, assemble the first MAC CE into a MAC PDU.

In one subembodiment of the above embodiment, the second condition set comprises that the first MAC CE is allowed to be assembled into the MAC PDU according to the Logical Channel Prioritization criterion, and the Logical Channel Prioritization criterion is referenced in chapter 5.4.3.1 of TS 38.321.

In one subembodiment of the above embodiment, the second condition set comprising the first buffer status report is triggered by the first signaling.

In one subsidiary embodiment of the above subembodiment, there is no valid data on all logical channels in the Q1 logical channel groups.

In one subsidiary embodiment of the above subembodiment, at least one of the Q1 logical channel groups has valid data.

In one embodiment, the first signaling comprises UCI.

In one embodiment, the first signaling comprises a UL grant.

In one embodiment, the first signaling indicates a first resource block, and the first resource block is used to trigger the first buffer status report.

In one embodiment, the first MAC CE comprises a BSR MAC CE.

In one embodiment, a format of the first MAC CE comprises a Short BSR format.

In one embodiment, a format of the first MAC CE comprises a Long BSR format.

In one embodiment, a format of the first MAC CE comprises a Short Truncated BSR format.

In one embodiment, a format of the first MAC CE comprises a Long Truncated BSR format.

In one embodiment, the first MAC CE comprises 1 byte.

In one embodiment, the first MAC CE comprises a Buffer Size field and an LCG ID field.

In one embodiment, the first MAC CE only comprises a Buffer Size field.

In one embodiment, the first MAC CE only comprises a Data Volume field.

In one embodiment, the first MAC CE comprises a Data Volume field and an LCG ID field.

In one embodiment, the first MAC CE is associated with a MAC MSGB.

In one embodiment, the first MAC CE is not associated with a MAC MSGB.

In one embodiment, the first MAC CE is indicated by a MAC MSGB with an LCID equal to one of 35, 36, . . . , 45, and 46, and the MAC MSGB is not used for other MAC CEs or MAC SDUs.

In one embodiment, the first MAC CE is indicated by a MAC MSGB with an LCID equal to one of {35, 36, . . . , 45, 46}, and the MAC MSGB is used for a MAC SDU.

In one embodiment, the first MAC CE is a BSR MAC CE generated after a Command BSR is triggered.

In one embodiment, when the first signaling is received, a BSR is triggered, and the BSR is a Command BSR.

In one embodiment, the first MAC CE is a BSR MAC CE generated by a padding BSR being triggered.

In one embodiment, when the first signaling is received, a BSR is triggered, the BSR is a padding BSR, and the first signaling comprises UL grant.

In one embodiment, the cache state refers to an amount of cache.

In one embodiment, the cache state refers to a volume of uplink data pending to be transmitted.

In one embodiment, the cache state refers to a range of uplink data volume pending to be transmitted.

In one embodiment, the cache state comprises data in MAC buffer.

In one embodiment, the cache state comprises an RLC SDU.

In one embodiment, the cache state comprises a PDCP SDU.

In one embodiment, the cache state comprises an RLC header.

In one embodiment, the cache state comprises a PDCP header.

In one embodiment, the cache state comprises a MAC SDU.

In one embodiment, the cache state comprises a MAC header.

In one embodiment, the first candidate MAC CE set does not comprise a C-RNTI MAC CE.

In one embodiment, the first candidate MAC CE set does not comprise a Configured Grant Confirmation MAC CE, a BFR MAC CE, or a Multiple Entry Configured Grant Confirmation MAC CE.

In one embodiment, the first candidate MAC CE set comprises at least one of a Sidelink Configured Grant Confirmation MAC CE, an LBT failure MAC CE, a MAC CE for SL-BSR prioritized, or the BSR MAC CE.

In one embodiment, the BSR MAC CE is a BSR MAC CE generated after a Periodic BSR is triggered.

In one embodiment, the BSR MAC CE is a BSR MAC CE generated after a Regular BSR is triggered.

In one embodiment, the BSR MAC CE is a BSR MAC CE generated after a Padding BSR is triggered.

In one embodiment, the BSR MAC CE is a BSR MAC CE generated after a Regular BSR is triggered.

In one embodiment, the phrase that the first candidate MAC CE set comprises a BSR MAC CE comprises: the first candidate MAC CE set comprises at least the BSR MAC CE.

In one embodiment, the phrase that the first candidate MAC CE set comprises a BSR MAC CE comprises: the first candidate MAC CE set only comprises the BSR MAC CE.

In one embodiment, the phrase that a priority of the first MAC CE is not lower than a priority of a second MAC CE comprises: a priority of the first MAC CE is higher than a priority of the second MAC CE.

In one embodiment, the phrase that a priority of the first MAC CE is not lower than a priority of a second MAC CE comprises: a priority of the first MAC CE is equal to a priority of the second MAC CE.

In one embodiment, the phrase that a priority of the first MAC CE is not lower than a priority of a second MAC CE comprises: when both the first MAC CE and the second MAC CE exist, the first MAC CE takes priority over the second MAC CE.

In one embodiment, the phrase that a priority of the first MAC CE is not lower than a priority of a second MAC CE comprises: when both the first MAC CE and the BSR MAC CE exist, the first MAC CE takes priority over the BSR MAC CE.

In one embodiment, the phrase that a priority of the first MAC CE is not lower than a priority of a second MAC CE comprises: an order in which the logical channels corresponding to the first MAC CE are prioritized is higher than an order in which logical channels of the second MAC CE are prioritized.

In one embodiment, the phrase that a priority of the first MAC CE is not lower than a priority of a second MAC CE comprises: for the first MAC CE and the second MAC CE, Logical channels shall be prioritized in accordance with the following order:
the first MAC CE;
the second MAC CE.

In one embodiment, the dotted box F6.1B is optional.

In one embodiment, the dotted box F6.2B is optional.

In one embodiment, the dotted box F6.3B is optional.

In one embodiment, the dotted box F6.4B is optional.

In one embodiment, the dotted box F6.5B is optional.

In one embodiment, the dotted box F6.6B is optional.

In one embodiment, the dotted box F6.7B is optional.

In one embodiment, the dotted box F6.8B is optional.

In one embodiment, the dotted box F6.1B exists.

In one embodiment, the dotted box F6.1B does not exist.

In one embodiment, the dotted box F6.2B exists.

In one embodiment, the dotted box F6.2B does not exist.

In one embodiment, the dotted box F6.3B exists.

In one embodiment, the dotted box F6.3B does not exist.

In one embodiment, the dotted box F6.4B exists.

In one embodiment, the dotted box F6.4B does not exist.

In one embodiment, the dotted box F6.5B exists.

In one embodiment, the dotted box F6.5B does not exist.

In one embodiment, the dotted box F6.6B exists.

In one embodiment, the dotted box F6.6B does not exist.

In one embodiment, the dotted box F6.7B exists.

In one embodiment, the dotted box F6.7B does not exist.

In one embodiment, the dotted box F6.8B exists.

In one embodiment, the dotted box F6.8B does not exist.

In one embodiment, one of the dotted boxes F6.2B and F6.3B exists.

In one embodiment, the dotted box F6.4B exists and the dotted box F6.5B exists.

In one embodiment, the dotted box F6.4B exists and the dotted box F6.5B does not exist.

In one embodiment, the dotted box F6.6B exists and the dotted box F6.7B exists.

In one embodiment, the dotted box F6.6B exists and the dotted box F6.7B does not exist.

In one embodiment, the dotted box F6.6B and the dotted box F6.7B do not exist.

In one embodiment, the dotted boxes F6.6B and F6.7B exist, while the dotted box F6.8B does not exist.

In one embodiment, at least one of the dotted boxes F6.6B and F6.7B does not exist, and the dotted box F6.8B exists.

### Embodiment 7A

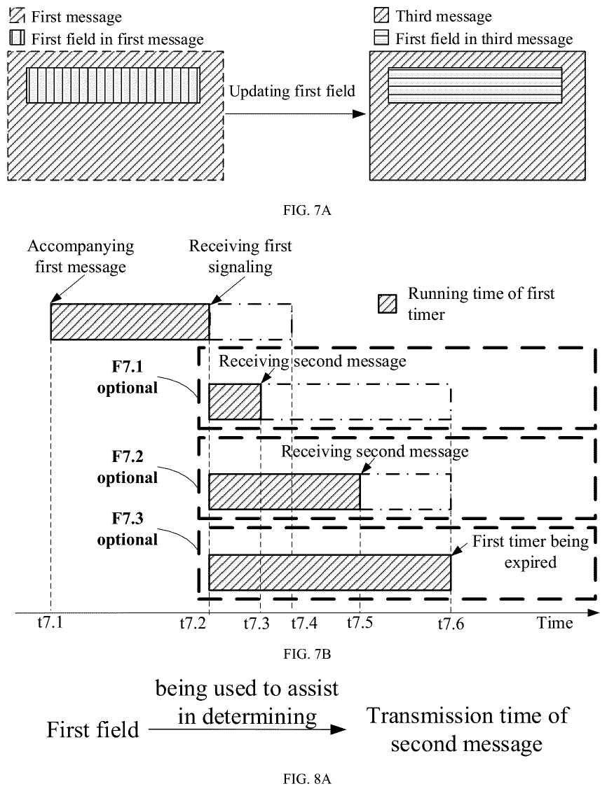

Embodiment 7A illustrates a flowchart of updating a first field according to one embodiment of the present application, as shown in FIG. 7A. In FIG. 7A, the slash-filled dotted box represents a first message, the vertical-filled solid box represents a first field in the first message; the slash-filled solid box represents a third message, and horizontal line-filled solid box represents a first field in the third message; only the first fields in the first message and the third message are different.

In embodiment 7A, when a second condition set is satisfied, update the first field; the behavior of updating the first field is used to determine a third message; herein, a first message comprises the first field.

In one embodiment, the first field in the first message is set as a first-type candidate value; the first field in the third message is set as another first-type candidate value, the first-type candidate value is one of the Q1 first-type candidate value(s), the another first-type candidate value is one of the Q1 first-type candidate value(s), and the first-type candidate value is different from the another first-type candidate value.

In one embodiment, the slash part in FIG. 7A represents other fields, and a size and a position of the other fields and the first field are not limited by FIG. 7A, only indicating that the first message comprises the first field and the third message comprises the first field.

### Embodiment 7B

Embodiment 7B illustrates a schematic diagram of a first timer according to one embodiment of the present application. In FIG. 7B, the horizontal axis represents time; t7.1, t7.2, t7.3, t7.4, t7.5, and t7.6 are six incremental moments in time; the slash-filled solid box represents a running time of a first timer; the dot-dash-line framed box is used to represents an expiration value of the first timer.

In Embodiment 7B, at the time t7.1, a first timer is started accompanying a first message; at the time t7.2, a first signaling is received, as a response to the behavior of receiving the first signaling, the first timer is restarted; a time interval between time t7.1 and time t7.4 is equal to the second expiration value of the first timer; a time interval between time 17.1 and time t7.2 is less than the second expiration value of the first timer; a time interval between the time t7.2 and the time t7.6 is equal to the first expiration value of the first timer.

In one embodiment, the dotted box F7.1 is optional.

In one embodiment, the dotted box F7.2 is optional.

In one embodiment, the dotted box F7.3 is optional.

In one embodiment, the dotted box F7.1 exists.

In one embodiment, the dotted box F7.1 does not exist.

In one embodiment, the dotted box F7.2 exists.

In one embodiment, the dotted box F7.2 does not exist.

In one embodiment, the dotted box F7.3 exists.

In one embodiment, the dotted box F7.3 does not exist.

In one embodiment, one of the dotted boxes F7.1, F7.2, and F7.3 exists.

In one embodiment, the dotted boxes F7.1, F7.2, and F7.3 do not exist at the same time.

In one embodiment, the dotted box F7.1 exists, and the dotted boxes F7.2 and F7.3 do not exist.

In one subembodiment of the embodiment, at the time t7.3, the second message is received, and as a response to the second message being received, stop the first timer; a time interval between the time t7.2 and the time t7.3 is less than a first expiration value of the first timer, and a time interval between the time t7.3 and the time t7.1 is less than a second expiration value of the first timer.

In one subembodiment of the above embodiment, at the time t7.3, a running time of the first timer comprises a time interval between the time 7.1 and the time t7.3.

In one subembodiment of the above embodiment, the first timer is restarted between time t7.3 and time t7.6.

In one subembodiment of the above embodiment, the first timer is not restarted between time t7.3 and time t7.6.

In one subembodiment of the above embodiment, at the time of t7.3, timing of the first timer is equal to a difference value of the t7.3 and the t7.2.

In one embodiment, the dotted box F7.2 exists, and the dotted boxes F7.1 and F7.3 do not exist.

In one subembodiment of the embodiment, at the time t7.5, the second message is received, and as a response to the second message being received, stop the first timer; a time interval between the time t7.2 and the time t7.5 is less than a first expiration value of the first timer, and a time interval between the time t7.5 and the time 17.1 is less than a second expiration value of the first timer.

In one subsidiary embodiment of the embodiment, the meaning of the not being less than is being equal to.

In one subsidiary embodiment of the embodiment, the meaning of the not being less than is being greater than.

In one subembodiment of the above embodiment, at the time t7.5, a running time of the first timer comprises a time interval between the time 17.1 and the time t7.5.

In one subembodiment of the above embodiment, the first timer is restarted between time t7.5 and time t7.6.

In one subembodiment of the above embodiment, the first timer is not restarted between time t7.5 and time t7.6.

In one subembodiment of the above embodiment, at the time of t7.5, timing of the first timer is equal to a difference value of the t7.5 and the t7.2.

In one embodiment, the dotted box F7.3 exists, and the dotted boxes F7.1 and F7.2 do not exist.

In one subembodiment of the above embodiment, at the time t7.6, the first timer is expired, and as a response to an expiration of the first timer, update from RRC_INACTIVE state to a first RRC state; a time interval between the time t7.2 and the time t7.6 is equal to a first expiration value of the first timer.

In one subembodiment of the above embodiment, at the time t7.6, a running time of the first timer comprises a time interval between the time 17.1 and the time t7.6.

In one subembodiment of the above embodiment, at a time after the t7.6, the first timer is restarted.

In one subembodiment of the above embodiment, at a time after the t7.6, the first timer is not restarted.

In one subembodiment of the above embodiment, timing of the first timer reaching the first expiration value is used to determine an expiration of the first timer.

In one subembodiment of the above embodiment, at the time of t7.6, timing of the first timer is equal to a difference value of the t7.6 and the t7.2, and a difference value of the t7.6 and the t7.2 is equal to a first expiration value of the first timer.

### Embodiment 8A

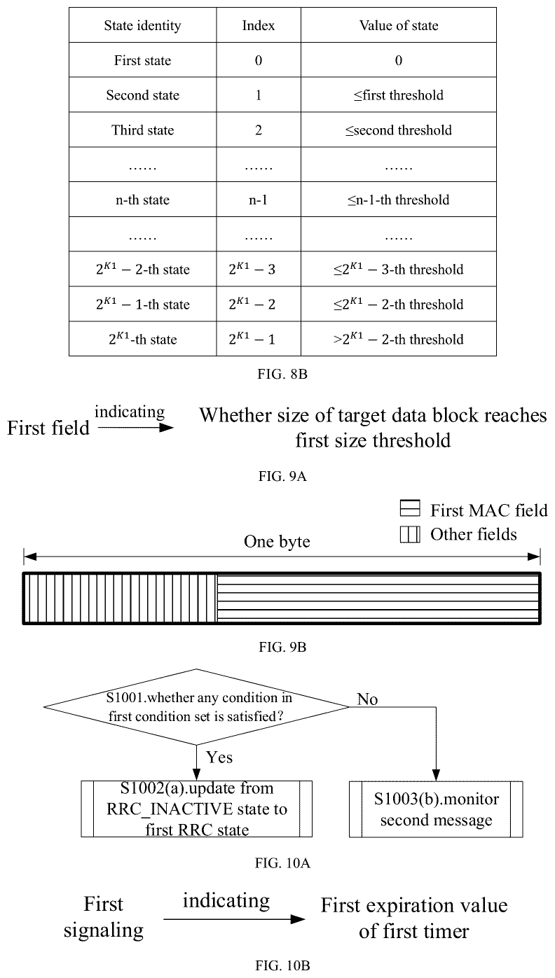

Embodiment 8A illustrates a schematic diagram of a first field being used to assist in determining a time for transmitting a second message according to one embodiment of the present application, as shown in FIG. 8A.

In embodiment 8A, the phrase that the first field is used to assist in determining a transmission of the second message comprises: the first field is used to assist in determining a time for transmitting the second message.

In one embodiment, the phrase that the first field is used to assist in determining a time for transmitting the second message comprises: the first field is used to directly determine a time for transmitting the second message.

In one subembodiment of the above embodiment, the phrase that the first field is used to directly determine a time for transmitting the second message comprises: the first field is used to suggest delaying transmitting the second message.

In one subembodiment of the above embodiment, the phrase that the first field is used to directly determine a time for transmitting the second message comprises: the first field is used to suggest transmitting the second message in advance.

In one embodiment, the phrase that the first field is used to assist in determining a time for transmitting the second message comprises: the first field is used to indirectly determine a time for transmitting the second message.

In one subembodiment of the above embodiment, the first field indicates that a size of a target data block reaching a first size threshold is used to indirectly determine transmitting the second message in advance, and the second message is the first candidate type.

In one subembodiment of the above embodiment, the first field indicates that there exists no data pending to be transmitted for indirectly determining an early transmission of the second message, and the second message is the second candidate type.

In one subembodiment of the above embodiment, the first field indicates that there exists data pending to be transmitted for indirectly determining a delay in transmitting the second message, and the second message is either the first candidate type or the second candidate type.

In one embodiment, the first field indicating whether there exists data pending to be transmitted is used for assisting in determining a time for transmitting the second message.

In one subembodiment of the above embodiment, the first field indicating whether there exists data pending to be transmitted is used for suggesting delaying a transmission time of the second message.

In one subsidiary embodiment of the subembodiment, when the first field is transmitted, the data pending to be transmitted is not generated.

In one subordinate embodiment of the subsidiary embodiment, the data pending to be transmitted is data on sidelink.

In one subordinate embodiment of the subsidiary embodiment, the data pending to be transmitted is data on a uu interface.

In one subordinate embodiment of the subsidiary embodiment, the data pending to be transmitted is predicted by the first node.

In one subordinate embodiment of the subsidiary embodiment, the data pending to be transmitted is determined by the first node based on statistical information of service characteristics over a period of time.

In one subsidiary embodiment of the subembodiment, when the first field is transmitted, the data pending to be transmitted is generated.

In one embodiment, the first field is used to suggest transmitting the second message as soon as possible; the first field is used to suggest whether the second message is transmitted in the first time window.

In one embodiment, the first field is used to indicate whether there exists data pending to be transmitted in a first time window.

In one embodiment, the first field is used to indicate whether the probability of a presence of data pending to be transmitted in a first time window is greater than a specific threshold.

In one embodiment, the first field is used to indicate that current cached data volume is zero.

In one embodiment, a transmission time of the first field is used to determine the first time window.

In one embodiment, the first time window is after a transmission time of the first field.

In one embodiment, how to determine the transmission time of the second message based on the first field is implementation-related.

In one embodiment, how to determine the transmission time of the second message based on the first field is determined by various network device manufacturers themselves.

In one embodiment, a receiver of the first field follows an indication of the first field to determine a time for transmitting the second message.

In one embodiment, a determination of the transmission time of the second message is implementation related.

### Embodiment 8B

Embodiment 8B illustrates a schematic diagram of K1 bits being used to indicate 2^{K1} states according to one embodiment of the present application, as shown in FIG. 8B. In FIG. 8B, each row except for a first row corresponds to a state; the first column represents a state identifier, the second column represents an index of each state, and the third column represents a value of each state.

In one embodiment, the K1 bits indicate 2^{K1} states, and each state in the 2^{K1} states indicates a range of a data volume.

In one embodiment, one of the 2^{K1} states indicates that a data volume is equal to 0.

In one embodiment, one of the 2^{K1} states indicates that a data volume is greater than the first threshold.

In one embodiment, a first one of the 2^{K1} states indicates that a data volume is equal to 0.

In one embodiment, an n-th state among the 2^{K1} states indicates that a data volume is not greater than an n−1-th threshold, n being an integer greater than 1 and not greater than the 2^{K1}−1.

In one embodiment, a 2^{K1}-th state in the 2^{K1} states indicates that a data volume is greater than a 2^{K1}−2-th threshold.

In one embodiment, the 2^{K1}−2-th threshold is equal to the first threshold.

In one embodiment, an index number of a first state among the 2^{K1} states is equal to 0.

In one embodiment, an index number of n-th state among 2^{K1} states is equal to n−1, n being an integer greater than 1 and not greater than the 2^{K1}−1.

In one embodiment, an index number of a 2^{K1}-th state among the 2^{K1} states is equal to 2^{K1}−1.

In one embodiment, a state is determined among the 2^{K1} states according to the buffer state, and the K1 bits in the first MAC CE are set as an index number corresponding to the state.

In one embodiment, each state in the 2^{K1} states indicates a buffer state.

In one embodiment, each state in the 2^{K1} states indicates a range of a data volume.

In one embodiment, each of the 2^{K1} states indicates a value of Buffer Status (BS).

In one embodiment, each of the 2^{K1} states indicates a value of the data volume (DV).

In one embodiment, each state in the 2^{K1} states is measured by byte.

In one embodiment, each state in the 2^{K1} states is measured by bit.

In one embodiment, the first column in FIG. 8B does not exist.

In one embodiment, the first column in FIG. 8B exists.

### Embodiment 9A

Embodiment 9A illustrates a schematic diagram of the first field indicating whether a size of the target data block reaches a first size threshold according to one embodiment of the present application, as shown in FIG. 9A.

In embodiment 9A, the first field indicates whether a size of a target data block reaches a first size threshold; the target data block comprises at least one of data pending to be transmitted on uplink, or a MAC MSGB or a MAC CE.

In one embodiment, data pending to be transmitted on uplink comprises: uplink data valid for a MAC entity.

In one embodiment, uplink data valid for a MAC entity comprises RLC SDUs and RLC SDU segments that are not comprised in an RLC data PDU.

In one embodiment, uplink data valid for a MAC entity comprises an RLC data PDU pending for an initial transmission.

In one embodiment, uplink data valid for a MAC entity comprises an RLC data PDU pending for a retransmission.

In one embodiment, uplink data valid for a MAC entity comprises a PDCP SDU not constructed in a PDCP Data PDU.

In one embodiment, uplink data valid for a MAC entity comprises a PDCP Data PDU not submitted to lower layer.

In one embodiment, uplink data valid for a MAC entity comprises a PDCP control PDU.

In one embodiment, uplink data valid for a MAC entity comprises a retransmitted PDCP SDU.

In one embodiment, uplink data valid for a MAC entity comprises a retransmitted PDCP Data PDU.

In one embodiment, uplink data valid for a MAC entity comprises a PDCP SN.

In one embodiment, uplink data valid for a MAC entity comprises a PDCP PDU header.

In one embodiment, uplink data valid for a MAC entity comprises an Acknowledged Mode Data (AMD) PDU header.

In one embodiment, uplink data valid for a MAC entity comprises an Unacknowledged Mode Data (UMD) PDU header.

In one embodiment, an increase in uplink data valid for a MAC entity is used to determine a presence of the second data block.

In one embodiment, the phrase that the first field indicates whether a size of a target data block reaches a first size threshold comprises: the first field indicates whether the size of the target data block is greater than the first size threshold.

In one embodiment, the phrase that the first field indicates whether a size of a target data block reaches a first size threshold comprises: the first field indicates whether the size of the target data block is greater than or equal to the first size threshold.

In one embodiment, the first field comprises 1 bit.

In one subembodiment of the above embodiment, when the size of the target data block reaches the first size threshold, the first field is set to 1; otherwise, the first field is set to 0.

In one subembodiment of the above embodiment, the first field is set to 1 to indicate that the size of the target data block reaches the first size threshold; the first field is set to any value other than 1 to indicate that the size of the target data block does not reach the first size threshold.

In one subsidiary embodiment of the subembodiment, the one bit is two bits in a BSR MAC CE.

In one subsidiary embodiment of the subembodiment, the one bit is two bits in a MAC CE, the MAC CE comprises a Buffer Size field, and the Buffer Size field indicates a volume of uplink data calculated based on TS 38.322 and TS 38.323.

In one embodiment, the first field comprises 2 bits.

In one subembodiment of the above embodiment, the two bits are two continuous bits.

In one subsidiary embodiment of the subembodiment, the two bits are two bits in a BSR MAC CE.

In one subsidiary embodiment of the subembodiment, the two bits are two bits in a MAC CE, the MAC CE comprises a Buffer Size field, and the Buffer Size field indicates a volume of uplink data calculated based on TS 38.322 and TS 38.323.

In one subembodiment of the above embodiment, the two bits are two discontinuous bits.

In one subsidiary embodiment of the subembodiment, the two bits are respectively two fields in two MAC MSGBs.

In one subsidiary embodiment of the subembodiment, the two bits are respectively two R fields in two MAC MSGBs.

In one subembodiment of the above embodiment, the two bits at most indicate four thresholds.

In one subembodiment of the above embodiment, when the size of the target data block reaches the first size threshold, the first field is set to a first value; otherwise, the first field is set to 0.

In one subembodiment of the above embodiment, the first field is set to 1 to indicate that the size of the target data block reaches the first size threshold; the first field is set to any value other than 1 to indicate that the size of the target data block does not reach the first size threshold.

In one embodiment, the phrase that the first field indicates whether a size of a target data block reaches a first size threshold comprises: the first field explicitly indicates whether a size of the target data block reaches the first size threshold

In one subembodiment of the above embodiment, the first field comprises at least 2 bits.

In one subembodiment of the above embodiment, the first field comprises at least 2 bits, and the first field comprises at most 8 bits.

In one subembodiment of the above embodiment, the first field is set to 1 to indicate that a size of the target data block reaches the first size threshold.

In one embodiment, the phrase that the first field indicates whether a size of a target data block reaches a first size threshold comprises: the first field implicitly indicates that a size of the target data block reaches the first size threshold

In one embodiment, the first size threshold is pre-configured.

In one embodiment, the first size threshold is configured by an RRC signaling.

In one embodiment, the first size threshold is equal to at least one bit.

In one embodiment, the first size threshold is used to determine whether a threshold of an SDT is executed.

In one embodiment, the first field indicating that a size of a target data block reaching a first size threshold is used to assist in determining whether the second message comprises an RRCResume message or an RRCConnectionResume message.

### Embodiment 9B

Embodiment 9B illustrates a schematic diagram of a first MAC CE comprising a first MAC field according to one embodiment of the present application, as shown in FIG. 9B. In FIG. 9B, the solid box represents the first MAC CE, the horizontal-line-filled box represents the first MAC field, the vertical-line-filled box represents other fields, and a length of the first MAC CE is equal to a byte.

In Embodiment 9B, the first MAC CE comprises a first AMC field, the first AMC field comprises K1 bits, and the K1 bits are used to indicate the buffer status; herein, the first MAC CE comprises one byte, and byte comprises 8 bits.

In one embodiment, K1 is equal to 8.

In one embodiment, K1 is equal to 7.

In one embodiment, K1 is equal to 6.

In one embodiment, K1 is equal to 5.

In one embodiment, the first MAC CE comprises two bytes, and the one byte comprises 8 bits.

In one embodiment, the other fields comprise 8-K1 bits.

In one embodiment, the other fields comprise at least one field.

In one embodiment, the other fields do not exist; herein, K1 is equal to 8.

In one embodiment, the other fields comprise an R field, and the R field is set to 0.

In one embodiment, the other fields comprise an LCG ID field.

In one subembodiment of the above embodiment, the LCG ID field comprises 1 bit.

In one subembodiment of the above embodiment, the LCG ID field comprises 2 bits.

In one subembodiment of the above embodiment, the LCG ID field comprises 3 bits.

In one embodiment, the first MAC CE simultaneously comprises the first MAC field and the LCG ID field.

In one embodiment, the first MAC CE simultaneously comprises the first MAC field and the R field.

In one embodiment, the first MAC CE simultaneously comprises the first MAC field, the LCG ID field and the R field.

In one embodiment, a name of the first MAC field comprises at least one of buffer or size.

In one embodiment, a name of the first MAC field comprises at least one of data or volume.

In one embodiment, the first MAC field is a buffer size field.

In one embodiment, the first MAC field is a data volume field.

### Embodiment 10A

Embodiment 10A illustrates a schematic diagram of a first condition set being satisfied being used to determine a behavior of a first node according to one embodiment of the present application, as shown in FIG. 10A. In FIG. 10A, each box represents a step.

In Embodiment 10A, in step S1001, judge whether there exists any condition in the first condition set being satisfied, if so, proceed to step S1002 (a), otherwise proceed to step S1002 (b); in step S1002(a), as a response to any condition in a first condition set being satisfied, update from RRC_INACTIVE state to a first RRC state; in step S1002(b), as a response to each condition in a first condition set not being satisfied, monitor a second message.

In one embodiment, the phrase of “as a response to each condition in a first condition set not being satisfied, monitoring a second message” comprises: as a response to the first timer not being expired and the second message not being received, monitoring the second message.

In one embodiment, the first timer not being expired means that the first timer is running.

In one embodiment, the first timer not being expired refers to that the first timer continues running after it is started.

In one embodiment, the first timer not being expired refers to that the first timer is restarted before it is expired and the first timer continues running after it is restarted.

### Embodiment 10B

Embodiment 10B illustrates a schematic diagram of a first signaling indicating a first expiration value of a first timer according to one embodiment of the present application, as shown in FIG. 10B.

In embodiment 10B, the first signaling indicates a first expiration value of the first timer.

In one embodiment, the first signaling is an RRC message, and a value of a field in the RRC message is set as the first expiration value.

In one subembodiment of the embodiment, the first signaling comprises an RRCRelease message.

In one subembodiment of the embodiment, the first signaling comprises an RRCConnectionRelease message.

In one subembodiment of the embodiment, the first signaling comprises an SIB1 message.

In one subembodiment of the embodiment, the first signaling comprises an RRCReconfigurationSidelink message.

In one subembodiment of the embodiment, the first signaling comprises an RRCReconfiguration message.

In one subembodiment of the embodiment, the first signaling comprises an RRCConnectionReconfiguration message.

In one subembodiment of the embodiment, the first signaling comprises SuspendConfig, and the field is a field in SuspendConfig.

In one subembodiment of the embodiment, the first signaling comprises SuspendConfig1, and the field is a field in SuspendConfig1.

In one subembodiment of the above embodiment, the first signaling comprises another field, the another field is used for an SDT procedure, and the field is a field in the another field.

In one subsidiary embodiment of the above subembodiment, the another field comprises logical channel configuration.

In one subsidiary embodiment of the above subembodiment, the another field comprises a DRB configuration.

In one subsidiary embodiment of the subembodiment, the another field comprises the first expiration value of the first timer.

In one subembodiment of the embodiment, a name of the field comprises a name of the first timer.

In one subembodiment of the embodiment, a value of the field indicates the first expiration value.

In one embodiment, the first signaling is a field in an RRC message, and a value of the first signaling is set as the first expiration value.

In one subembodiment of the embodiment, a name of the field comprises a name of the first timer.

In one subembodiment of the embodiment, a value of the field indicates the first expiration value.

In one embodiment, the first signaling indicates a first expiration value of the first timer, and the second signaling indicates a second expiration value of the first timer.

In one subembodiment of the above embodiment, the first expiration value and the second expiration value are equal.

In one subembodiment of the above embodiment, the first expiration value and the second expiration value are not equal.

In one subembodiment of the above embodiment, the first expiration value is greater than the second expiration value.

In one subembodiment of the above embodiment, the first expiration value is less than the second expiration value.

In one subembodiment of the above embodiment, the first signaling and the second signaling have a same name.

In one subembodiment of the above embodiment, the first signaling and the second signaling have different names.

### Embodiment 11A

Embodiment 11A illustrates a schematic diagram of a field in a MAC MSGB being used to determine a first field according to one embodiment of the present application, as shown in FIG. 11A. In FIG. 11A, a solid box represents a field, a dashed box represents a first field field, and the first field field indicates the first field.

In Embodiment 11A, a field in a MAC MSGB is used to determine the first field.

In one embodiment, FIG. 11A represents a MAC MSGB, and the MAC MSGB comprises a first field field, a Format (F) field, a Logical Channel ID (LCID) field, and a Length (L) field.

In one embodiment, for definitions of the F field, the LCID field, and the L field, refer to chapter 6.2.1 of 3GPP TS 38.321.

In one embodiment, the first field field is a Reserved bit (R) field, and for the definition of the R field, refer to chapter 6.2.1 of 3GPP TS 38.321.

In one subembodiment of the above embodiment, the phrase that the first field is used to assist in determining a transmission of the second message comprises: the R field is used to assist in determining a transmission of the second message.

In one subembodiment of the above embodiment, only during the SDT procedure, the R field is used to assist in determining a transmission of the second message.

In one subembodiment of the above embodiment, a field in an RRC message indicates whether the R field is allowed to be used to assist in determining a transmission of the second message.

In one subsidiary embodiment of the above embodiment, the RRC message comprises an RRCRelease message, or an RRCReconfiguration message, or an RRCConnectionReconfiguration message, or an RRCConnectionRelease message.

In one subsidiary embodiment of the above embodiment, the RRC message comprises an SIB1 message.

In one subsidiary embodiment of the above embodiment, the field is set as setup to indicate that the R field is allowed to be used to assist in determining a transmission of the second message.

In one subsidiary embodiment of the above embodiment, the field is set as Release to indicate that the R field is not allowed to be used to assist in determining a transmission of the second message.

In one embodiment, the R field is set to 1 to assist in determining a transmission of the second message.

In one embodiment, a format of the MAC MSGB is not limited in FIG. 11A.

In one embodiment, a format of the MAC MSGB is one of FIG. 6.1.2-1 or 6.1.2-2 or 6.1.2-3 in chapter 6.1.2 of TS 38.321.

### Embodiment 11B

Embodiment 11B illustrates a structure block diagram of a processor in first second node according to one embodiment of the present application, as shown in FIG. 11B. In FIG. 11B, a processor 1100 in a first node comprises a first receiver 1101 and a first transmitter 1102.

The first transmitter 1102 transmits a first message, the first message comprises an RRC message; accompanying the first message, starts a first timer;

the first receiver 1101 monitors a second message when the first timer is in a running state; receives a first signaling when the first timer is in a running state, as a response to the behavior of receiving the first signaling, restarts the first timer or triggering a first buffer status report.

In embodiment 11B, if the second message is received, and as a response to the second message being received, stop the first timer; the second message comprises an RRC message, and the second message is used to respond to the first message.

In one embodiment, the first transmitter 1102, before the first message being transmitted, resumes a first-type DRB; herein, when the first-type DRB is resumed, the first node is in RRC_INACTIVE state.

In one embodiment, the first receiver 1101, as a response to an expiration of the first timer, updates from RRC_INACTIVE state to a first RRC state; herein, the first RRC state is a candidate state in a first candidate state set, and the first candidate state set comprises RRC_IDLE state.

In one embodiment, the first transmitter 1102, after the behavior of triggering a first buffer status report, generates a first MAC CE; herein, the first MAC CE indicates a buffer status; a priority of the first MAC CE is not lower than a priority of a second MAC CE, the second MAC CE is a MAC CE in a first candidate MAC CE set, and the first candidate MAC CE set comprises a BSR MAC CE.

In one embodiment, the first signaling indicates a first expiration value of the first timer.

In one embodiment, the first receiver 1101 receives a second signaling; herein, the second signaling indicates a second expiration value of the first timer; the second signaling comprises an RRC message.

In one embodiment, the first receiver 1101 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1101 comprises the antenna 452, the receiver 454, the multi-antenna receiving processor 458 and the receiving processor 456 in FIG. 4 of the present application.

In one embodiment, the first receiver 1101 comprises the antenna 452, the receiver 454 and the receiving processor 456 in FIG. 4 of the present application.

In one embodiment, the first transmitter 1102 comprises the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1102 comprises the antenna 452, the transmitter 454, the multi-antenna transmitting processor 457 and the transmitting processor 468 in FIG. 4 of the present application.

In one embodiment, the first transmitter 1102 comprises the antenna 452, the transmitter 454 and the transmitting processor 468 in FIG. 4 of the present application.

### Embodiment 12A

Embodiment 12A illustrates a schematic diagram of a field being used to determine a first field in a MAC CE according to one embodiment of the present application, as shown in FIG. 12A. In FIG. 12A, a solid box represents a Buffer Size field, and a dotted box represents a first field.

In Embodiment 12A, FIG. 12A represents a MAC CE, the MAC CE comprises a Buffer Size field and a first field field, and the first field field indicates the first field.

In one embodiment, the MAC CE comprises one byte, and the byte comprises 8 bits.

In one embodiment, the Buffer Size field comprises 4 bits.

In one embodiment, the Buffer Size field comprises 5 bits.

In one embodiment, the Buffer Size field comprises 6 bits.

In one embodiment, the Buffer Size field comprises 7 bits.

In one embodiment, the first field field comprises 7 bits.

### Embodiment 12B

Embodiment 12B illustrates a structure block diagram of a processor in a second node according to one embodiment of the present application, as shown in FIG. 12B. In FIG. 12B, a processor 1200 in a second node comprises a second transmitter 1201 and a second receiver 1202.
the second receiver 1202 receives a first message, the first message comprises an RRC message;
the second transmitter 1201 transmits a second message; transmits a first signaling.

In embodiment 12B, accompanying the first message, a first timer is started; when the second message is received, the first timer is in a running state; when the first message is received, the first timer is in a running state; as a response to the first signaling being received, the first timer is restarted or a first buffer status report is triggered; if the second message is received, and as a response to the second message being received, stop the first timer; the second message comprises an RRC message, and the second message is used to respond to the first message.

In one embodiment, the first timer is initiated by a transmitter of the first message.

In one embodiment, when the second message is received by a transmitter of the first message, the first timer is in a running state.

In one embodiment, when the first signaling is received by a transmitter of the first message, the first timer is in a running state.

In one embodiment, as a response to the first signaling being received by a transmitter of the first message, the first timer is restarted by a transmitter of the first message or the first buffer status report is triggered.

In one embodiment, before the first message is transmitted, a first-type DRB is resumed; herein, when the first-type DRB is resumed, a transmitter of the first message is in RRC_INACTIVE state.

In one embodiment, a first-type DRB is resumed by a transmitter of the first message.

In one embodiment, as a response to an expiration of the first timer, RRC_INACTIVE state is updated as a first RRC state; herein, the first RRC state is a candidate state in a first candidate state set, and the first candidate state set comprises RRC_IDLE state.

In one embodiment, a transmitter of the first message is updated from RRC_INACTIVE state to a first RRC state.

In one embodiment, after the behavior of triggering a first buffer status report, a first MAC CE is generated; herein, the first MAC CE indicates a buffer status; a priority of the first MAC CE is not lower than a priority of a second MAC CE, the second MAC CE is a MAC CE in a first candidate MAC CE set, and the first candidate MAC CE set comprises a BSR MAC CE.

In one embodiment, a first MAC CE is generated by a transmitter of the first message.

In one embodiment, the first signaling indicates a first expiration value of the first timer.

In one embodiment, the second transmitter 1201 transmits a second signaling; herein, the second signaling indicates a second expiration value of the first timer; the second signaling comprises an RRC message.

In one embodiment, the second transmitter 1201 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1201 comprises the antenna 420, the transmitter 418, the multi-antenna transmitting processor 471 and the transmitting processor 416 in FIG. 4 of the present application.

In one embodiment, the second transmitter 1201 comprises the antenna 420, the transmitter 418 and the transmitting processor 416 in FIG. 4 of the present application.

In one embodiment, the second receiver 1202 comprises the antenna 420, the receiver 418, the multi-antenna receiving processor 472, the receiving processor 470, the controller/processor 475 and the memory 476 in FIG. 4 of the present application.

In one embodiment, the second receiver 1202 comprises the antenna 420, the receiver 418, the multi-antenna receiving processor 472 and the receiving processor 470 in FIG. 4 of the present application.

In one embodiment, the second receiver 1202 comprises the antenna 420, the receiver 418 and the receiving processor 470 in FIG. 4 of the present application.

### Embodiment 13

Embodiment 13 illustrates a schematic diagram of a field in a MAC CE being used to determine a first field according to another embodiment of the present application, as shown in FIG. 13. In FIG. 13, a solid box represents a field, and a dotted box represents a first field.

In Embodiment 13, FIG. 13 represents a MAC CE, the MAC CE comprises a Buffer Size field, other fields and a first field field, and the first field field indicates the first field.

In one embodiment, the MAC CE comprises one byte, and the byte comprises 8 bits.

In one embodiment, the first field field comprises 1 bit.

In one subembodiment of the embodiment, the other fields comprise 1 bit, and the Buffer Size field comprises 6 bits.

In one subembodiment of the embodiment, the other fields comprise 2 bit, and the Buffer Size field comprises 5 bits.

In one subembodiment of the embodiment, the other fields comprise 3 bit, and the Buffer Size field comprises 4 bits.

In one embodiment, the first field field comprises 2 bits.

In one subembodiment of the embodiment, the other fields comprise 1 bit, and the Buffer Size field comprises 6 bits.

In one subembodiment of the embodiment, the other fields comprise 2 bit, and the Buffer Size field comprises 5 bits.

In one subembodiment of the embodiment, the other fields comprise 3 bit, and the Buffer Size field comprises 4 bits.

In one embodiment, the other fields comprise a PHR field.

In one embodiment, the other fields comprise an LCG ID field.

In one embodiment, the other fields indicate beam failure.

### Embodiment 14

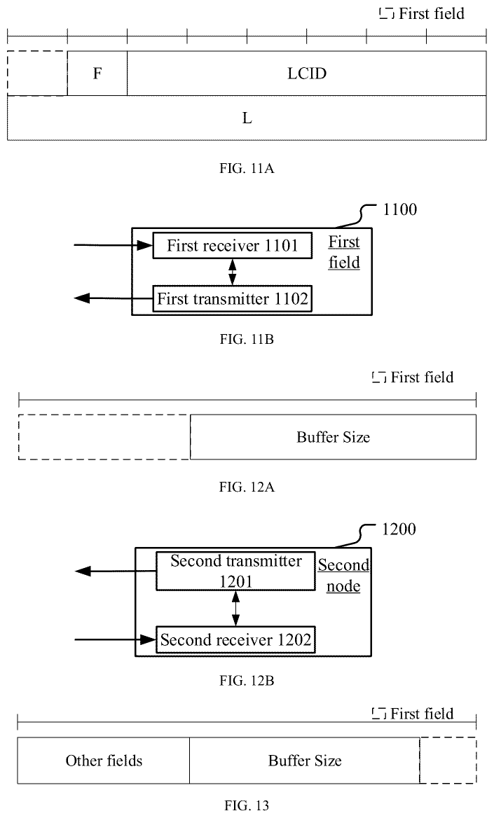

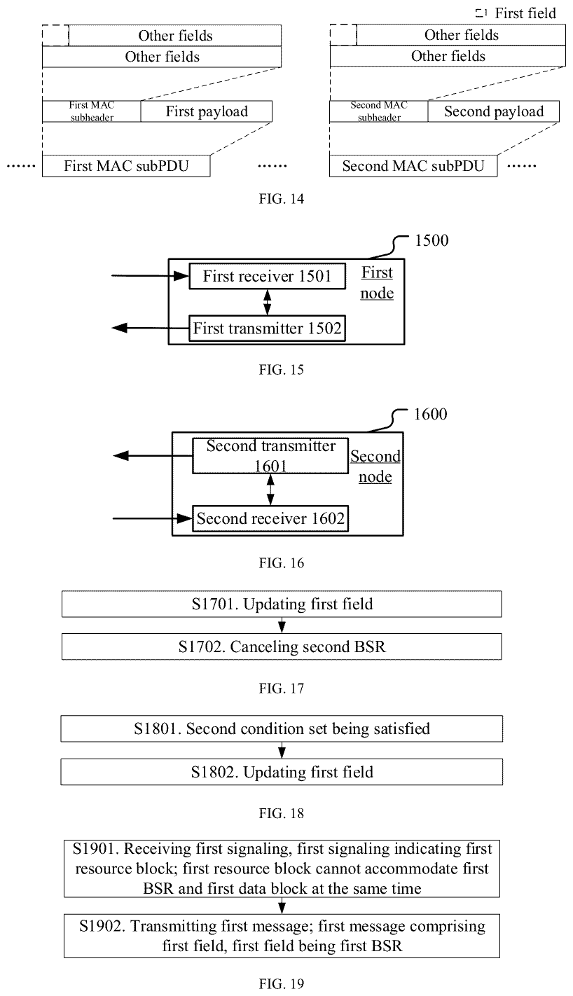

Embodiment 14 illustrates a schematic diagram of multiple fields in multiple MAC MSGBs being used to determine a first field in a MAC PDU according to one embodiment of the present application, as shown in FIG. 14. In FIG. 14, a dotted box represents a part in a first field, a solid box represents a MAC sub-PDU, or a solid box represents a MAC MSGB, or a solid box represents a payload, or a solid box represents one or multiple fields, and an ellipse represents other MAC sub-PDUs.

In Embodiment 14, the FIG. 14 represents a MAC PDU, and the MAC PDU comprises K1 MAC sub-PDUs, K1 being a positive integer, K1 being greater than 1; a first MAC sub-PDU and a second MAC sub-PDU are respectively one of the K1 MAC sub-PDU(s), the first MAC sub-PDU comprises a first MAC MSGB and a first payload, the second MAC sub-PDU comprises a second MAC MSGB and a second payload, the first MAC MSGB comprises a part of the first field and other fields, and the second MAC MSGB comprises a part of the first field and other fields.

In one embodiment, the first payload is a MAC SDU, or the first payload is a MAC CE.

In one embodiment, the second payload is a MAC SDU, or the second payload is a MAC CE.

In one embodiment, the first payload is a MAC SDU, or the second payload is a MAC CE.

In one embodiment, the first payload is a MAC SDU, or the second payload is a MAC SDU.

In one embodiment, the first payload is a CCCH SDU, or the second payload is a DCCH SDU.

In one embodiment, the first field comprises an R field in a first MAC MSGB in a first MAC sub-PDU and an R field in a second MAC MSGB in a second MAC sub-PDU.

In one embodiment, the first field comprises K2 R field(s) in K2 MAC MSGB(s) among K2 MAC sub-PDU(s), K2 being a positive integer not greater than K1.

In one subembodiment of the above embodiment, K2 is equal to the K1.

In one subembodiment of the above embodiment, K2 is less than the K1.

In one subembodiment of the above embodiment, K2 is equal to 2.

In one embodiment, a format of the first MAC MSGB refers to one of FIG. 6.1.2-1 or 6.1.2-2 or 6.1.2-3 in chapter 6.1.2 of TS 38.321.

In one embodiment, a format of the second MAC MSGB refers to one of FIG. 6.1.2-1 or 6.1.2-2 or 6.1.2-3 in chapter 6.1.2 of TS 38.321.

In one embodiment, all ellipses in FIG. 14 exist.

In one embodiment, at least one ellipse in FIG. 14 does not exist.

### Embodiment 15

Embodiment 15 illustrates a structure block diagram of a processor in a first node according to one embodiment of the present application, as shown in FIG. 15. In FIG. 15, a processor 1500 in a first node comprises a first receiver 1501 and a first transmitter 1502.

The first transmitter 1502, accompanying a first message, starts a first timer; transmits the first message, the first message comprises an RRC signaling; transmits a first field;

the first receiver 1501, monitors a second message, the second message comprises an RRC signaling, the second message is used to respond to the first message; as a response to any condition in a first condition set being satisfied, updates from RRC_INACTIVE state to a first RRC state;

In embodiment 15, if the second message is received, and as a response to the second message being received, stop the first timer; the first field is used to assist in determining a transmission of the second message; two conditions in the first condition set are respectively the first timer being expired and the second message being received; the first RRC state is a candidate state in a first candidate state set, and the first candidate state set comprises RRC_IDLE state.

In one embodiment, the phrase that the first field is used to assist in determining a transmission of the second message comprises: the first field is used to assist in determining a time for transmitting the second message.

In one embodiment, the first transmitter 1502, as a response to the behavior of transmitting a first field, increases an expiration value of the first timer by a first offset; herein, the first offset comprises at least one slot.

In one embodiment, the first field indicates whether a size of a target data block reaches a first size threshold; the target data block comprises at least one of data pending to be transmitted on uplink, or a MAC MSGB or a MAC CE.

In one embodiment, the first receiver 1502 receives a first signaling, the first signaling indicates a first resource block; herein, the first message comprises the first field, and the first field is a first BSR; the first resource block cannot accommodate the first BSR and the first data block at the same time; the first data block comprises an SDU; the first resource block is used to carry the first message.

In one embodiment, the first receiver 1501 determines that a fourth message is not correctly received; receives a second signaling, the second signaling indicates a second resource block; the first transmitter 1502, when a second condition set is satisfied, updates the first field; the behavior of updating the first field is used to determine a third message, transmits the third message on the second resource block; herein, the behavior of determining that the fourth message is not correctly received triggers the second signaling; the second condition set comprises that there exists a second data block, and the second data block arrives after the first message is assembled.

In one embodiment, the first transmitter 1502, as a response to the behavior of updating the first field, cancels a second BSR; herein, the second BSR is triggered between the first message and the third message.

In one embodiment, the first receiver 1501 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1501 comprises the antenna 452, the receiver 454, the multi-antenna receiving processor 458 and the receiving processor 456 in FIG. 4 of the present application.

In one embodiment, the first receiver 1501 comprises the antenna 452, the receiver 454 and the receiving processor 456 in FIG. 4 of the present application.

In one embodiment, the first transmitter 1502 comprises the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1502 comprises the antenna 452, the transmitter 454, the multi-antenna transmitting processor 457 and the transmitting processor 468 in FIG. 4 of the present application.

In one embodiment, the first transmitter 1502 comprises the antenna 452, the transmitter 454 and the transmitting processor 468 in FIG. 4 of the present application.

### Embodiment 16

Embodiment 16 illustrates a structure block diagram of a processor in a second node according to one embodiment of the present application, as shown in FIG. 16. In FIG. 16, a processor 1600 in a second node comprises a second transmitter 1601 and a second receiver 1602.

The second receiver 1602 receives a first message, the first message comprises an RRC signaling; receives a first field;

the second transmitter 1601 transmits a second message, the second message comprises an RRC signaling, the second message is used to respond to the first message;

in embodiment 16, accompanying the first message, a first timer is started; as a response to any condition in a first condition set being satisfied, a transmitter of the first message updates from RRC_INACTIVE state to a first RRC state; if the second message is received, as a response to the second message being received, the first timer is stopped; the first field is used to assist in determining a transmission of the second message; two conditions in the first condition set are respectively the first timer being expired and the second message being received; the first RRC state is a candidate state in a first candidate state set, and the first candidate state set comprises RRC_IDLE state.

In one embodiment, the phrase that the first field is used to assist in determining a transmission of the second message comprises: the first field is used to assist in determining a time for transmitting the second message.

In one embodiment, as a response to the first field being transmitted, an expiration value of the first timer is increased by a first offset; herein, the first offset comprises at least one slot.

In one embodiment, the first field indicates whether a size of a target data block reaches a first size threshold; the target data block comprises at least one of data pending to be transmitted on uplink, or a MAC MSGB or a MAC CE.

In one embodiment, the second transmitter 1601 transmits a first signaling, and the first signaling indicates a first resource block; herein, the first message comprises the first field, and the first field is a first BSR; the first resource block cannot accommodate the first BSR and the first data block at the same time; the first data block comprises an SDU; the first resource block is used to carry the first message.

In one embodiment, the second transmitter 1601, a fourth message is determined not correctly received, and the fourth message is triggered by the first message; transmits a second signaling, the second signaling indicates a second resource block; the second receiver 1501 receives a third message on the second resource block; herein, when a second condition set is satisfied, the first field is updated; the behavior of the first field being updated is used to determine the third message; the behavior of determining that the fourth message is not correctly received triggers the second signaling; the second condition set comprises that there exists a second data block, and the second data block arrives after the first message is assembled.

In one embodiment, as a response to the behavior of the first field being updated, a second BSR is canceled; herein, the second BSR is triggered between the first message and the third message.

In one embodiment, the second transmitter 1601 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1601 comprises the antenna 420, the transmitter 418, the multi-antenna transmitting processor 471 and the transmitting processor 416 in FIG. 4 of the present application.

In one embodiment, the second transmitter 1601 comprises the antenna 420, the transmitter 418 and the transmitting processor 416 in FIG. 4 of the present application.

In one embodiment, the second receiver 1602 comprises the antenna 420, the receiver 418, the multi-antenna receiving processor 472, the receiving processor 470, the controller/processor 475 and the memory 476 in FIG. 4 of the present application.

In one embodiment, the second receiver 1602 comprises the antenna 420, the receiver 418, the multi-antenna receiving processor 472 and the receiving processor 470 in FIG. 4 of the present application.

In one embodiment, the second receiver 1602 comprises the antenna 420, the receiver 418 and the receiving processor 470 in FIG. 4 of the present application.

### Embodiment 17

Embodiment 17 illustrates a schematic diagram of updating a first field being used to determine canceling a second BSR according to one embodiment of the present application, as shown in FIG. 17.

In embodiment 17, in step S1701, update the first field: in step S1702, as a response to the behavior of updating the first field, cancel a second BSR.

In one embodiment, accompanying a first message, start a first timer; transmit the first message, the first message comprises an RRC signaling; transmit a first field; monitor a second message, the second message comprises an RRC signaling, the second message is used to respond to the first message; as a response to any condition in a first condition set being satisfied, update from RRC_INACTIVE state to a first RRC state; determine that a fourth message is not correctly received, the fourth message is triggered by the first message; receive a second signaling, the second signaling indicates a second resource block; the first transmitter, when a second condition set is satisfied, updates the first field; the behavior of updating the first field is used to determine a third message, transmits the third message on the second resource block; herein, if the second message is received, and as a response to the second message being received, stop the first timer; the first field is used to assist in determining a transmission of the second message; two conditions in the first condition set are respectively the first timer being expired and the second message being received; the first RRC state is a candidate state in a first candidate state set, and the first candidate state set comprises RRC_IDLE state; the behavior of determining that the fourth message is not correctly received triggers the second signaling; the second condition set comprises that there exists a second data block, and the second data block arrives after the first message is assembled; the second BSR is triggered between the first message and the third message.

### Embodiment 18

Embodiment 18 illustrates a schematic diagram of a second condition set being satisfied being used to determine updating a first field according to one embodiment of the present application, as shown in FIG. 18.

In embodiment 18, in step S1801, determine that a second condition set is satisfied; in step S1802, when a second condition set is satisfied, update the first field;

In one embodiment, accompanying a first message, start a first timer; transmit the first message, the first message comprises an RRC signaling; transmit a first field; monitor a second message, the second message comprises an RRC signaling, the second message is used to respond to the first message; as a response to any condition in a first condition set being satisfied, update from RRC_INACTIVE state to a first RRC state; determine that a fourth message is not correctly received, the fourth message is triggered by the first message; receive a second signaling, the second signaling indicates a second resource block; the behavior of updating the first field is used to determine a third message, transmit the third message on the second resource block; herein, if the second message is received, and as a response to the second message being received, stop the first timer; the first field is used to assist in determining a transmission of the second message; two conditions in the first condition set are respectively the first timer being expired and the second message being received; the first RRC state is a candidate state in a first candidate state set, and the first candidate state set comprises RRC_IDLE state; the behavior of determining that the fourth message is not correctly received triggers the second signaling; the second condition set comprises that there exists a second data block, and the second data block arrives after the first message is assembled.

In one embodiment, the second condition set comprises a size of a target data block reaching a first size threshold.

In one embodiment, the second condition set comprises that an increase value in RSRP of a current serving cell compared to last RSRP reaches a first difference value, or that a decrease value in RSRP compared to last RSRP reaches a second difference value.

In one embodiment, the second condition set comprises there not being sufficient uplink resources.

In one embodiment, the second condition set comprises uplink out-of-sync.

In one embodiment, the second condition set comprises an occurrence of beam failure.

In one embodiment, the first message and the first field belong to a same MAC PDU.

In one embodiment, the first message and the first field do not belong to a same MAC PDU.

In one embodiment, the first message is associated with a TEMPORARY_C-RNTI, and the first field is associated with TEMPORARY_C-RNTI.

In one embodiment, the first message is associated with an MSGB-RNTI, and the first field is associated with an MSGB-RNTI.

In one embodiment, the first message is associated with an MSGB-RNTI, and the first field is associated with a TEMPORARY_C-RNTI.

In one embodiment, the first message is associated with a TEMPORARY_C-RNTI or an MSGB-RNTI, the first field is associated with a C-RNTI.

In one embodiment, the first message is associated with a TEMPORARY_C-RNTI, and the second message is associated with a TEMPORARY_C-RNTI.

In one embodiment, the first message is associated with an MSGB-RNTI, and the second message is associated with an MSGB-RNTI.

In one embodiment, the first message is associated with an MSGB-RNTI, and the second message is associated with a TEMPORARY_C-RNTI.

### Embodiment 19

Embodiment 19 illustrates a schematic diagram of when a first resource block cannot accommodate both a first BSR and a first data block, the first message comprising a first BSR according to one embodiment of the present application, as shown in FIG. 19.

In embodiment 19, in step S1901, receive a first signaling, and the first signaling indicates a first resource block; the first resource block cannot accommodate the first BSR and the first data block at the same time; transmit a first message in step S1902; the first message comprises the first field, and the first field is a first BSR.

In one embodiment, accompanying a first message, start a first timer; the first message comprises an RRC signaling; monitor a second message, the second message comprises an RRC signaling, the second message is used to respond to the first message; as a response to any condition in a first condition set being satisfied, update from RRC_INACTIVE state to a first RRC state; herein, if the second message is received, and as a response to the second message being received, stop the first timer; the first field is used to assist in determining a transmission of the second message; two conditions in the first condition set are respectively the first timer being expired and the second message being received; the first RRC state is a candidate state in a first candidate state set, and the first candidate state set comprises RRC_IDLE state; the first data block comprises an SDU; the first resource block is used to carry the first message.

In one embodiment, the behavior of transmitting a first message comprises the behavior of transmitting a first field.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, tele-controlled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IOT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, tele-controlled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first transmitter, accompanying a first message, starting a first timer; transmitting the first message, the first message comprising a Radio Resource Control (RRC) signaling; transmitting a first field; and
a first receiver, monitoring a second message, the second message comprising an RRC signaling, the second message being used to respond to the first message; as a response to any condition in a first condition set being satisfied, entering into a first RRC state from RRC_INACTIVE state;
wherein if the second message is received, and as a response to the second message being received, stop the first timer; the first field is used to assist in determining a transmission of the second message; two conditions in the first condition set are respectively the first timer being expired and the second message being received;
the first RRC state is a candidate state in a first candidate state set, and the first candidate state set comprises RRC_IDLE state.

2. The first node according to claim 1, wherein the behavior of “as a response to any condition in a first condition set being satisfied, entering into a first RRC state from RRC_INACTIVE state” comprises: as a response to an expiration of the first timer, entering into the first RRC state from RRC_INACTIVE state; the second message not being received; the first RRC state being RRC_IDLE state.

3. The first node according to claim 1, wherein the behavior of “as a response to any condition in a first condition set being satisfied, entering into a first RRC state from RRC_INACTIVE state” comprises: as a response to the second message being received, entering into a first RRC state from RRC_INACTIVE state; the second message being received; the first RRC state being RRC_INACTIVE state, or, the first RRC state being RRC_IDLE state.

4. The first node according to claim 1, wherein the first message comprises an RRCResumeRequest message;
the second message comprises an RRCRelease message.

5. The first node according to claim 1, wherein the first message comprises an RRC signaling and the first message comprises a Buffer Status Report (BSR).

6. The first node according to claim 1, wherein the first message is all or part in Msg3; or, the first message is all or part in MSGA.

7. The first node according to claim 1, wherein accompanying a first message, not start the T319.

8. The first node according to claim 1, wherein the first field indicates that data other than the first-type Data Radio Bearer (DRB) arrives; the first field is a field in an RRC message.

9. The first node according to claim 1, wherein the first message comprises the first field.

10. The first node according to claim 1, wherein the first field is not a field in the first message.

11. The first node according to claim 1, wherein the first field indicates two first-type states, the first field being set is used to indicate one first-type state, and the first field not being set is used to indicate another first-type state; the first-type state comprises: data other than the first-type DRB arrives; the another first-type state comprises: no data other than the first-type DRB arrives.

12. The first node according to claim 1, wherein the phrase that the first field is used to assist in determining a transmission of the second message comprises: the first field is used to assist in determining a time for transmitting the second message.

13. The first node according to claim 1, comprising:
the first transmitter, as a response to the behavior of transmitting a first field, an expiration value of the first timer being increased by a first offset;
wherein the first offset comprises at least one slot.

14. The first node according to claim 1, wherein the first field indicates whether a size of a target data block reaches a first size threshold; the target data block comprises at least one of data pending to be transmitted on uplink, or a MAC subheader or a MAC CE.

15. The first node according to claim 1, comprising:
the first receiver, receiving a first signaling, the first signaling indicating a first resource block;
wherein the first message comprises the first field, and the first field is a first BSR; the first resource block cannot accommodate the first BSR and the first data block at the same time; the first data block comprises an SDU; the first resource block is used to carry the first message.

16. The first node according to claim 1, comprising:
the first receiver, determining that a fourth message is not correctly received, the fourth message being triggered by the first message; receiving a second signaling, the second signaling indicates a second resource block; and
the first transmitter, when a second condition set is satisfied, updating the first field; the behavior of updating the first field being used to determine a third message, transmitting the third message on the second resource block;
wherein the behavior of determining that the fourth message is not correctly received triggers the second signaling; the second condition set comprises that there exists a second data block, and the second data block arrives after the first message is assembled.

17. The first node according to claim 6, comprising:
the first transmitter, as a response to the behavior of updating the first field, canceling a second BSR;
wherein the second BSR is triggered between the first message and the third message.

18. A second node for wireless communications, comprising:
a second receiver, receiving a first message, the first message comprising an RRC signaling. receiving a first field; and
a second transmitter, transmitting a second message, the second message comprising an RRC signaling, the second message being used to respond to the first message;
wherein accompanying the first message, a first timer is started; as a response to any condition in a first condition set being satisfied, a transmitter of the first message enters into a first RRC state from RRC_INACTIVE state; if the second message is received, as a response to the second message being received, the first timer is stopped; the first field is used to assist in determining a transmission of the second message;
two conditions in the first condition set are respectively the first timer being expired and the second message being received; the first RRC state is a candidate state in a first candidate state set, and the first candidate state set comprises RRC_IDLE state.

19. A method in a first node for wireless communications, comprising:
accompanying a first message, starting a first timer; transmitting the first message, the first message comprising an RRC signaling; transmitting a first field; and
monitoring a second message, the second message comprising an RRC signaling, the second message being used to respond to the first message; as a response to any condition in a first condition set being satisfied, entering into a first RRC state from RRC_INACTIVE state;
wherein if the second message is received, and as a response to the second message being received, stop the first timer; the first field is used to assist in determining a transmission of the second message; two conditions in the first condition set are respectively the first timer being expired and the second message being received;
the first RRC state is a candidate state in a first candidate state set, and the first candidate state set comprises RRC_IDLE state.

20. A method in a second node for wireless communications, comprising:
receiving a first message, the first message comprising an RRC signaling. receiving a first field; and
transmitting a second message, the second message comprising an RRC signaling, the second message being used to respond to the first message;
wherein accompanying the first message, a first timer is started; as a response to any condition in a first condition set being satisfied, a transmitter of the first message enters into a first RRC state from RRC_INACTIVE state; if the second message is received, as a response to the second message being received, the first timer is stopped; the first field is used to assist in determining a transmission of the second message;
two conditions in the first condition set are respectively the first timer being expired and the second message being received; the first RRC state is a candidate state in a first candidate state set, and the first candidate state set comprises RRC_IDLE state.
